(19) United States
(12) Patent Application Publication
(10) Pub. No.: US 2002/0147775 A1
(43) Pub. Date: Oct. 10, 2002

(54) System and method for displaying information provided by a provider

(76) Inventors: Aruna Rohra Suda, Yokohama-Shi (JP); Suresh Jeyachandran, Yokohama-Shi (JP); Prem Anand Joseph, Yokohama-Shi (JP)

Correspondence Address: MORGAN & FINNEGAN, L.L.P., 345 Park Avenue, New York, NY, 10154-0053, US

(21) Appl. No.: 10/116,932

(22) Filed: Apr. 5, 2002

(30) Foreign Application Priority Data
Apr. 6, 2001 (JP) 2001-107893
Aug. 3, 2001 (JP) 2001-236197
Aug. 17, 2001 (JP) 2001-248314

(51) Int. Cl. G06F 15/16

(52) U.S. Cl. 709/203

(57) ABSTRACT

In an information processing system including a server and at least one client terminals, the server receives service information provided by a plurality of providers via an internet, and selects service information suitable to a user of a client terminal from among the provided service information and transmits the selected service information to the client terminal, the client terminal displays the received service information in a sub window, while a page in the internet is displayed in a main window.

### FIELD OF THE INVENTION

The present invention relates to an information processing system including a server and at least one client terminals, and in the system, a method for displaying information provided by a plurality of providers in a client terminal.

### BACKGROUND OF THE INVENTION

A conventional personal computer can display a page in an Internet requested by a user. The computer also shows to the user a commercial or advertisement in the form of a banner appended to the page, or an advertisement linked to the page in response to a click of an anchor in the page.

However the computer mentioned above only displays an advertisement related to a page in advance. Therefore the computer cannot provide the user with an advertisement or other service information independent of the current page.

Further such an advertisement or service information are displayed with taking no account of preference or interest of each user.

### SUMMARY OF THE INVENTION

It is an object of the present invention to provide a system and method for displaying information provided by a provider independently of the current page displayed at the request of a user.

It is another object of the present invention to provide a system and method for providing a user with information selected in accordance with a user preference.

According to one aspect, the present invention relates to an information processing system including a server and at least one client terminals, said server comprising receiving means for receiving information provided by a plurality of providers via an internet; and transmission means for transmitting information from the plurality of providers to said at least one client terminals, each of said at least one client terminals comprising: server information receiving means for receiving information transmitted from said server; and display means for displaying, while information in the internet is displayed in a first window by a browser, information received by said server information receiving means in a second window.

According to another aspect, the present invention relates to an information processing method comprising the steps of: receiving information provided by a plurality of providers by a server via an internet; transmitting information provided by the plurality of providers to at least one client terminals by said server; and displaying on said at least one client terminals, while information in the internet is displayed in a first window by a browser, information received from said server in a second window.

According to another aspect, the present invention relates to a client terminal connectable to a server for receiving information provided by a plurality of providers, said client terminal comprising: server information receiving means for receiving information transmitted from said server; and display means for displaying, while information in the internet is displayed in a first window by a browser, information received by said server information receiving means in a second window.

According to another aspect, the present invention relates to an information processing method in a client terminal connectable to a server for receiving information provided by a plurality of providers, said method comprising the steps of: receiving information provided by the plurality of providers via said server; and displaying, while information in the internet is displayed in a first window by a browser, information received from the plurality of providers via said server in a second window.

According to another aspect, the present invention relates to a computer readable program for processing information executed by a client terminal connectable to a server for receiving information from a plurality of providers, said program comprising the program steps of: receiving information from the plurality of providers via said server; and displaying, while information in the internet is displayed in a first window by a browser, information received from the plurality of providers via said server in a second window.

According to another aspect, the present invention relates to a server connectable to at least one client terminals, said server comprising: receiving means for receiving information provided by a plurality of providers via an internet; transmission means for transmitting information provided by the plurality of providers to said at least one client terminals; and transmission control means for controlling said transmission means to select and transmit predetermined information from among information provided by the plurality of providers.

According to another aspect, the present invention relates to an information processing method in a server connectable to at least one client terminals, said method comprising the steps of: receiving information provided by a plurality of providers via an internet; selecting predetermined information from among information provided by the plurality of providers in said receiving step; and transmitting the predetermined information selected in said selecting step to said at least one client terminals.

According to another aspect, the present invention relates to a computer readable program for processing information executed by a server connectable to at least one client terminals, said program comprising the program steps of: receiving information provided by a plurality of providers via an internet; selecting predetermined information from among information provided by the plurality of providers in said receiving step; and transmitting the predetermined information selected in said selecting step to said at least one client terminals.

According to another aspect, the present invention relates to an information processing system including a server and at least one client terminals, said server comprising: receiving means for receiving a page in an internet requested by a client terminal and information provided by a plurality of providers via the internet; and transmission means for transmitting the page and information provided by the plurality of providers to said client terminal, each of said at least one client terminals comprising: server information receiving means for receiving the page and information provided by the plurality of providers from said server; and display means for displaying the page in a first window and information provided by the plurality of providers in a second window.

According to another aspect, the present invention relates to an information processing method comprising the steps of: receiving by a server a page in an internet requested by a client terminal and information provided by a plurality of providers via the internet; transmitting the page and information provided by the plurality of providers from said server to said client terminal; and displaying the page in a first window and information provided by the plurality of providers in a second window.

According to another aspect, the present invention relates to a server connectable to at least one client terminals, said server comprising: receiving means for receiving a page in an internet requested by a client terminal and information provided by a plurality of providers via the internet; and transmission means for transmitting the page and information provided by the plurality of providers to said client terminal.

According to another aspect, the present invention relates to an information processing method in a server connectable to at least one client terminals, said method comprising the steps of: receiving a page in an internet requested by a client terminal and information provided by a plurality of providers via the internet; and transmitting the page and information provided by the plurality of providers to said client terminal.

According to another aspect, the present invention relates to a computer readable program for processing information executed by a server connectable to at least one client terminals, said program comprising the program steps of: receiving a page in an internet requested by a client terminal and information provided by a plurality of providers via the internet; and transmitting the page and information provided by the plurality of providers to said client terminal.

Other features and advantages of the present invention will be apparent from the following description taken in conjunction with the accompanying drawings, in which like reference characters designate the same or similar parts throughout the figures thereof

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram illustrating the hardware configuration according to an embodiment of the present invention.

FIG. 2 shows the functional block diagram of information processing system embodying the present invention.

FIG. 3 shows the functional block diagram of information browsing system embodying the present invention.

FIG. 4 is a flowchart of the main procedural steps of this embodiment.

FIG. 5 is a flowchart of INITIALIZE procedure.

FIG. 6 is a flowchart of the procedural steps of CreateSession ( ).

FIG. 7 is a flowchart of MAIN-PROCESSOR.

FIG. 8 is a flowchart of the procedural steps of UserAction.

FIG. 9 is a flowchart of the procedural steps of ProcessServiceUI ( ).

FIG. 10 is a flowchart of the procedural steps of CheckExisting ( ).

FIG. 11 is a flowchart of the procedural steps of ShowDetail ( ).

FIG. 12 is a flowchart of the procedural steps of ShowSession ( ).

FIG. 13 is a flowchart of the procedural steps of For Each Session, Sort KPTAction by Time.

FIG. 14 is a flowchart of the procedural steps of GetPreviousYearNodes.

FIG. 15 is a flowchart of the procedural steps of GetBeforeCurrMonthNodes.

FIG. 16 is a flowchart of the procedural steps of GetbeforeCurrWeekNodes.

FIG. 17 is a flowchart of the procedural steps of GetCurrWeekNodes.

FIG. 18 is a flowchart that procedural steps of ShowLinks ( ).

FIG. 19 is a flowchart of the procedural steps of Sort by keywords.

FIG. 20 is a flowchart of the procedural steps of ShowTreeView.

FIG. 21 is a flowchart of the procedural steps of ProcessLeafAction.

FIG. 22 is a flowchart of the procedural steps of ProcessNodeAction.

FIG. 23 is a flowchart of the procedural steps of Sort by Domain.

FIG. 24 is a flowchart of the procedural steps of Sort by Organization.

FIG. 25 is a flowchart of the procedural steps of Sort by Service Provider Information Type.

FIG. 26 is a flowchart of the procedural steps of ExecuteAction ( ).

FIG. 27 is a flowchart of the procedural steps of SaveContents ( ).

FIG. 28 is a flowchart of the procedural steps of WebFetch ( ).

FIG. 29 is a flowchart of the procedural steps of steps of SaveFileContents ( ).

FIG. 30 is a flowchart of the procedural steps of FillKPTAction.

FIG. 31 is a flowchart of the procedural steps of GetNextDataToShow ( ).

FIG. 32 is a flowchart of the procedural steps to see if any system task needs to be executed.

FIG. 33 is a flowchart of the procedural steps of TERMINATE.

FIG. 34 is a flowchart of the main procedural steps of server.

FIG. 35 is a flowchart of INITIALIZE_SERVER procedure.

FIG. 36 is a flowchart of the procedural steps of MAIN-PROCESSOR_SERVER procedure.

FIG. 37 is a flowchart of the procedural steps of UserAction ( ).

FIG. 38 is a flowchart of the procedural steps of SystemAction ( ).

FIG. 39 is a flowchart of the procedural steps of ExecuteServerAct ( ).

FIG. 40 is a flowchart of the procedural steps of GetInfo ( ).

FIG. 41 is a flowchart of TERMINATE_SERVER procedure.

FIG. 42 shows another example system architecture INK2 System, in which the User Settings are stored in individual clients.

FIG. 43 is a flowchart of the procedural steps of CreateSession ( ) of INK2 System.

FIG. 44 shows another example system architecture INK3 System, in which the User Settings and Information provided by the Information Provider are stored in individual clients.

FIG. 45 is a flowchart of the procedural steps of CreateSession ( ) of INK3 System.

FIGS. 46 and 47 show examples of the knowledge structures in the knowledge base.

FIGS. 48 and 49 show examples content of the knowledge base.

FIG. 50 shows an example content of the Domain knowledge base.

FIG. 51 shows example rules for determining the organization indices for a URL.

FIG. 52 shows example rules for determining the domain indices for a URL.

FIG. 53 shows an example of Information DB.

FIG. 54 shows another example of Information DB.

FIG. 55 shows an example of Customer DB.

FIG. 56 shows an example of User Settings DB.

FIG. 57 shows an example User Interface of this embodiment.

FIG. 58 shows an example User Interface when the Flash News is displayed from Service Provider.

FIG. 59 shows an example User Interface when Local weather forecast is displayed from Service Provider.

FIG. 60 shows an example User Interface when Banner Advertisement is shown from Service Provider.

FIG. 61 shows an example User Interface when Show Detail is pressed in previous figure.

FIG. 62 shows an example User Interface when Show Detail is shown as Pop-up Window.

FIG. 63 shows an example User Interface of information created dynamically by Service Provider.

FIG. 64 shows an example User Interface of special Summer Campaign information directed to specific end-users.

FIG. 65 shows an example User Interface of timely information or time bound real time information from Service Provider.

FIGS. 66 and 67 show examples of User Settings User Interface.

FIG. 68 shows an example Japanese Old Stories information provided by Service Provider.

FIG. 69 shows an example Daily English Lesson provided by Information Service Provider.

FIG. 70 shows an example Service of Technical Term information provided.

FIG. 71 shows an example Service of Difficult words in the page being browsed in main window.

FIG. 72 shows an example Service of Japanese Translation of the page being browsed.

FIG. 73 shows an example User Interface of Get All Links UI sorted by Information Type provided by Service Provider.

FIG. 74 shows an example User Interface of Get All Links of Business English Lessons.

FIG. 75 shows an example User Interface of Get All Links UI sorted by Organizations.

FIG. 76 shows an example User Interface of Get All Links UI sorted by Domains.

FIG. 77 shows an example User Interface of Get All Links UI sorted by Keywords.

FIG. 78 shows another example system architecture KPTIN1 System of this embodiment.

FIG. 79 is a flowchart of MAIN-PROCESSOR for KPTIN1 System.

FIG. 80 is a flowchart of the procedural steps of UserAction for KPTIN1 System.

FIG. 81 shows another example system architecture KPTIN2 System, in which the User Settings are stored in individual clients.

FIG. 82 shows another example system architecture KPTIN3 System, in which the User Settings and Information provided by the Information Provider are stored in individual clients.

FIG. 83 shows an example User Interface of KPTIN System.

FIG. 84 shows another example User Interface of KPTIN System.

FIG. 85 shows an example User Interface when customized Information is provided to by Information Provider.

FIG. 86 shows an example Pop-up of Detail information User Interface.

FIG. 87 shows an example User Interface when the main window and service provider information window have been swapped.

FIG. 88 shows an example User Interface when Banner Advertisement is shown from Service Provider.

FIG. 89 shows an example User Interface when Banner Advertisement is shown from Service Provider.

FIG. 90 shows an example User Interface when Show Detail is pressed in previous figure.

FIG. 91 shows an example Daily English Lesson provided by Information Service Provider.

FIGS. 92 to 94 shows some of the other examples of possible system architecture for this embodiment.

### DETAILED DESCRIPTION OF THE PREFERRED EMBODIMENT

A preferred embodiment of the present invention will now be described in detail with reference to the accompanying drawings.

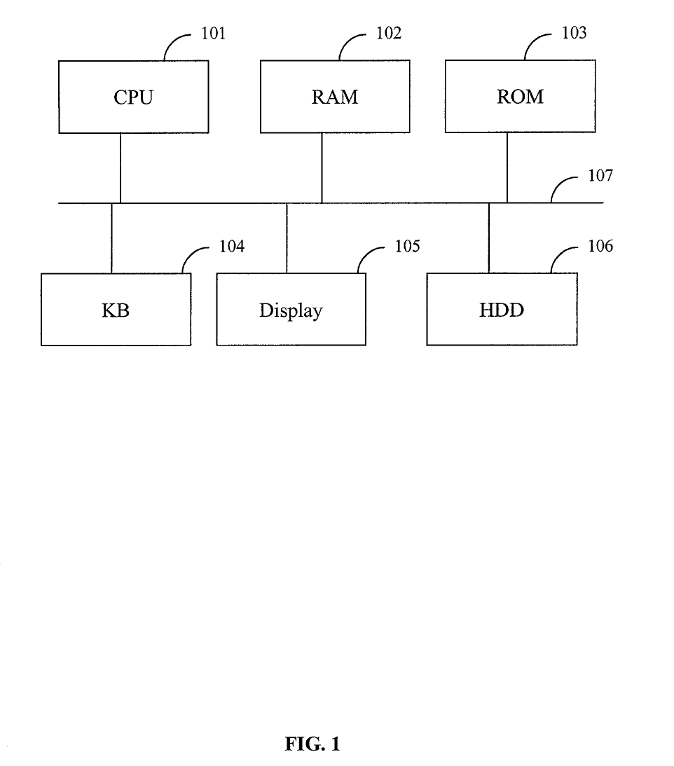

FIG. 1 is a block diagram illustrating the hardware configuration according to an embodiment of the present invention. In this figure, a central processing unit (CPU) 101 is operative to perform operations for various processing and make a logical decision or the like and further controls each composing element connected to a bus 107.

A RAM 102 is used to temporarily store variables and intermediate data generated during the processing. A program from an external source may be loaded into the RAM 102. A ROM 103 is used to store programs, which correspond to individual flowcharts that will be described later and which are to be executed by the CPU 101, and fixed data.

A keyboard (KB) 104 is used for inputting data and an instruction by a user. A mouse or other input devices may be used with the keyboard 104. Display 105 displays data and a hard disk drive (HDD) stores data of a database, a program, and the like.

The bus 107 is used to transfer an address signal indicating a composing element to be controlled by the CPU 101, a control signal used for controlling each composing element and data to be exchanged between the composing equipments.

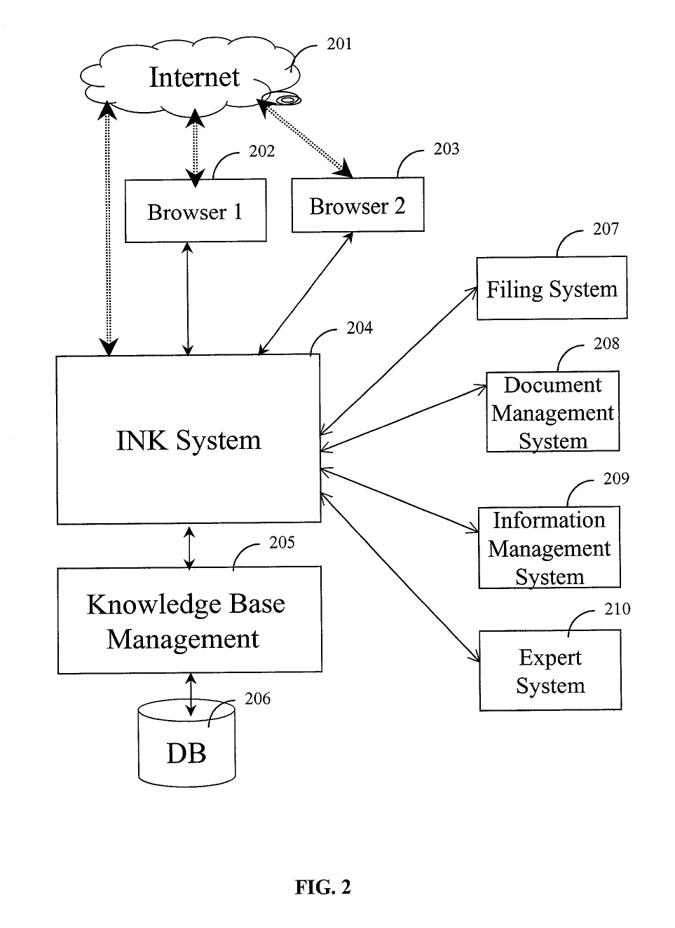

FIG. 2 shows the functional block diagram of information processing system embodying the present invention. Browser 202 is used for information browsing of the Web. Filing system 207 is for filing and managing files. Document Management System 208 is for managing documents. Information Management System 209 is for managing information other than documents. Expert System 210 is for providing expert information or services. INK System interacts and acts as a controlling system as explained in detail in this embodiment to Browser 202, Filing System 207, Document Management System 208, Information Management System 209 and Expert System 210. Knowledge Base Management 205, is the management of knowledge accessed/stored from/to the Database 206. The information on the Internet 201 is browsed using multiple browsers 202, 203 simultaneously and as explained in this embodiment, INK System 204 handles and processes them separately.

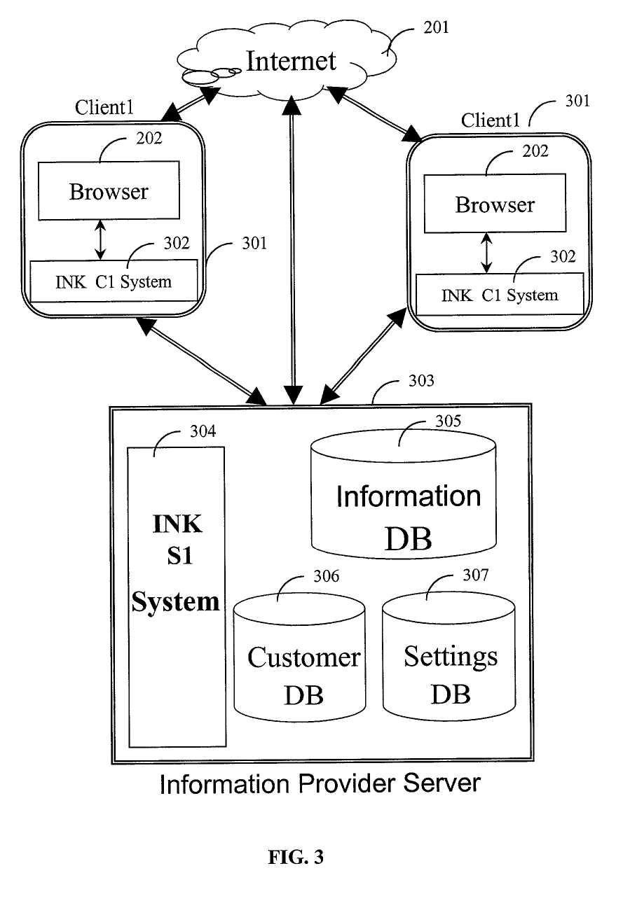

FIG. 3 shows the function block diagram of INK Client Server implementation of the System. The Client1 301 consists of Browser 202 and INK C1 System 302. The Information Provider Server 303 consists of INK S1 System 304, with information stored in Information DB 305, valid users or customers information stored in Customer DB 306 and user settings or preferences stored in Settings DB 307.

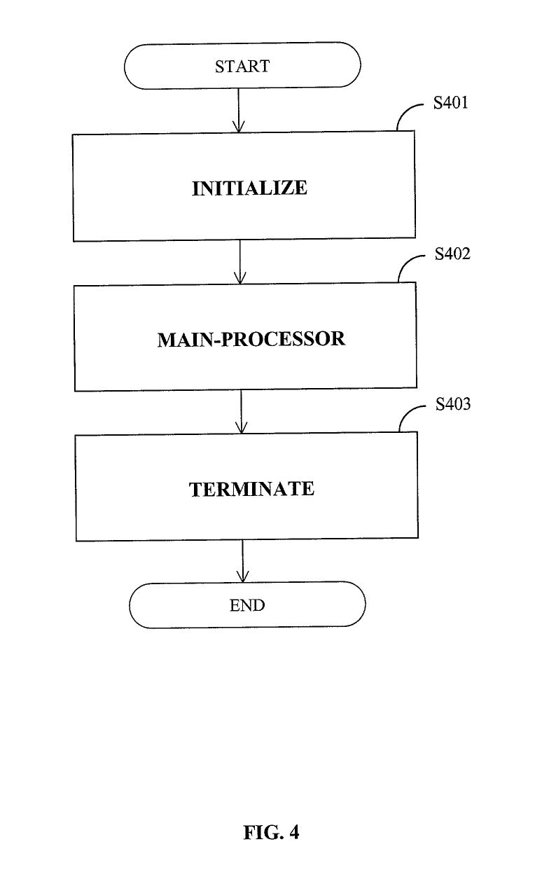

FIG. 4 is a flowchart of the main procedural steps of this embodiment. The following description is for an example system, which connects to the Internet and allows browsing and saving of the information. In step S401, initialization processes to connect to the Internet are executed. In step S402, main function processing browsing, saving, managing stored information etc. of this embodiment is performed. In step S403, terminate or clean-up processing is executed.

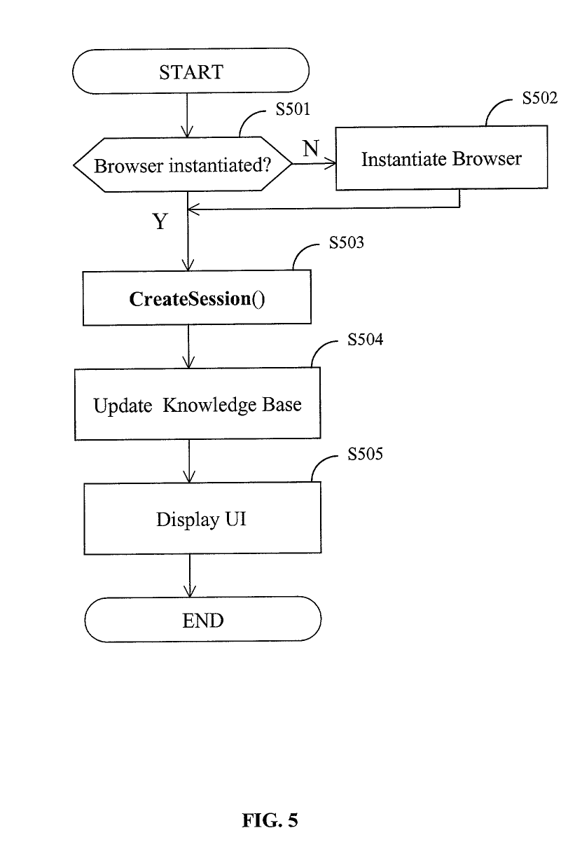

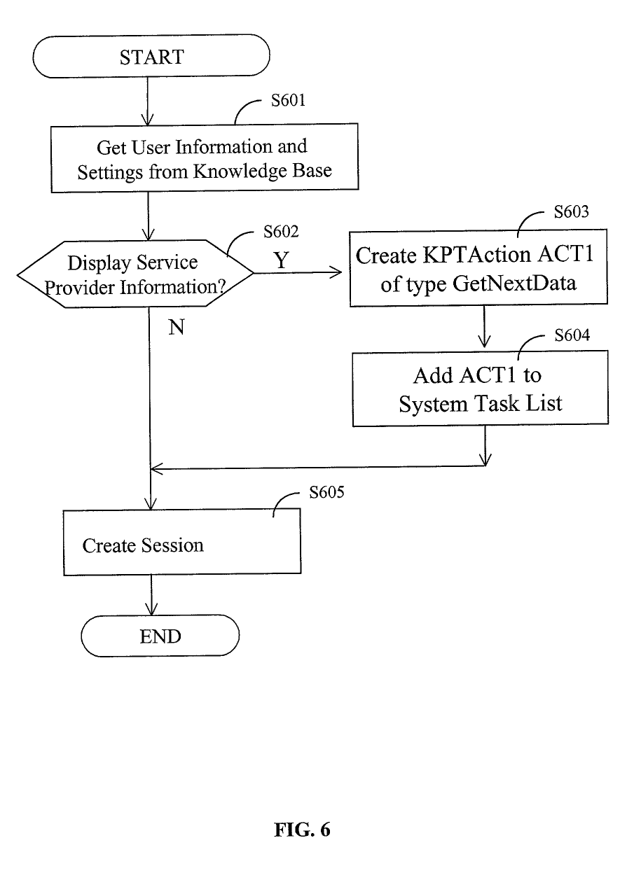

FIG. 5 is a flowchart of INITIALIZE procedure of step S401. In step S501 a check is made to determine if the browser needs to be instantiated or not. If browser is not instantiated, it is instantiated in step S502. In step S503, a new session is created in CreateSession ( ) which is executed as explained in detail in FIG. 6. In step S504, the knowledge base is updated. The main UI of this embodiment is displayed in step S505 and the process ends.

FIG. 6 is a flowchart of CreateSession of step S503. In step S601, the user information and the user preferences or settings are obtained from the knowledge base. A check is made in step S602 to determine if the Information from the Information or Service Provider needs to be displayed. If so, KPTAction ACT1 of type GetNextData is created in step S603 and added to System Task list in step S604. In either case the control proceeds to S605 where a new session is created.

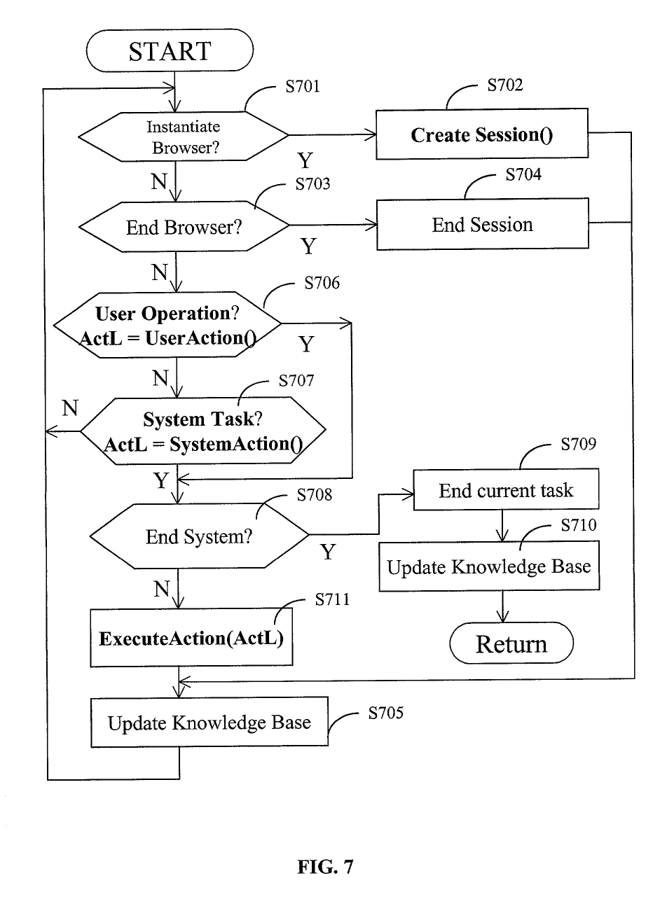

FIG. 7 is a flowchart of MAIN-PROCESSOR of step S402. In step S701, a check is made to determine if the browser was instantiated or not. If so, a new session is created in step S702 by executing CreateSession ( ) and the process proceeds to step S705, wherein the knowledge base is updated. If not, a check is made in step S703 to determine if the browser was terminated or ended. If so, the session associated with the browser is ended in step S704 and proceeds to step S705. If not, a check is made in step S706 to determine if any User Operation was performed. If so, the process proceeds to step S708. If not, a check is made in step S707 to determine if any System Task exists in System Task List. If not, the process proceeds to step S701 otherwise to step S708. A check is made in step S708 to determine if an action was performed to end the system. If so, all the current tasks are terminated in step S709 and knowledge base updated in step S710 and the process returns. If not, step S711 ExecuteAction(ActL) is executed and control moves to step S705 to update the knowledge base.

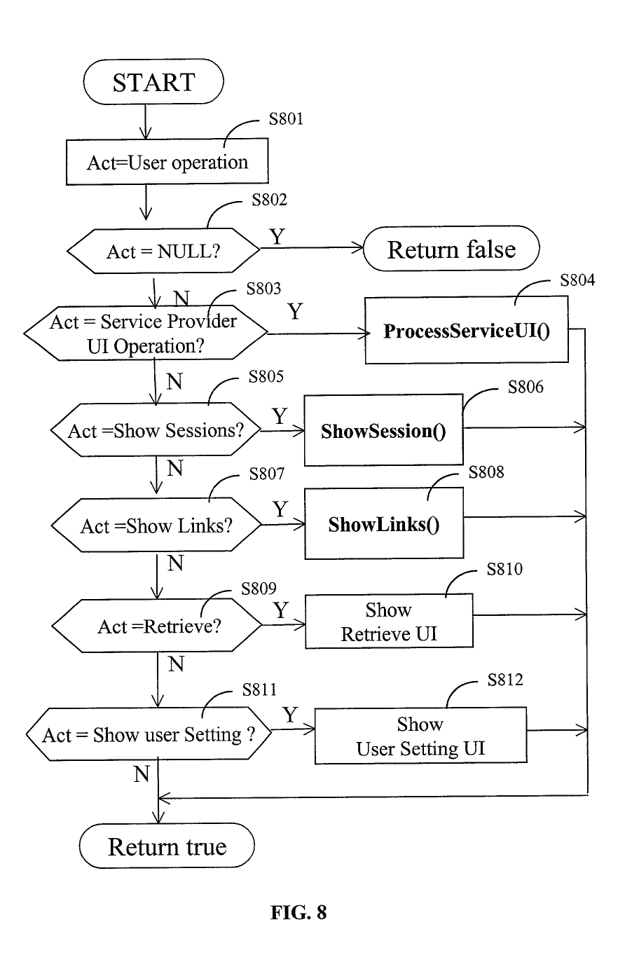

FIG. 8 is a flowchart of the procedural steps of S706 UserAction. In step S801 the user operation performed by the user is set to Act. A check is made in step S802 to determine if Act is equal to NULL. If so, the process returns false. If it is not NULL, the process proceeds to step S803, a check is made to determine whether Act is Service Provider UI Operation. If so, step S804, ProcessServiceUI ( ) which is explained later is executed and process returns true. If not, a check is made in step S805 to determine if Act is Show Sessions. If so, ShowSession ( ) as explained later is executed in step S806 and the process returns true. If not, a check is made in step S807 to determine if the Act is Show Links. If so, ShowLinks ( ) as explained later is executed in step S808 and the process returns true. If not, a check is made in step S809 to determine whether Act is Retrieve. If Act is retrieve, the process proceeds to step S810 where RetrieveUI is displayed. If not, a check is made in step S811 to determine whether Act is Show User Settings. If Act is User Settings, the process proceeds to step S812 where User Setting UI is displayed the process returns true.

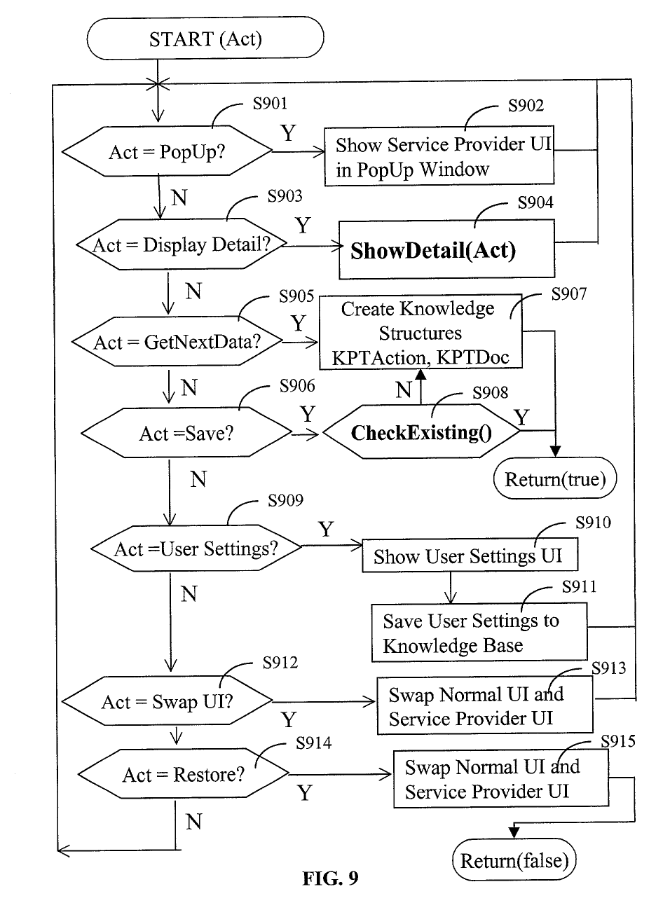

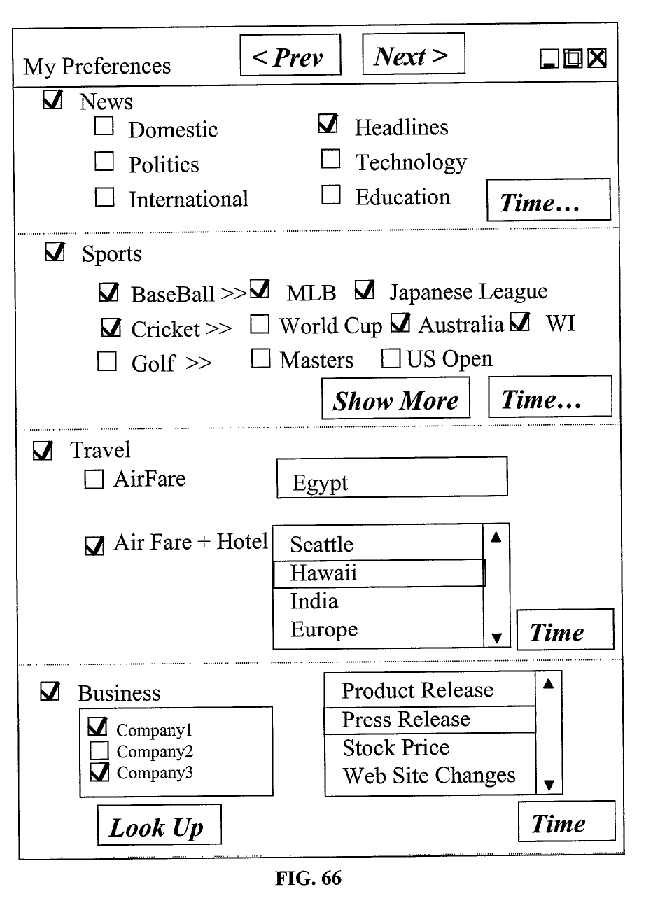

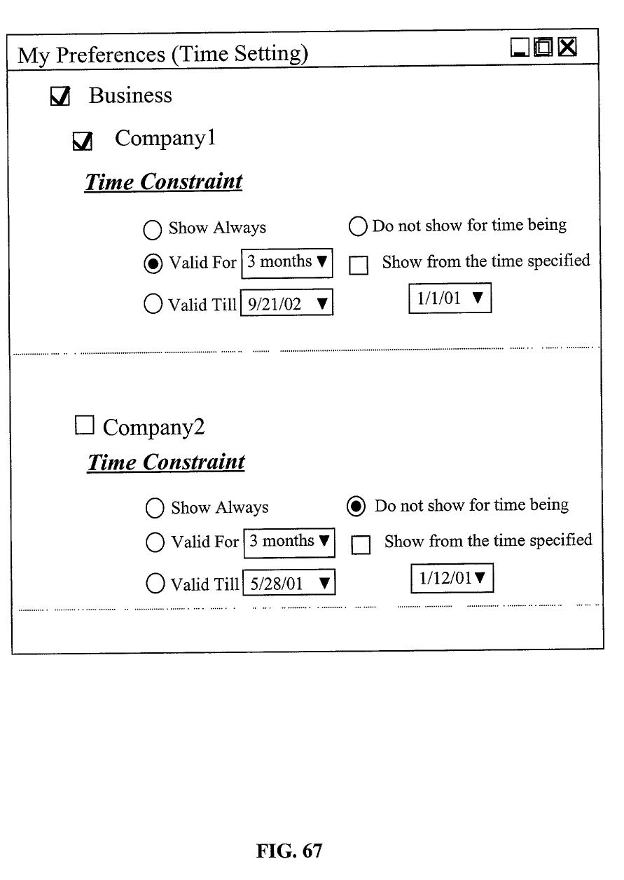

FIG. 9 is a flowchart of the procedural steps of S804, ProcessServiceUI of this embodiment. A check is made in step S901 to determine if the Act is PopUP. If so, the process proceeds to step S902, where the details of the service provider UI are shown in a Pop-up window. If not, a check is made in step S903 to determine if the Act is Display Detail. If so, ShowDetail ( ), which is described later is executed in step S904 and proceeds to step S901. If not, a check is made in step S905 to determine if Act is GetNextData. If so, the necessary Knowledge structures KPTAction, KPTDoc are created in step S907 and the process returns true. If not, a check is made in step S906 to determine if the Act is Save. If so, CheckExisiting ( ) is executed which is explained later in detail in step S908 and proceeds to step S907. If not, a check is made in step S909 to determine if the Act is User Settings. If so, step S910 is executed where in User Interface to get user preferences, examples of which are shown in Figs.66 and 67. The user preferences obtained are saved in the knowledge base in step S911 and the process proceeds to step S901. If not, a check is made in step S912 to determine if Act is SwapUI. If so, the normal UI in the main window and the Service Provider UI are swapped in step S913. If not a check is made in step S914 to determine if Act is Restore. If so, the Normal UI in the main window and the Service Provider UI window are swapped to normal and the process returns false.

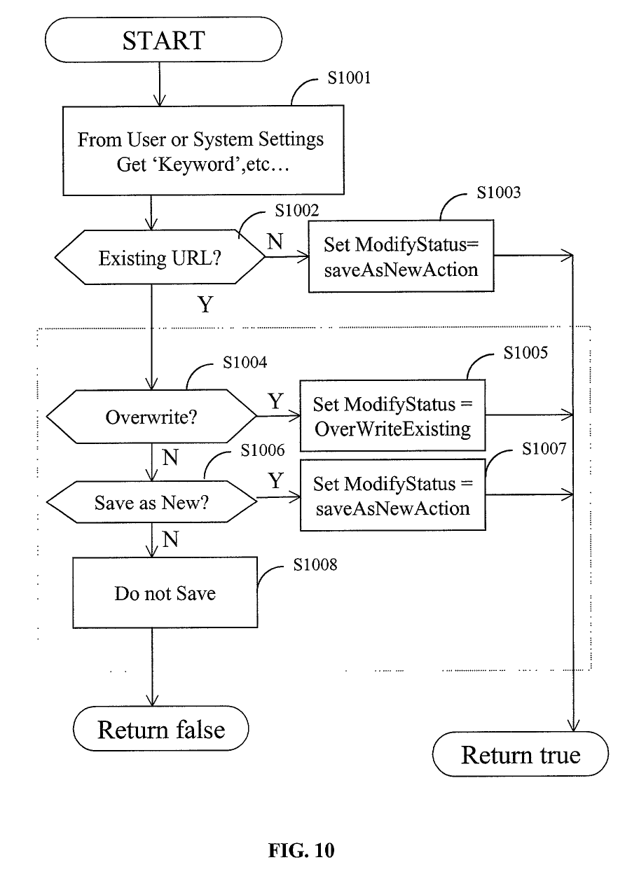

FIG. 10 is a flowchart of the procedural steps of S908, CheckExisting ( ) of this embodiment to check if the information already exists in the knowledge base or not. In step S1001, the values of Keyword, Validity Range etc . . . are either obtained from the user or from the system settings. In step S1002, a check is made to determine whether the URL already exists. If URL does not exist, the process proceeds to step S1003 where ModifyStatus is set to saveAsNewAction and returns true. If URL exists, a check is made in step S1004 to determine if the information needs to be over-written i.e., update or modify the previous information. This is done either by asking the user, whether he or she would like to overwrite the existing information, save as new, do not save or based on the user settings. If so, in step S1005, ModifyStatus is set to OverWriteExisting and the process returns true. If not, a check is made in step S1006 to determine if the information needs to be saved as new, i.e., without modifying the existing information, save the current information as a separate entity. If so, ModifyStatus is set to saveAsNewAction and the process returns true. If not, the process returns false.

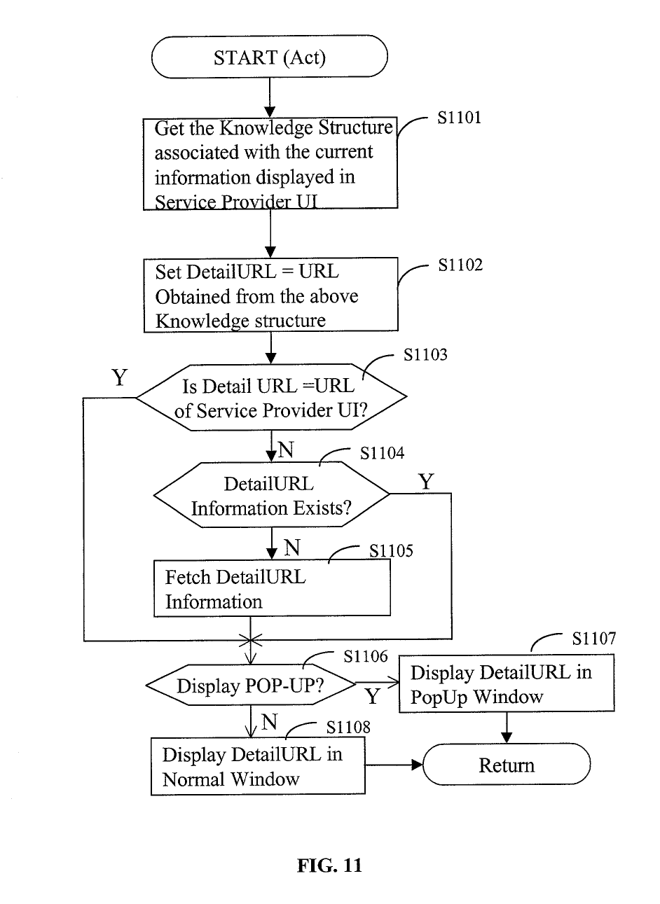

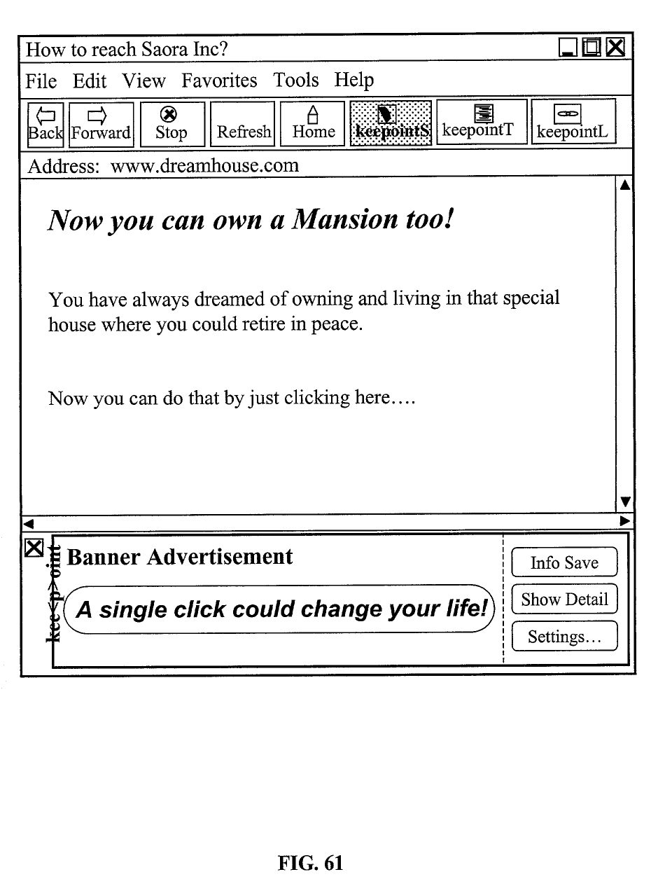

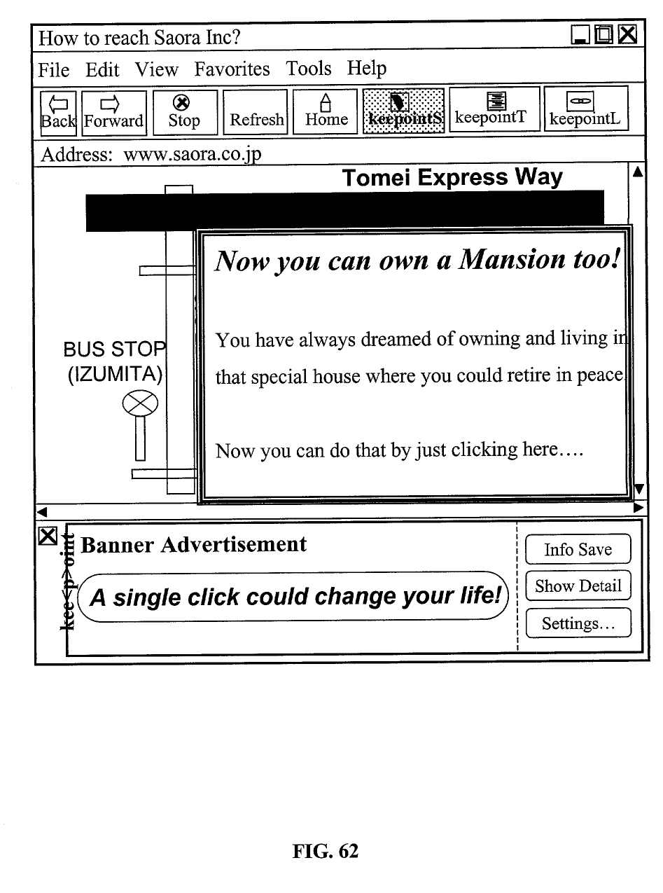

FIG. 11 is a flowchart of the procedural steps of S904, ShowDetail of this embodiment. In step S1101, the knowledge structures associated with the current information displayed by the Information Service Provider in the Service Provider UI is obtained. In step S1102, the DetailURL is set to the URL value obtained in previous step. A check is made in step S1103 to determine if the DetailURL and the URL of the Service provider UI being shown are equal or not. If so, the process proceeds to step S1106, otherwise a check is made in step S1104 to determine if the DetailURL information exists with the system. If so, the process proceeds to step S1106, otherwise the DetailURL information is procured in step S1105 and proceeds to step S1106. A check is made in step S1106 to determine if the information is to be displayed in a popup window. If so, the information is displayed in Popup window, an example of which is shown in FIG. 62 and the process returns. If not, the detail URL is shown in the normal window, an example of which is shown in FIG. 61.

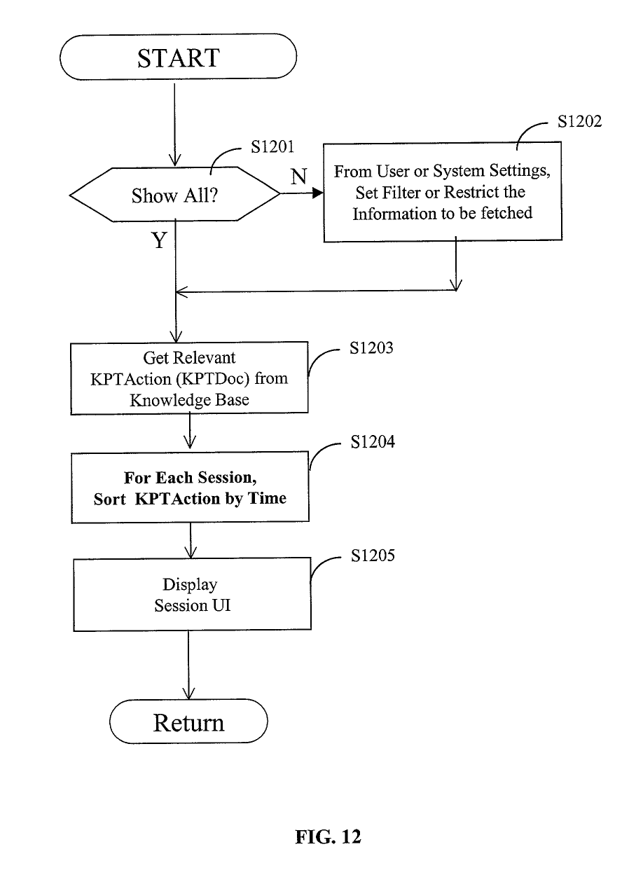

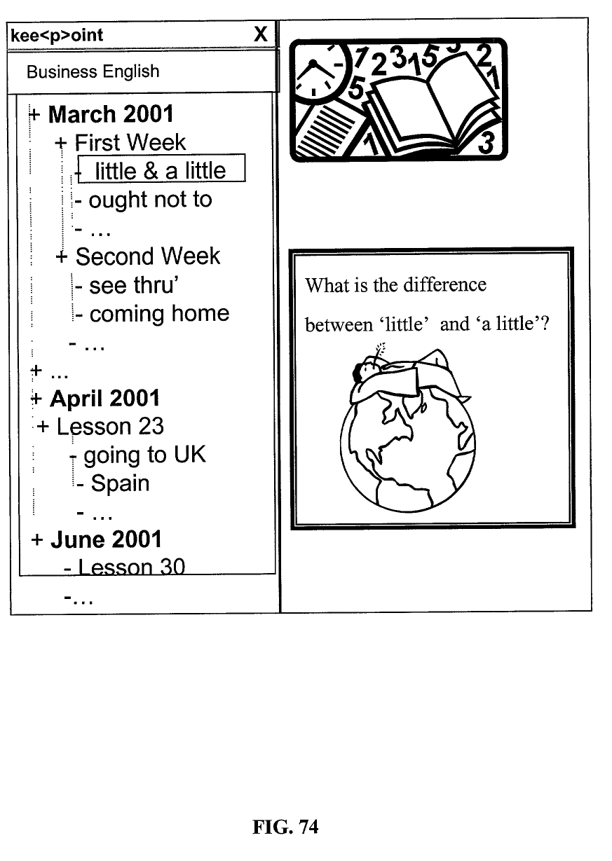

FIG. 12 is a flowchart of the procedural steps of S806, ShowSession of this embodiment. A check is made in step S1201 to determine if all the information needs to be displayed. If not, the process proceeds to step S1202, wherein based on either User settings and/or interaction and/or input and/or System settings, the filter or the constraint on the information to be displayed is obtained. In either case the process proceeds to step S1203, wherein the relevant KPTAction and the associated KPTDocument are got from Knowledge Base. In step S1204, KPTAction is sorted for each session by time as explained in detail later, in FIG. 10. In step S1205, Session UI is displayed, an example of which is shown in FIG. 74 and the process returns.

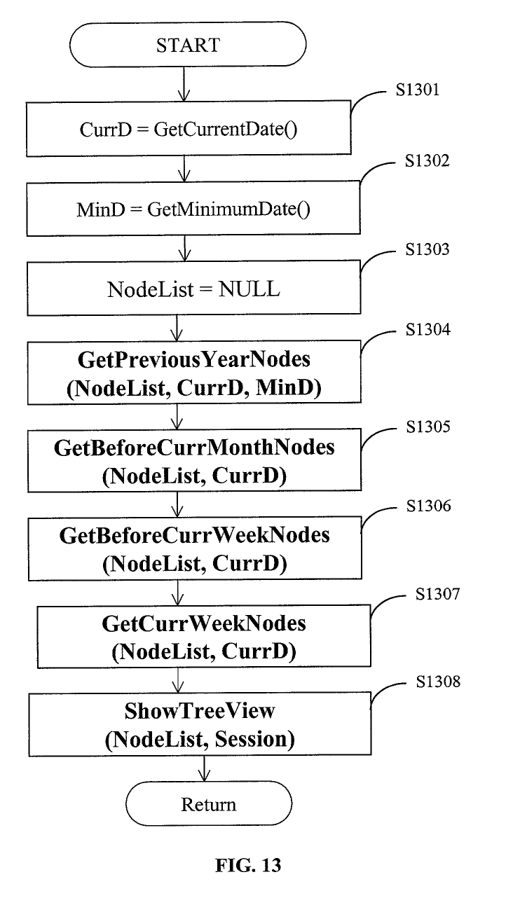

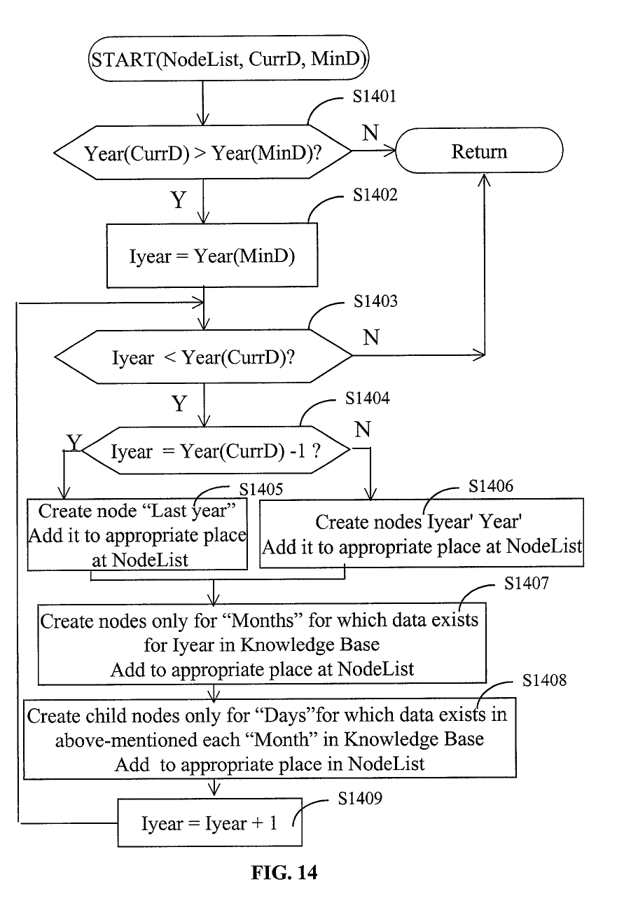

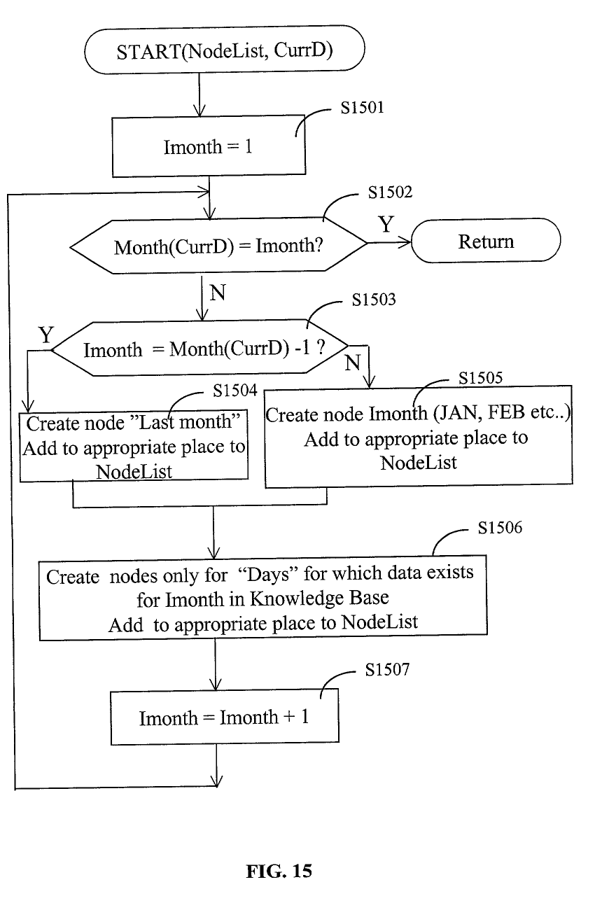

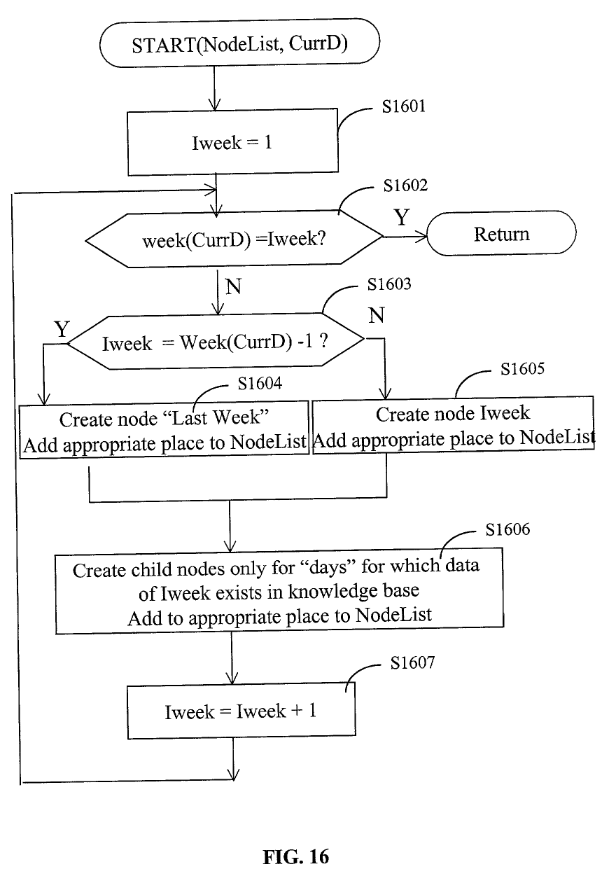

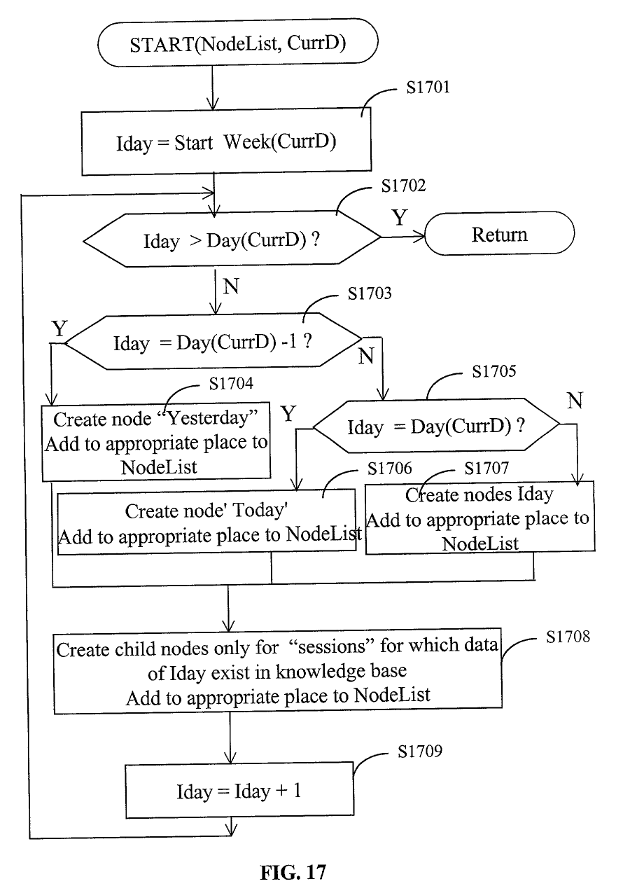

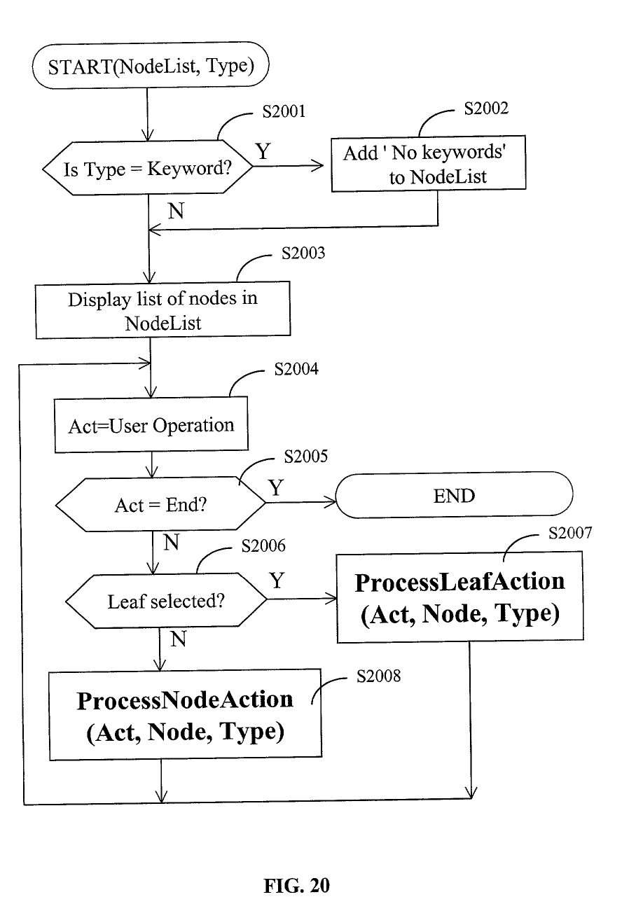

FIG. 13 is a flowchart of the procedural steps of For Each Session, Sort KPTAction by Time, step S1204 of this embodiment. Initially in step S1301, the CurrD is set to GetCurrentDate ( ), which the current date of the system. In step S1302, the MinD is set to GetMinimumDate ( ), which the minimum or earliest date for which information exists in the knowledge base. In step S1303, the NodeList is set to NULL. In step S1304, GetPreviousYearNodes(NodeList, CurrD, MinD) as detailed in FIG. 14 is executed. In step S1305, GetBeforeCurrMonthNodes(NodeList, CurrD) as detailed in FIG. 15 is executed. In step S1306, GetBeforeCurrWeekNodes (NodeList, CurrD) as detailed in FIG. 16 is executed. In step S1307, GetCurrWeekNodes(NodeList, CurrD) as detailed in FIG. 17 is executed. In step S1308, ShowTreeView(NodeList, Type) with Type=Session is executed as detailed in FIG. 20 and the example results are shown in FIG. 74, wherein the Sessions in the NodeList are displayed in sorted order.

FIG. 14 is a flowchart of the procedural steps of GetPreviousYearNodes (NodeList, CurrD, MinD) of step S1304 of this embodiment. A check is made in step S1401 to determine if Year(CurrD)>Year (MinD) i.e., the year part of CurrD is greater than the year part of MinD. If not, the process returns. If so, Iyear is set to Year(MinD) i.e., year part of MinD in step S1402. In step S1403, a check is made to determine if Iyear<Year(CurrD) i.e., Iyear is less than the year part of CurrD. If not, the process returns. If so, a check is made in step S1404 to determine if Iyear is equal to Year(CurrD)−1. If so, a node called ‘Last year’ is created and added to the appropriate place in NodeList in step S1405. If not, nodes for that year i.e., Iyear is created e.g., 1999 etc . . . and added to appropriate place in NodeList in step S1406. In either case, the step S1407 is executed, wherein nodes are created only for ‘Months’ e.g., January, June etc . . . for which data exists for the specified Iyear in the knowledge base and added to appropriate places in NodeList. In step S1408, nodes are created only for ‘Days’ e.g., 1, 3, 27 etc . . . for each of the above ‘Months’ for which data exists in the knowledge base and are added to appropriate places in NodeList. In step S1409, Iyear is incremented and the process continues to step S1403, till Iyear becomes greater than or equal to year part of CurrD, at which point the process returns.

FIG. 15 is a flowchart of the procedural steps of GetBeforeCurrMonthNodes (NodeList, CurrD) of step S1305 of this embodiment. Initially, in step S1501, Imonth is set to 1. A check is made in step S1502 to determine if Month(CurrD) i.e., month part of CurrD is equal to Imonth. If so, the process returns. If not, a check is made in step S1503 to determine if the values of Imonth and Month(CurrD)−1 are equal. If so, step S1504 is executed in which, a node called ‘Last month’ is created and added to appropriate place in NodeList. If not, step S1505 is executed in which, the node with Month name e.g., Jan or Jun etc . . . is created and added to appropriate place in NodeList. In either case, after completion, step S1506 is executed, wherein nodes are created only for ‘Days’ e.g., 1, 3, 27 etc . . . for each of the above ‘Months’ for which data exists in the knowledge base and are added to appropriate places in NodeList. In step S1507, Imonth is incremented and the process continues to step S1502, till Imonth is equal to the month part of CurrD, at which point the process returns.

FIG. 16 is a flowchart of the procedural steps of GetbeforeCurrWeekNodes (NodeList, CurrD) of step S1606 of this embodiment. Initially, in step S1601, Iweek is set to 1. A check is made in step S1602 to determine if Week(CurrD) i.e., week part of CurrD is equal to Iweek. If so the process returns. If not, a check is made in step S1603 to determine if the values of Iweek and Week(CurrD−1) are equal. If so, step S1604 is executed in which, a node called ‘Last Week’ is created and added to appropriate place in NodeList. If not, step S1605 is executed in which, the node with Iweek is created e.g., 1st week, 2nd week etc . . . and added to appropriate place to NodeList. In either case after completion, step S1606 is executed, wherein nodes are created only for ‘Days’ e.g., 1, 3, 27 etc . . . for each of the above ‘Weeks’ for which data exists in the knowledge base and are added to appropriate places in NodeList. In step S1607, Iweek is incremented and the process continues to step S1602, till Iweek is equal to the week part of CurrD, at which point the process returns.

FIG. 17 is a flowchart of the procedural steps of GetCurrWeekNodes (NodeList, CurrD) of step S1307 of this embodiment. Initially, in step S1701, Iday is set to StartofWeek(CurrD) i.e., the starting day of the current week. A check is made in step S1702 to determine if Iday is greater than the Day(CurrD) i.e., the day part of the CurrD. If so, the process returns. If not, in step S1703, a check is made to determine if Iday is equal to Day(CurrD)−1. If so, step S1704 is executed in which, a node called ‘Yesterday’ is created and added to appropriate place in NodeList and continues to step S1708. If not, step S1705 is executed in which, a check is made to determine if Iday is equal to Day(CurrD) i.e., current day. If so, step S1706 is executed in which, a node called ‘Today’ is created and added to appropriate place in NodeList and continues to step S1708. If not, nodes are created only for ‘Days’ e.g., 1, 3, 4 etc . . . for which data exists in the knowledge base and added to appropriate places in NodeList and continues to step S1708. In step S1708, child nodes are created for sessions of day(s) for which data exists in knowledge base and added to appropriate places to NodeList. Finally in step S1709, Iday is incremented by 1 and the process continues to step S1702, till Iday>Day(CurrD), at which point the process returns.

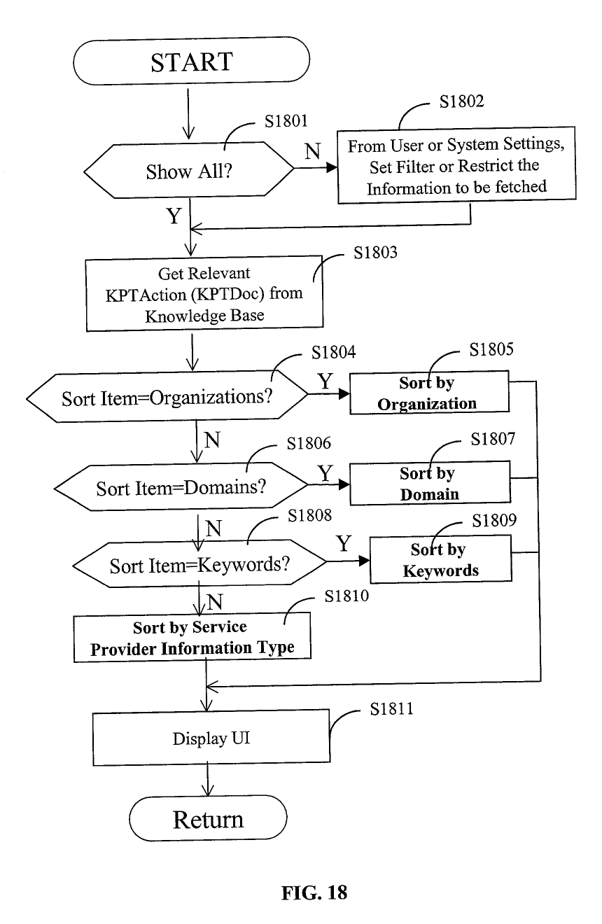

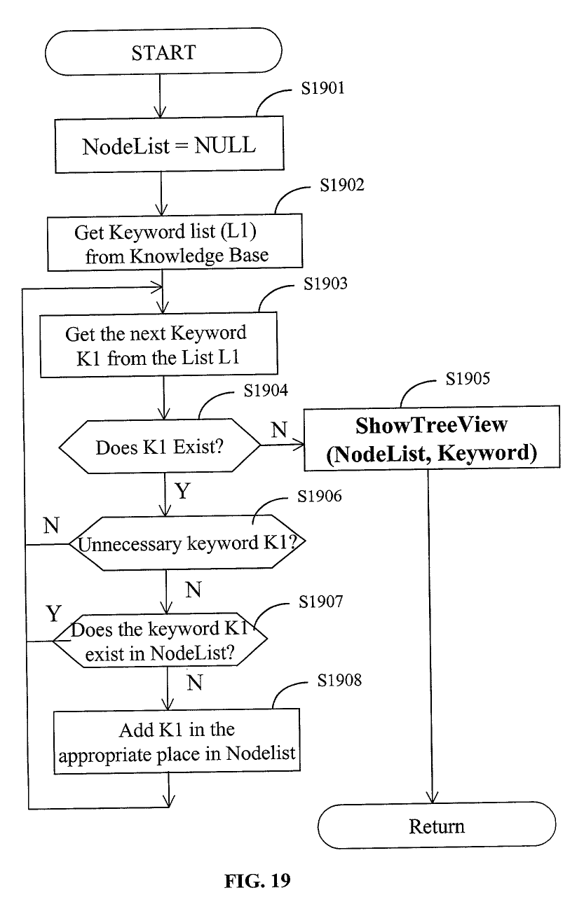

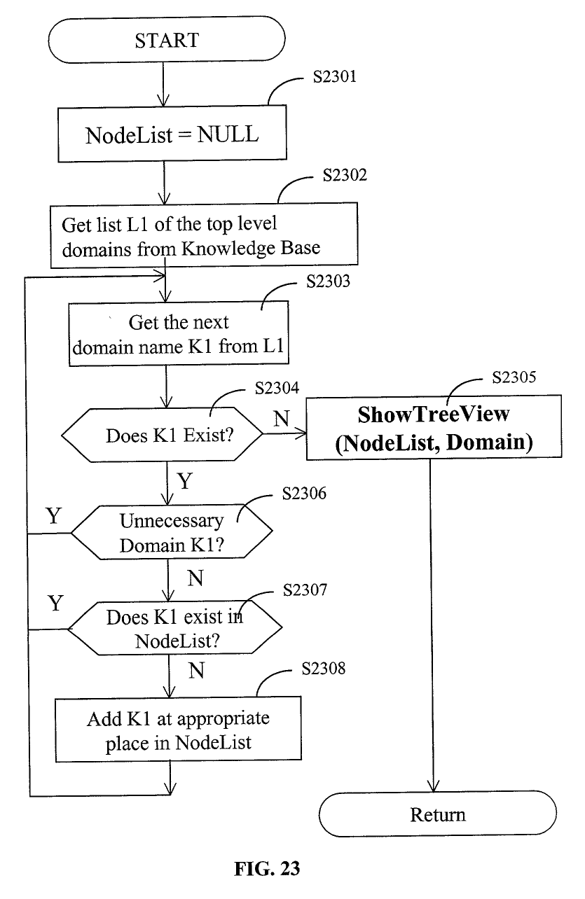

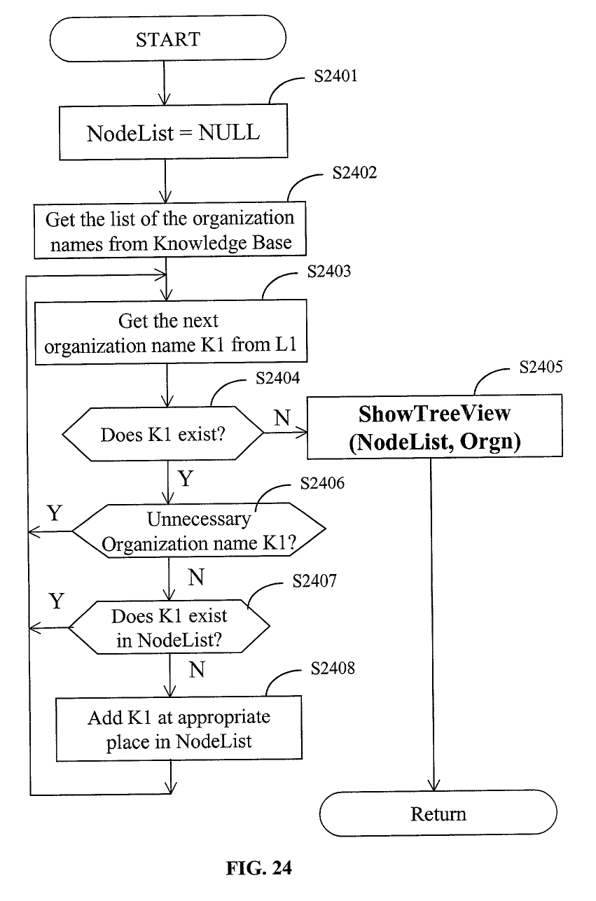

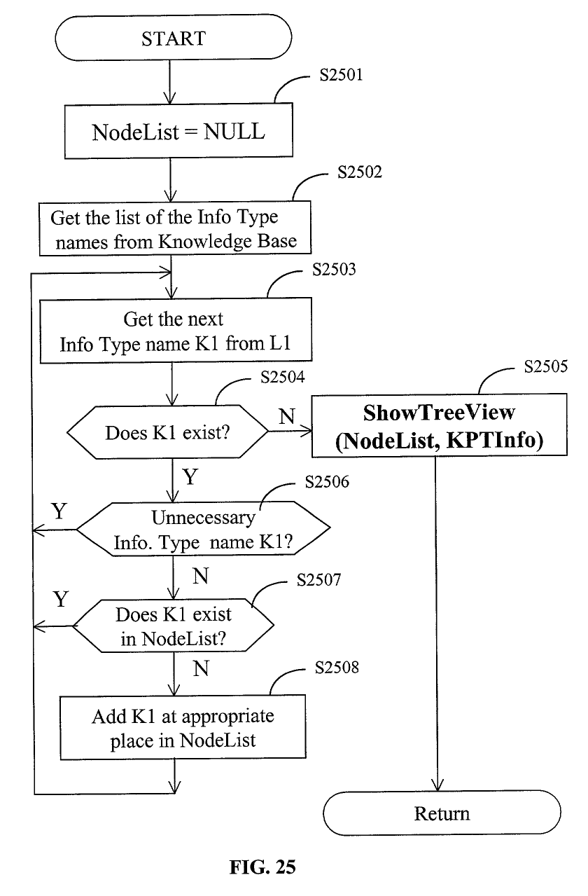

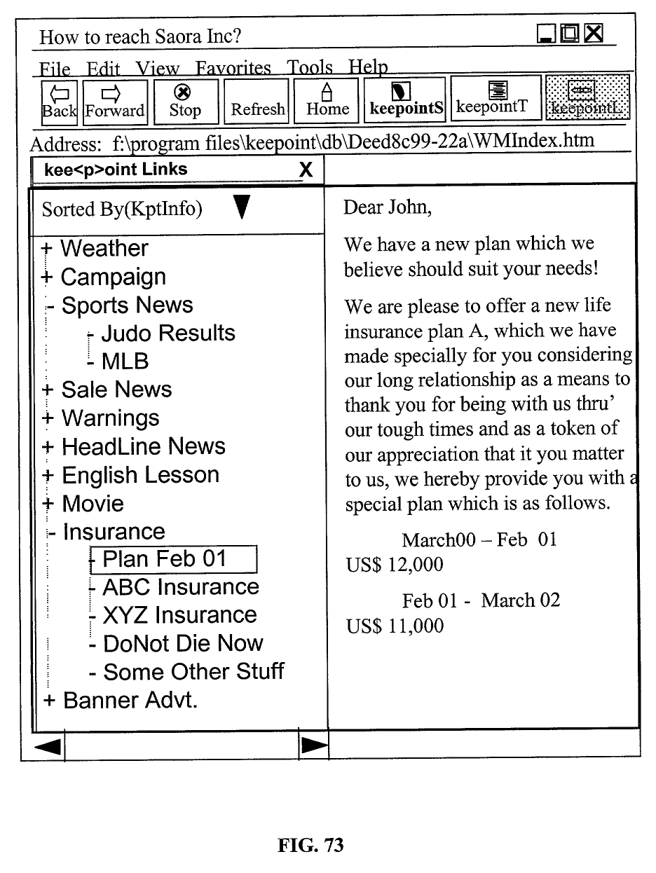

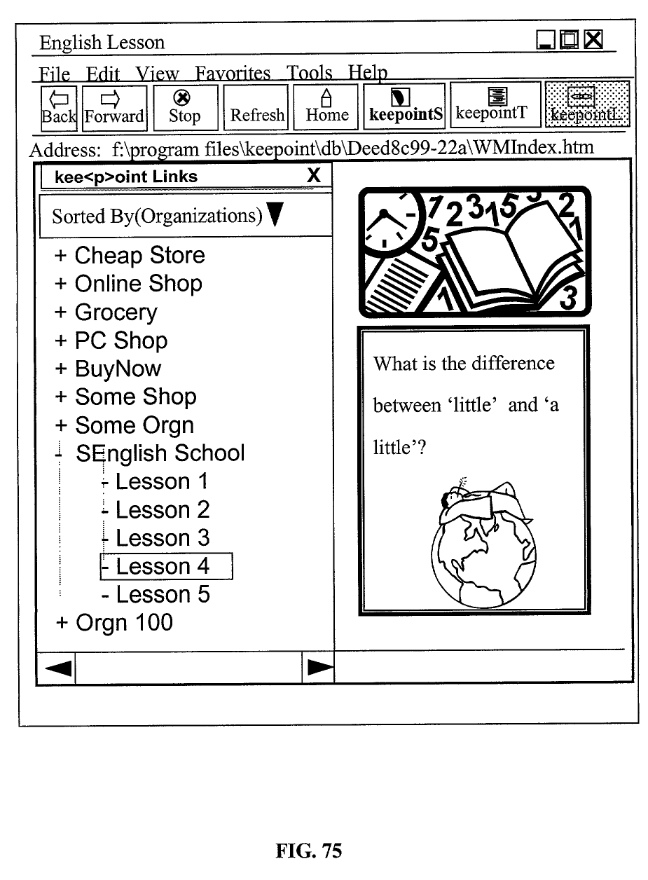

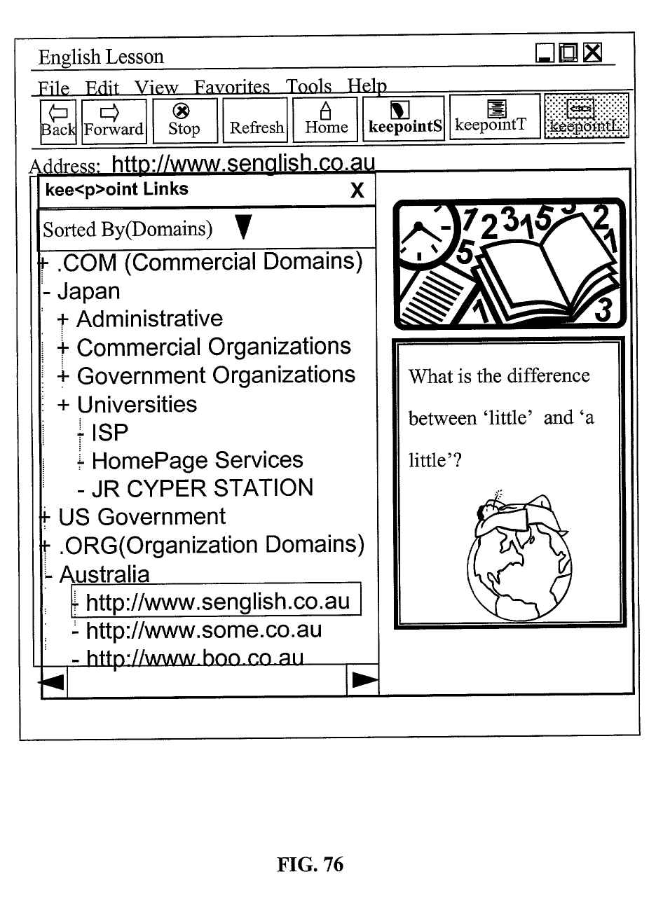

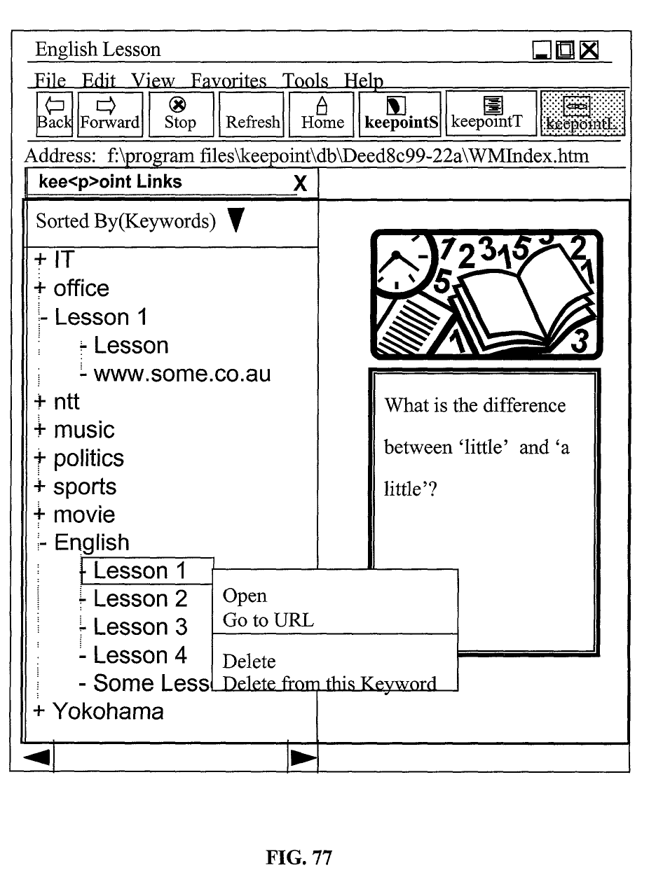

FIG. 18 is a flowchart that procedural steps of S808, ShowLinks of this embodiment. A check is made in step S1801 to determine if all the information needs to be displayed. If not, the process proceeds to step S1802, wherein based on either User settings and/or interaction and/or input and/or System settings, the filter or the constraint on the information to be displayed is obtained. In either case the process proceeds to step S1803, wherein the relevant KPTAction and the associated KPTDocument are got from Knowledge Base. In step S1804, a check is made to determine if the Sort Item is equal to Organizations. If so, the information is sorted by Organization, as explained in detail later in FIG. 24, in step S1805 and proceeds to S1811, where it is displayed, an example of which is shown in FIG. 75. If not, a check is made in step S1806 to determine if the sorting is by Domains. If so, the information is sorted by Domain, as explained in detail later in FIG. 23, in step S1807 and proceeds to step S1811, where it is displayed, an example of which is shown in FIG. 76. If not, a check is made in step S1808 to determine if the sorting is by Keywords. If so, the information is sorted by Keywords, as explained in detail later in FIG. 19, in step S1809 and proceeds to step S1811, where it is displayed, an example of which is shown in FIG. 77. If not, the information is sorted by Service provider Information Type, as explained in detail later in FIG. 25, in step S1810 and proceeds to step S1811, where it is displayed, an example of which is shown in FIG. 73 and the process returns.

FIG. 19 is a flowchart of the procedural steps of Sort by keywords S1809 of this embodiment. Initially in step S1901 the NodeList is set to NULL. In step S1902, the list of all keywords L1, is retrieved from the knowledge base. In step S1903, the next keyword K1 is fetched from the list of keywords L1. A check is made in step S1904 to determine if K1 exists. If so, a check is made in step S1906 to determine if it is a required keyword. If not, the control goes back to step S1903. If so, a check is made in step S1907 to determine if the keyword K1 already exists in the NodeList. If so, the control goes back to step S1903. If not, the keyword K1 is added at the appropriate place in the NodeList in step S1908 and control goes back to step S1903 to fetch the next keyword from the list. If K1 does not exist in step S1904, implying that all the keywords in the NodeList were processed and hence in step S1905, ShowTreeView(NodeList, Type) is executed with Type=Keyword, whose details are explained in FIG. 20 and the example results are shown in FIG. 77, wherein the keywords in the NodeList are displayed in the sorted order.

FIG. 20 is a flowchart of the procedural steps of ShowTreeView S1905 of this embodiment. First in step S2001, a check is made to determine if Type is Keyword. If so, No keywords is added to the NodeList in step S2002. In step S2003, the list of nodes in the NodeList is displayed. In step S2004 the process waits for user operation or Action Act and in step S2005, a check is made to determine if the Act is End, in which case the process returns. If not, a check is made in step S2006 to determine if a Leaf was selected. If so ProcessLeafAction(Act, Node, Type) is executed in step S2007. If not, ProcessNodeAction(Act, Node, Type) is executed in step S2008 and the process returns to step S2004.

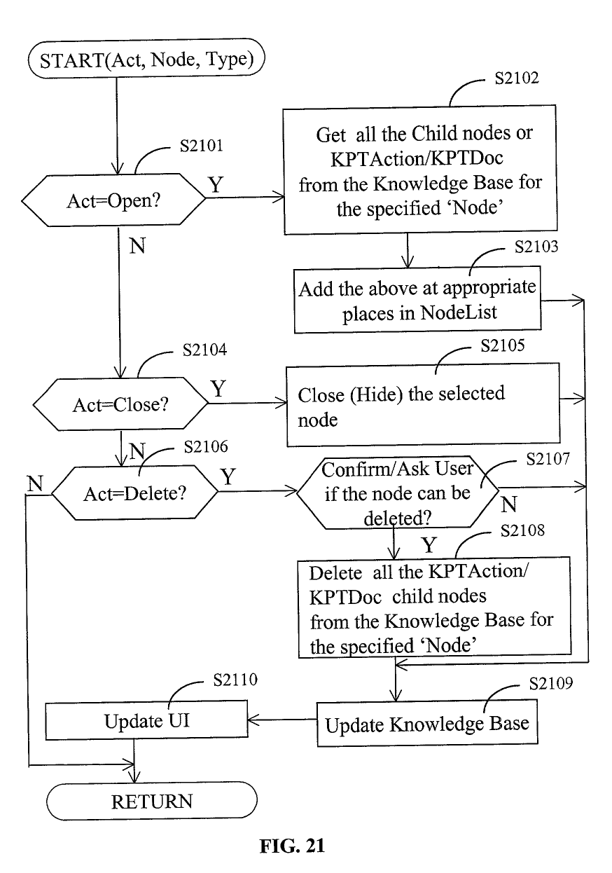

FIG. 21 is a flowchart of the procedural steps of ProcessLeafAction(Act, Node, Type) of step S2007 of this embodiment. A check is made in step S2101, if the Act is Open. If so, all the child nodes and all the actions KPTAction and associated KPTDocument are fetched in step S2102, from the knowledge base for the selected node and added to the NodeList at appropriate places in step S2103 and continues to step S2109. If not, a check is made in step S2104, if the Act is Close. If so, all the child nodes below the selected node are closed or hidden in step S2105 and continues to step S2109. If not, a check is made to determine if the Act is Delete. If so, a confirmation is sought from the user, if required, in step S2107 and if delete is not to be performed, it continues to step S2109, else all the KPTAction and associated KPTDocument for all the child nodes below the selected node is deleted from the knowledge base in step S2108 and continues to step S2109. In step S2109, the knowledge base is updated based on the type of action performed and in step S2110 the user interface is updated to reflect the updates made in the knowledge base. If in step S2106, the action is not Delete, the process returns.

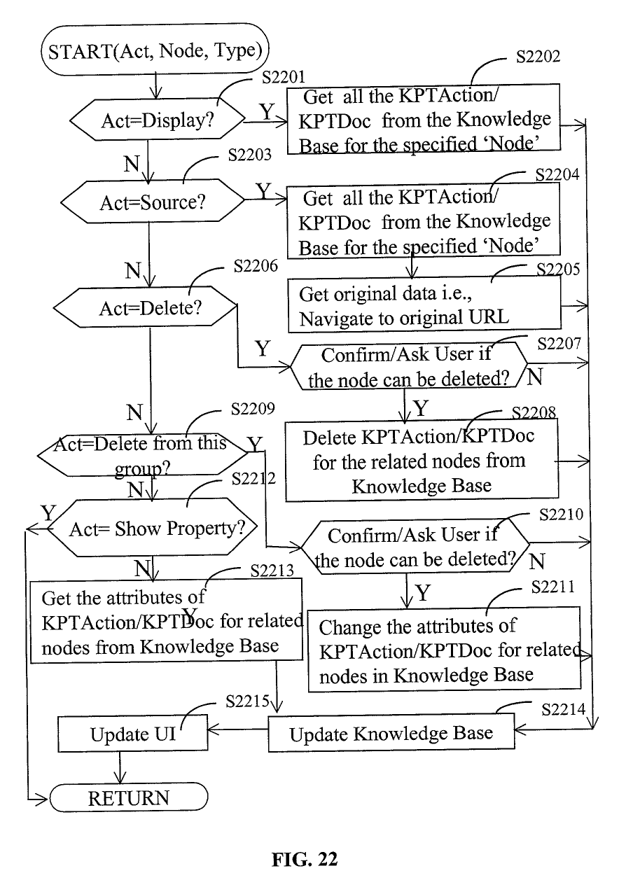

FIG. 22 is a flowchart of the procedural steps of ProcessNodeAction(Act, Node, Type) of step S2008 of this embodiment. A check is made in step S2201 to determine if the Act is Display i.e., to display the contents of the stored page, if contents are stored, otherwise, the original page needs to be displayed. If so, KPTAction and associated KPTDocument are fetched from the knowledge base for the selected node and added to the NodeList at appropriate place in step S2202 and continues to step S2214. If not, a check is made in step S2203 to determine if the Act is Source i.e., to display the contents of the original page. If so, the KPTAction and associated KPTDocument are fetched from the knowledge base for the selected node in step S2204 and fetches the contents of the page from the original location or URL in step S2205 and continues to step S2214. If not, a check is made to determine if the Act is Delete in step S2206. If so, a confirmation is sought from the user, if required, in step S2207 and if delete is not to be performed, it continues to step S2214, else in step S2208, the associated KPTAction and KPTDocument are deleted from the knowledge base and continues to step S2214. If not, a check is made in step S2209 to determine if the Act is Delete from this group. If so, a confirmation is sought from the user, if required, in step S2210 and if delete is not to be performed, it continues to step S2214, else in step S2211, the associated attributes or properties of KPTAction and KPTDocument are modified in the knowledge base and continues to step S2214. If not, a check is made in step S2212 to determine if the Act is Show Property. If so, the associated properties or attributes of the KPTAction and KPTDocument for the associated node are fetched from the knowledge base in step S2213 and continues to step S2214. In step S2214, the knowledge base is updated based on the type of action performed and in step S2215 the user interface is updated to reflect the updates made in the knowledge base. If in step S2212, the action is not Show Property, the process returns.

FIG. 23 is a flowchart of the procedural steps of Sort by Domain step S1807 of this embodiment. Initially the NodeList is set to NULL in step S2301. In step S2302, all the top level domain list L1 are fetched from the knowledge base. In step S2303, the next domain name K1 in list L1 is fetched. A check is made in step S2304 to determine if the domain name K1 exists. If so, a check is made in step S2306 to determine if the domain name K1 is unnecessary or not required domain. If so, it continues to step S2303 to fetch the next domain name from the list. If not, a check is made in step S2307 to determine if the K1 is already present in L1, if so, it continues to step S2303 otherwise the domain name K1 is added to the NodeList at the appropriate place in step S2308 and then continues to step S2303. In step S2304, if K1 does not exist, implying that all the items in the list L1 have been processed, FIG. 20 ShowTreeView(NodeList, Type), with Type=Domain is executed in step S2305 and the example results are shown in FIG. 76, wherein the Domains in the NodeList are displayed in the sorted order.

FIG. 24 is a flowchart of the procedural steps of Sort by Organization step S1805 of this embodiment. Initially the NodeList is set to NULL in step S2401. In step S2402, list of all the organizations L1 are fetched from the knowledge base. In step S2403, the next organization name K1 in list L1 is fetched. A check is made in step S2404 to determine if the organization name K1 exists. If so, a check is made in step S2406 to determine if the organization name K1 is unnecessary or not required entry. If so, it continues to step S2403 to fetch the next organization name from the list. If not, a check is made in step S2407 to determine if the K1 is already present in L1, if so, it continues to step S2403 otherwise the organization name K1 is added to the NodeList at the appropriate place in step S2408 and then continues to step S2403. In step S2404, if K1 does not exist, implying that all the items in the list L1 have been processed, FIG. 20 ShowTreeView(NodeList, Type), with Type=Orgn is executed in step S2405 and the example results are shown in FIG. 75, wherein the Organizations in the NodeList are displayed in the sorted order.

FIG. 25 is a flowchart of the procedural steps of Sort by Service Provider Information Type step S1810 of this embodiment. Initially the NodeList is set to NULL in step S2501. In step S2502, list of all the Information Type names L1 are fetched from the knowledge base. In step S2503, the next Information Type name K1 in list L1 is fetched. A check is made in step S2504 to determine if the Information Type K1 exists. If so, a check is made in step S2506 to determine if the Information Type K1 is unnecessary or not required entry. If so, it continues to step S2503 to fetch the next Information Type from the list. If not, a check is made in step S2507 to determine if the K1 is already present in L1, if so, it continues to step S2503 otherwise the Information Type K1 is added to the NodeList at the appropriate place in step S2508 and then continues to step S2503. In step S2504, if K1 does not exist, implying that all the items in the list L1 have been processed, FIG. 20 ShowTreeView(NodeList, Type), with Type=KPTInfo is executed in step S2505 and the example results are shown in FIG. 73, wherein the Service Provider Information Types in the NodeList are displayed in the sorted order.

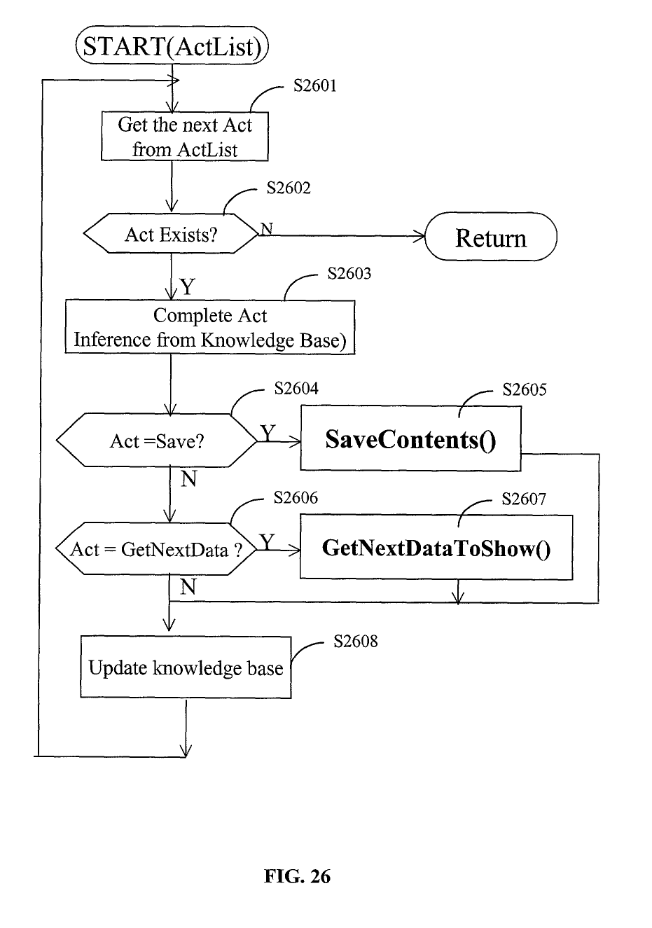

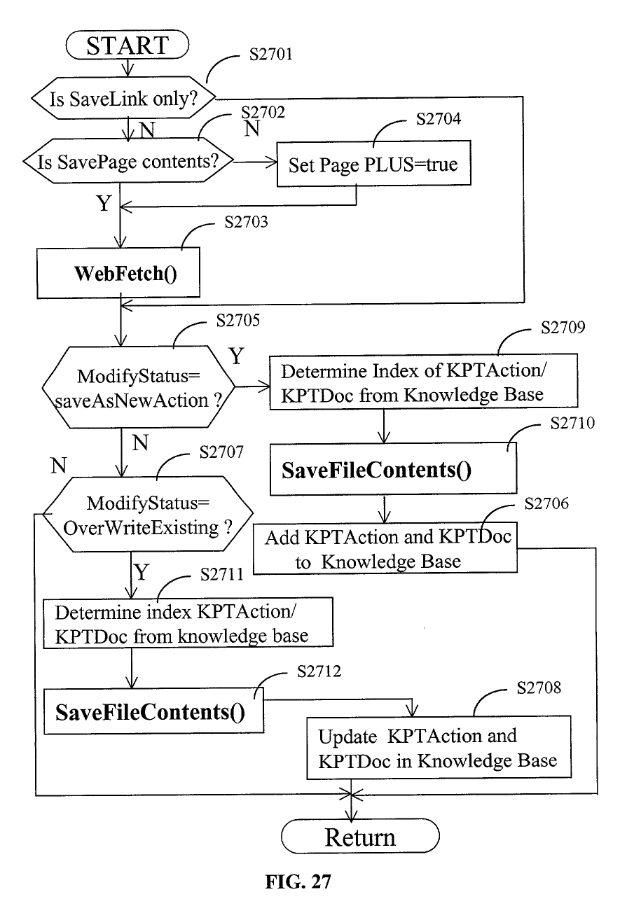

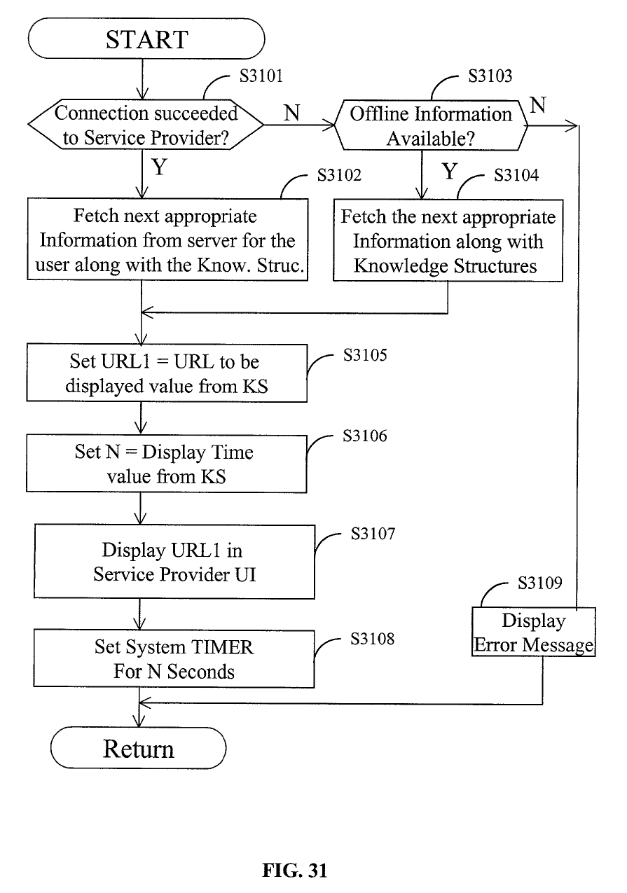

FIG. 26 is a flowchart of the procedural steps of S711, ExecuteAction of this embodiment. In step S2601, the next Act is got from the ActList. In step S2602, a check is made to determine if Act exists. If not, the process returns. Otherwise, in step S2603 inference is made using the knowledge base to complete the Act. A check is made in step S2604 to determine if Act is Save. If so, step S2605, SaveContents ( ) as explained later in FIG. 27 is executed and goes to step S2608. If not, a check is made in step S2606 to determine if Act is GetNextData. If so, step S2607, GetNextDataToShow ( ) as explained later in FIG. 31 is executed and goes to step S2608 wherein the knowledge base is updated and the process returns to step S2601 to fetch the next action from the ActList, till there are no more action left to be processed, at which stage the process returns.

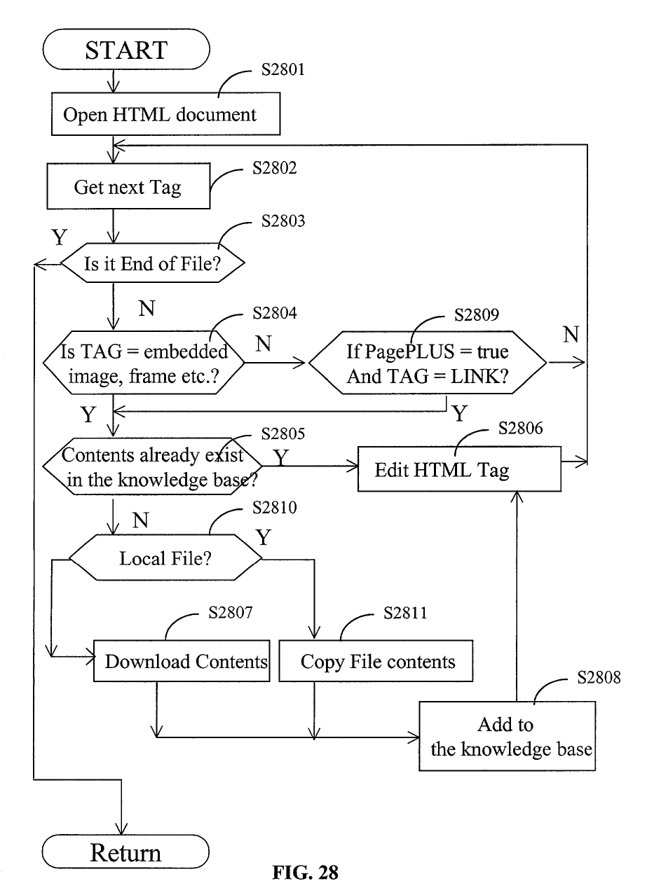

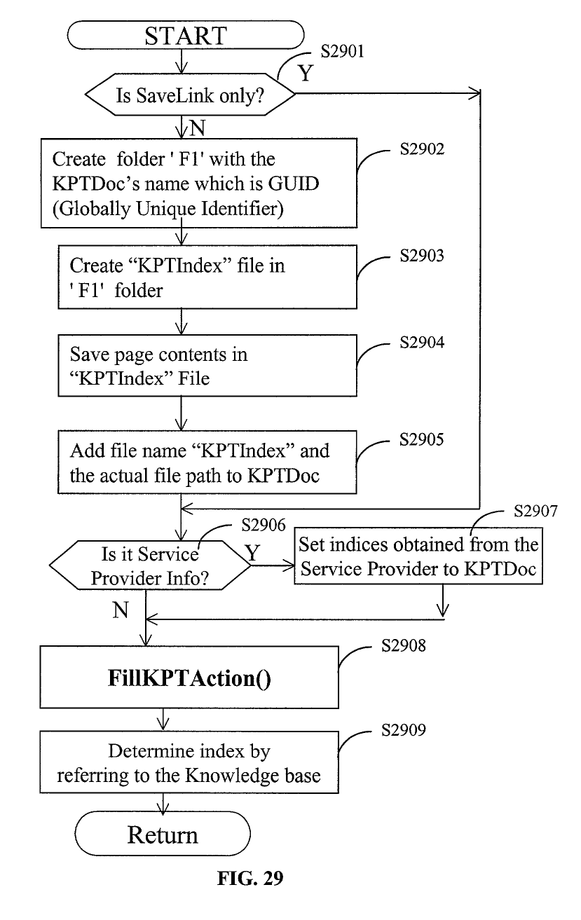

FIG. 27 is a flowchart of the procedural steps of SaveContents in step S2605 of this embodiment. A check is made in step S2701 to determine if it is a SaveLink only operation. If so, process proceeds to step S2705. Otherwise, a check is made to determine if it is a SavePage contents operation in step S2702. If so, Page PLUS is set to true in step S2704. In either case, step S2703, WebFetch ( ) is executed, which is explained in detail later in FIG. 28, in step S2703. In step S2705, a check is made to determine if ModifyStatus is saveAsNewAction or not. If so, indicies of KPTAction and the associated KPTDocument is determined from Knowledge Base in step S2709 and SaveFileContents ( ) is executed as explained in Fig.29, in step S2701. The KPTAction and KPTPerson are added to Knowledge Base in step S2706 and the process returns. If ModifyStatus is not saveAsNewAction, check is made in step S2707 to determine if it is OverWriteExisiting. If not the process returns, otherwise, in step S2711 indicies of KPTAction and the associated KPTDocument is determined from Knowledge Base in step S2711 and SaveFileContents ( ) is executed as explained in Fig.29, in step S2712. The KPTAction and KPTPerson are updated in the Knowledge Base in step S2708 and the process returns.

FIG. 28 is a flowchart of the procedural steps of WebFetch in step S2703 of this embodiment. In step S2801, HTML document obtained from the browser is opened. In step S2802, next tag is got. In step S2803, a check is made to determine if the end of file has been reached. If so the process returns. If not, a check is made to determine if the tag is for an embedded image, frame etc. in step S2804. If so, step S2805 is executed. If not, a check is made in step S2809 to determine if PagePLUS is true and the Tag type is of LINK. If not the process returns back to step S2802 to fetch the next tag. Otherwise, step S2805 is executed in which a check is made to see if the contents i.e., embedded images etc. already exist in our knowledge base and they are upto date in step S2805. If so, the HTML tag is edited in step S2806 to change the absolute or original path to the local path of the system where the file exists and process returns to step S2802. If not, a check is made to determine if the file to be fetched is a local file in step S2810. If so, the file contents are just copied, using a simple file copy command in step S2811, otherwise the contents are downloaded from the internet in step S2807. In either case step S2808 is executed, wherein the knowledge base is modified to update the information downloaded etc. and process returns to step S2802 to fetch the next tag in the HTML document. The process continues till end of file is reached at which instant the process returns.

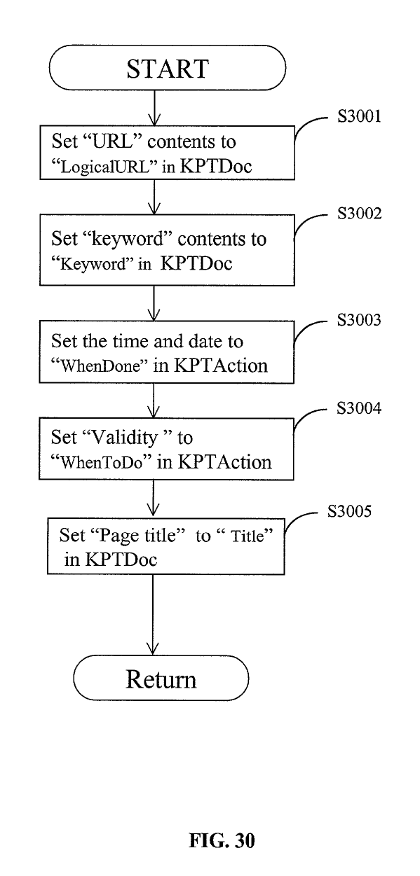

FIG. 29 is a flowchart of the procedural steps of steps S2710, S2712 SaveFileContents ( ) of this embodiment. A check is made in step S2901 to determine if the contents to be saved is SaveLink only. If so, the process continues to step S2908. In step S2902, a folder F1 with the name based on the KPTDocument's name, which is a Globally unique identifier (GUID) is created, which ensures that the folder to be created is unique within and across the local system. In step S2903, a file called KPTIndex is created in the folder created in previous step. The actual page contents i.e., HTML text are saved to the file created in the previous step. The fully qualified file name i.e., the folder name and the file name are stored as the physical URL location of the KPTDocument. A check is made in step S2906 to determine if the information was a Service Provider Information. If so, the indices obtained from the Service provider either along with it or otherwise are procured and set in the KPTDoc in step S2907. In either case, step S2908, FillKPTAction ( ) is executed which is explained in detail in FIG. 30 and the other required indices are determined by referring to the knowledge base in step S2909 and the process returns.

FIG. 30 is a flowchart of the procedural steps of S2908, FillKPTAction ( ) of this embodiment. In step S3001, the contents of ‘URL’ are set to ‘LogicalURL’ field of KPTDocument. In step S3002, the contents of ‘keyword’ are set to ‘Keyword’ field of KPTDocument. In step S3003, the time and date are set to ‘WhenDone’ field of KPTAction. In step S3004, the ‘Validity’ is set to ‘WhenToDo’ field of KPTAction and in step S3005, ‘Page title’ is set to ‘Title’ of KPTDocument and process returns.

Thus, when the user just clicks on Save, this embodiment does not ask the user for file name or destination folder location and the actual process of saving the information in a one-touch operation. Also the same information be it a page or link can be stored multiple times i.e., store the contents of the same link as many times as the user wishes, without ever specifying the filename, and still be able to retrieve them easily.

FIG. 31 is a flowchart of the procedural steps of S2607, GetNextDataToShow ( ) of this embodiment. A check is first made in step S3101 to determine if the connection to Service Provider could be successfully be established. If so, the next appropriate information is fetched from the server for the current user along with the knowledge structures in step S3102. If not, a check is made in step S3103 to determine if any information is available offline. If not, an error message is displayed in step S3109 to the user and the process returns. Otherwise, the next appropriate information along with the knowledge structure is fetched in step S3104. The URL to be displayed is set to URL1 in step S3105. The time to be displayed for which the URL1 needs to be displayed is obtained from the knowledge structure in S3106 and set to N. The URL1 is displayed in Service Provider UI window in step S3107. A system TIMER for N seconds is set in step S3108 and the function returns.

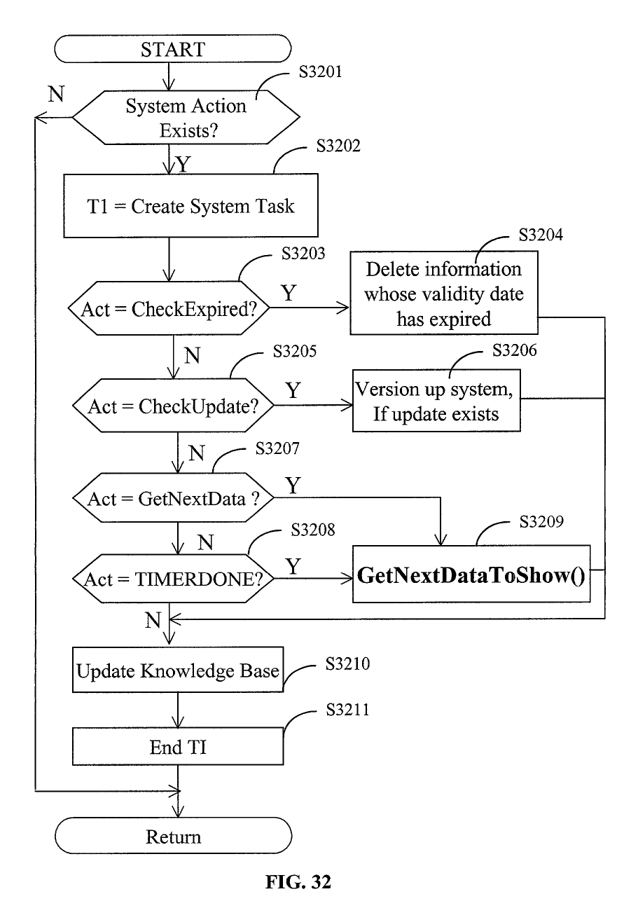

FIG. 32 is a flowchart of the procedural steps of S707 of this embodiment, in which a check is made to see if any system task needs to be executed. In step S3201, a check is made to determine if any system action exists, which needs to be executed. If no such action exists, the process is terminated and returns. If system action exists, system task T1 is created in step S3202. A check is made in step S3203 to determine if the system action is CheckExpired. If so, all the information whose validity date have expired are removed from the knowledge base in step S3204. If not, a check is made in step S3205 to determine if the system action is CheckUpdate. If so, Update is executed in step S3206 to update the version of the system, if update exists. If not, a check is made in step S3207 to determine if Act is GetNextData. If not, a check is made in step S3208 to determine if Act is TIMERDONE, i.e., the system TIMER set in S3108 has fired. In either of the above cases, step S3209 GetNextDataToShow ( ) is executed as explained earlier in FIG. 31. After the completion of the above steps, knowledge base is updated in step S3210 and system task T1 is terminated in step S3211 and the process returns.

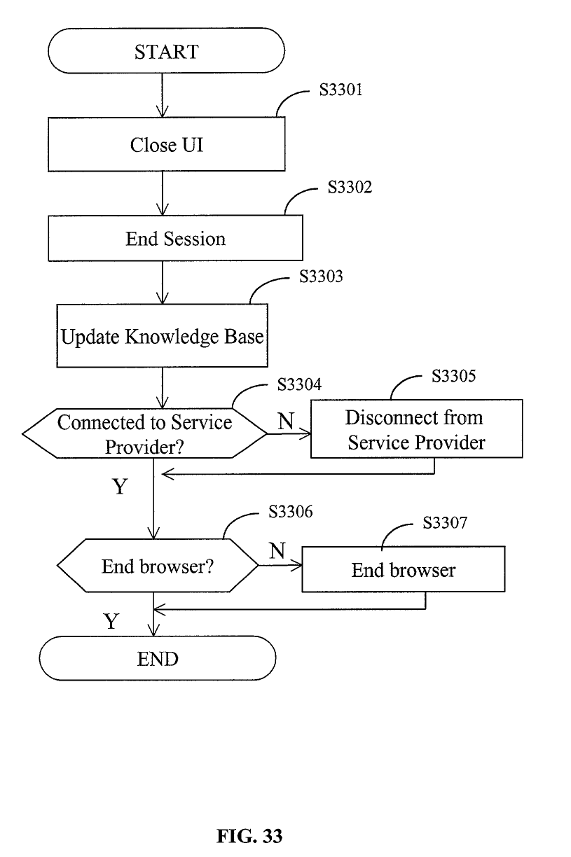

FIG. 33 is a flowchart of the procedural steps of TERMINATE of step S403 of this embodiment. In step S3301, all the UI being displayed are closed. In step S3302, all the current sessions are ended. In step S3303, Knowledge base is updated. A check is made in step S3304 to determine if the system is connected to the Service Provider. If so, in step S3305, the connection is terminated. A check is made in step S3306 to determine if browser needs to be ended or terminated. If so, the browser will be terminated in step S3307 and the process ends.

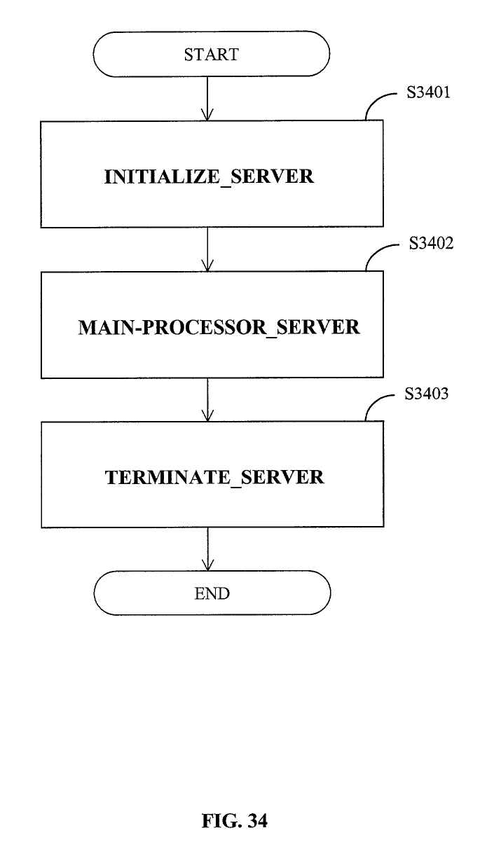

FIG. 34 is a flowchart of the main procedural steps of server 303 of this embodiment. In step S3401, initialization steps are executed. In step S3402, main function processing saving etc. of this embodiment at the server side is performed. In step S3403, terminate or clean-up processing is executed.

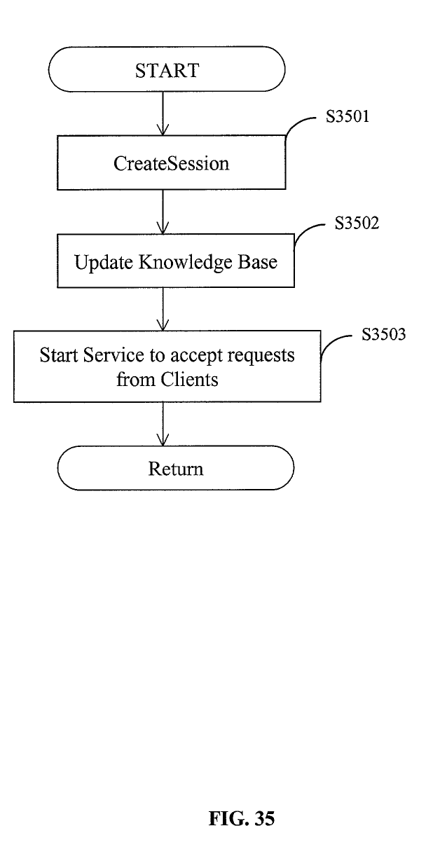

FIG. 35 is a flowchart of INITIALIZE_SERVER procedure of step S3401 of this embodiment. In step S3501, Session is created. In step S3502 knowledge base is updated In step S3503, service is started to accept requests from clients and the process returns.

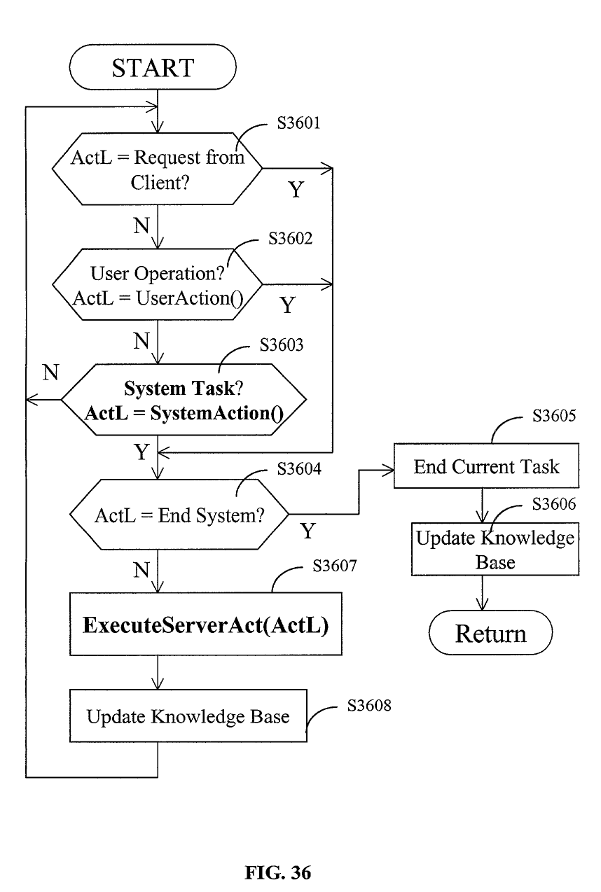

FIG. 36 is a flowchart of the procedural steps of MAIN-PROCESSOR_SERVER procedure of step S3402 of this embodiment. In step S3601, a check is made if ActL has any requests from any client. If so, the process proceeds to step S3604. If no, a check is made in step S3602 to determine if there are any user operation and ActL is set to UserAction ( ). If so, the process proceeds to step S3604. If not, a check is made in step S3603 to determine if there are any system tasks to be performed and ActL is set to SystemAction ( ). If not, the process returns to step S3601. In step S3604, a check is made to determine if ActL is equal to End System. If so, all the current active tasks are terminated in step S3605 and the knowledge base is updated in step S3606 and the process returns. If not, in step S3607 ExecuteServerAct(ActL) is executed as explained later. The knowledge base is updated in step S3608 and the process returns to step S3601.

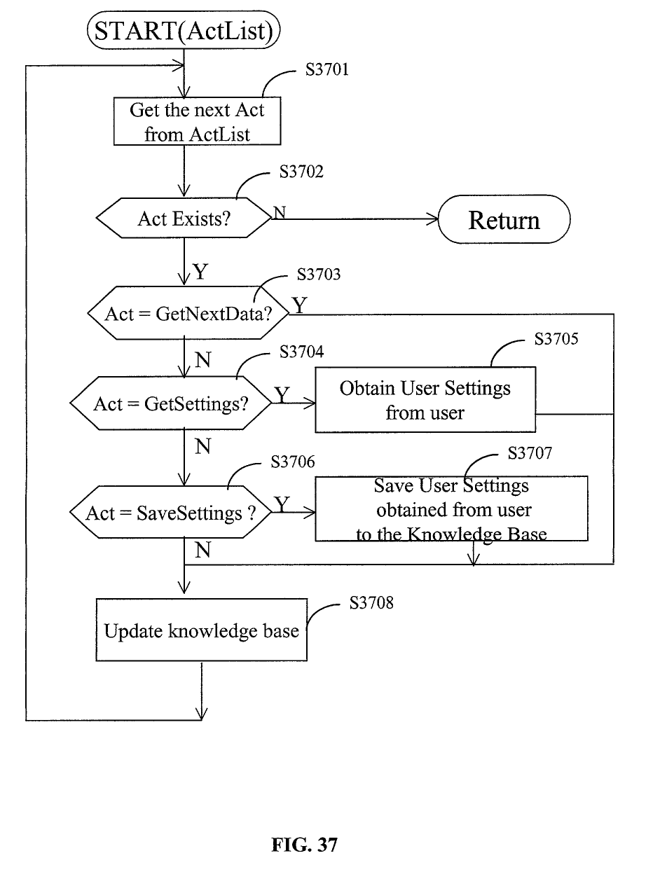

FIG. 37 is a flowchart of the procedural steps of 3602 UserAction. In step S3701, the next Act is got from the ActList. A check is made in step S3702 to determine if Act exists. If not, the process returns. If so, the process proceeds to step S3703, a check is made to determine whether Act is GetNextData. If so, step S3708 is executed wherein the Knowledge base is updated. If not a check is made in step S3704 to determine if Act is GetSettings. If so, the user settings are obtained in S3705 and proceeds to step S3708. If not a check is made in step S3706 to deterimine if Act is Save Settings. If so, step S3707 is executed to save the user settings or preferences obtained from the user to the knowledgebase. In either case the knowledge base is updated and process loops back to S3701.

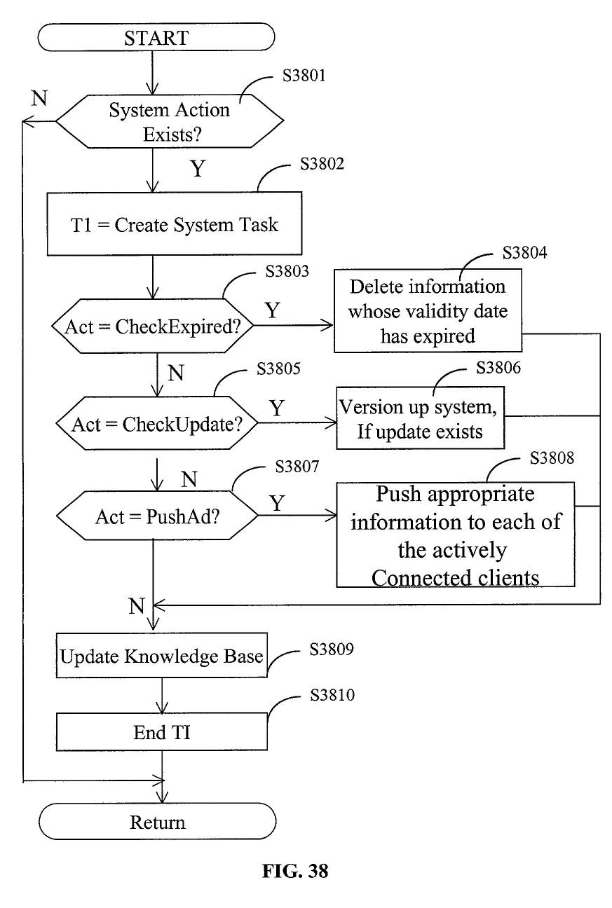

FIG. 38 is a flowchart of the procedural steps of S3603 of this embodiment, in which a check is made to see if any system task needs to be executed on the Server side. In step S3801, a check is made to determine if any system action exists, which needs to be executed. If no such action exists, the process is terminated and returns. If system action exists, system task T1 is created in step S3802. A check is made in step S3803 to determine if the system action is CheckExpired. If so, all the information whose validity date have expired are removed from the knowledge base in step S3804. If not, a check is made in step S3805 to determine if the system action is CheckUpdate. If so, Update is executed in step S3806 to update the version of the system, if update exists. If not, a check is made in step S3807 to determine if Act is PushAd. If so, the server fetches and matches the information, which needs to be sent to each active client. After the completion of the above steps, knowledge base is updated in step S3809 and system task T1 is terminated in step S3810 and the process returns.

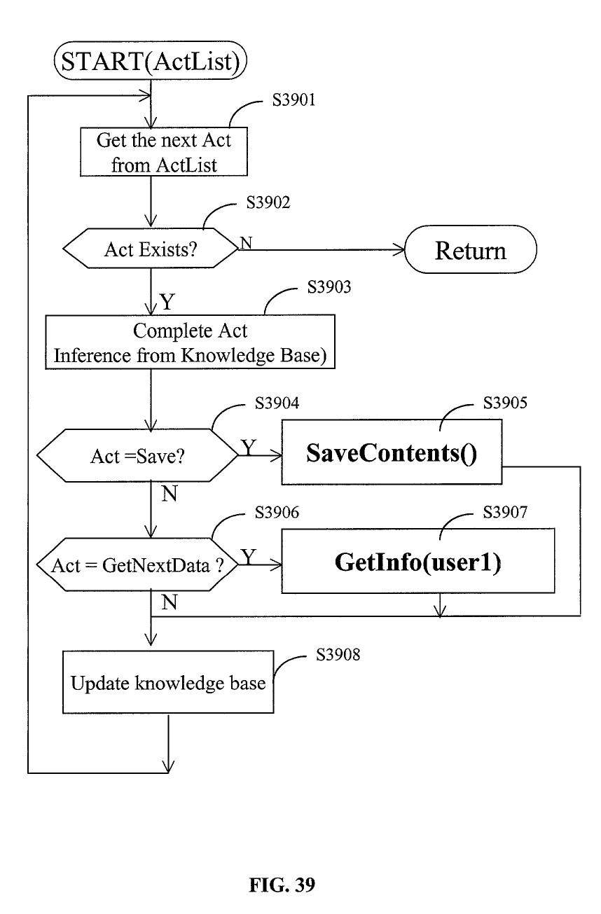

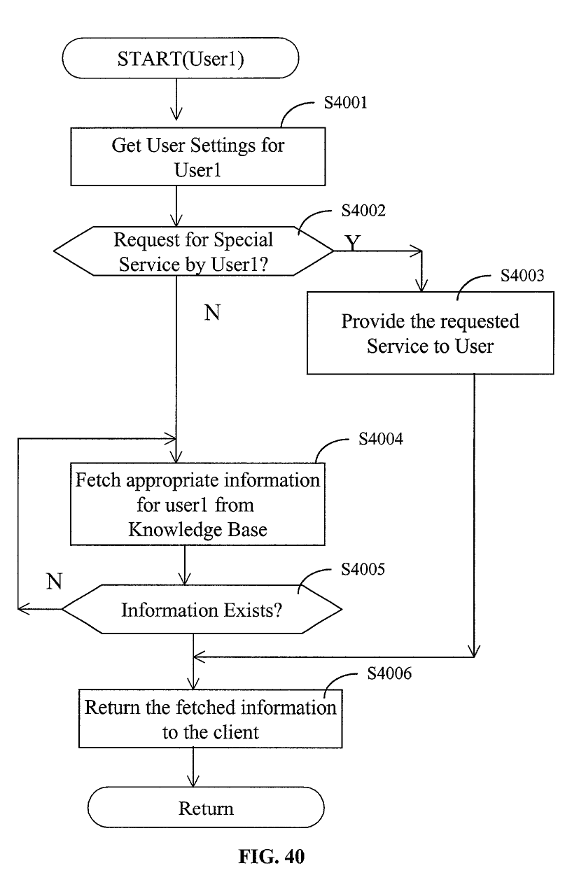

FIG. 39 is a flowchart of the procedural steps of S3607, ExecuteServerAct of this embodiment. In step S3901, the next Act is got from the ActList. In step S3902, a check is made to determine if Act exists. If not, the process returns. Otherwise, in step S3903 inference is made using the knowledge base to complete the Act. A check is made in step S3904 to determine if Act is Save. If so, step S3905, SaveContents ( ) as explained earlier in FIG. 27 is executed and goes to step S3908. If not, a check is made in step S3906 to determine if Act is GetNextData. If so, step S3907, GetInfo(user1) as explained later in FIG. 40 is executed and goes to step S3908 wherein the knowledge base is updated and the process returns to step S3901 to fetch the next action from the ActList, till there are no more action left to be processed, at which stage the process returns.

FIG. 40 is a flowchart of GetInfo procedure of step S3907. The User settings or preferences for the current user, user1 are obtained in step S4001. A check is made in step S4002 to determine if any special service has been requested from the user. If so, the appropriate service is provided in step S4003 and proceeds to step S4006. If not, the appropriate information matching the user settings or preferences is fetched from the Information DB in step S4004. A check is made in step S4005 to determine if the information exists. If not, it loops back to fetch the next information. Otherwise, the fetched information is returned back to the client in step S4006 and the process returns.

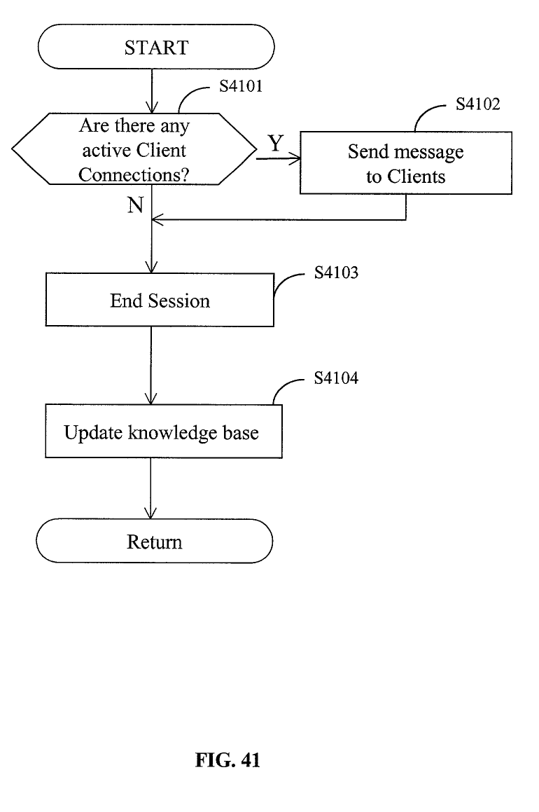

FIG. 41 is a flowchart of TERMINATE_SERVER procedure of step S3403 of this embodiment. In step S4101 a check is made to determine if there are any active client connections. If so, message is sent to the clients to disconnect from this server since it is shutting down. In either case the process proceeds to step S4103, where all the active sessions are terminated and the knowledge base is updated in step S4104 and the process returns.

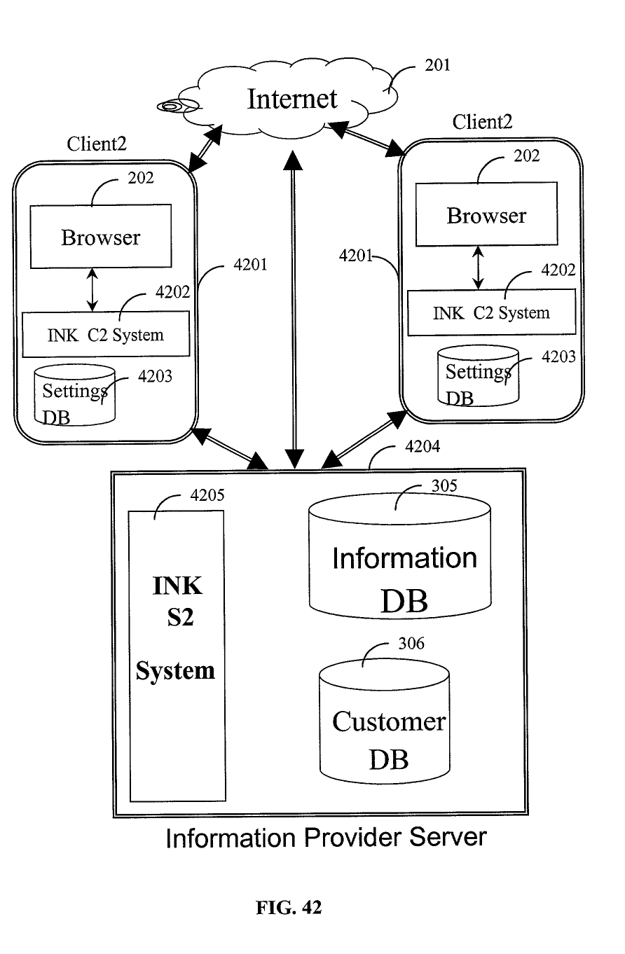

FIG. 42 shows another example system architecture of this embodiment. As can be seen in the figure, each client 4201 also stores the user settings or preferences in Settings DB 4203.

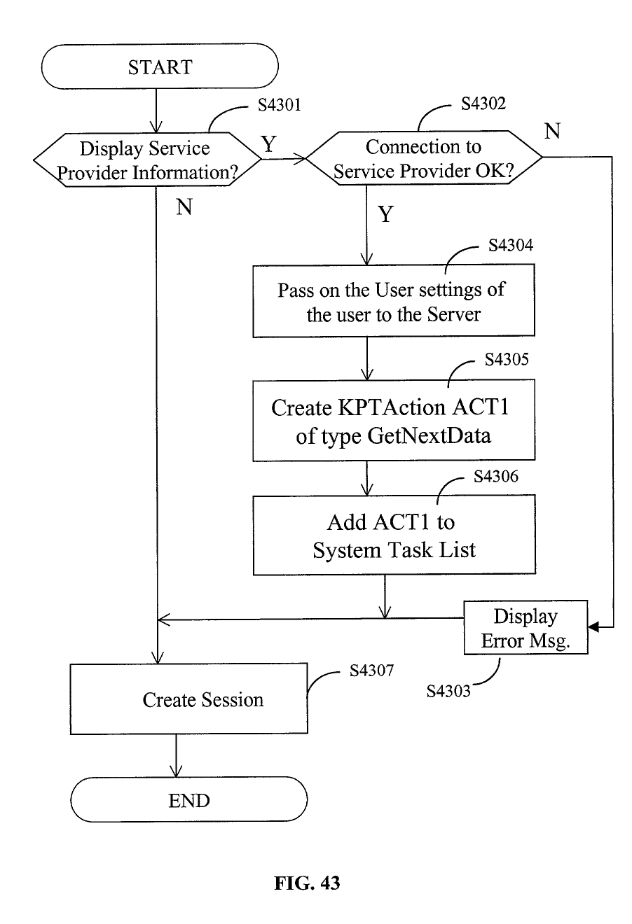

FIG. 43 is a flowchart of the procedural steps of CreateSession ( ) procedure of step S503 of INK2 System of previous figure. In step S4301 a check is made to determine if the Information from the Information or Service Provider needs to be displayed. If so, a check is made to see if the connection to the Information Service Provider was successful in step S4302. If not, an error message is displayed and proceeds to step S4307. If so, the user settings or preferences from the client are sent to the server in step S4304. KPTAction ACT1 of type GetNextData is created in step S4305 and added to System Task list in step S4306. The control proceeds to S4307 where a new session is created and the process returns.

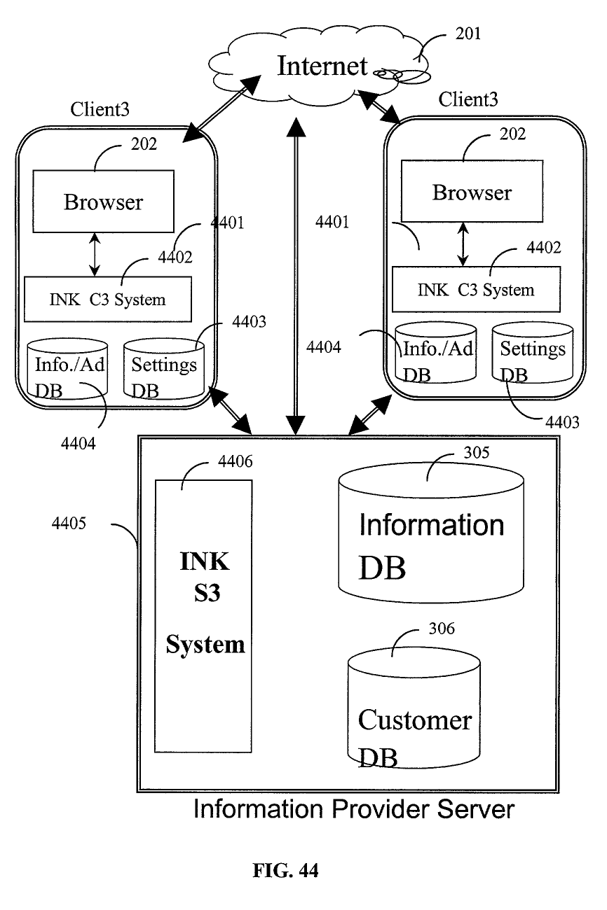

FIG. 44 shows another example system architecture INK3 System of this embodiment. As can be seen in the figure, each client 4401 not only stores the user settings or preferences in Settings DB 4403, but also the Information DB in Info/Ad DB 4404.

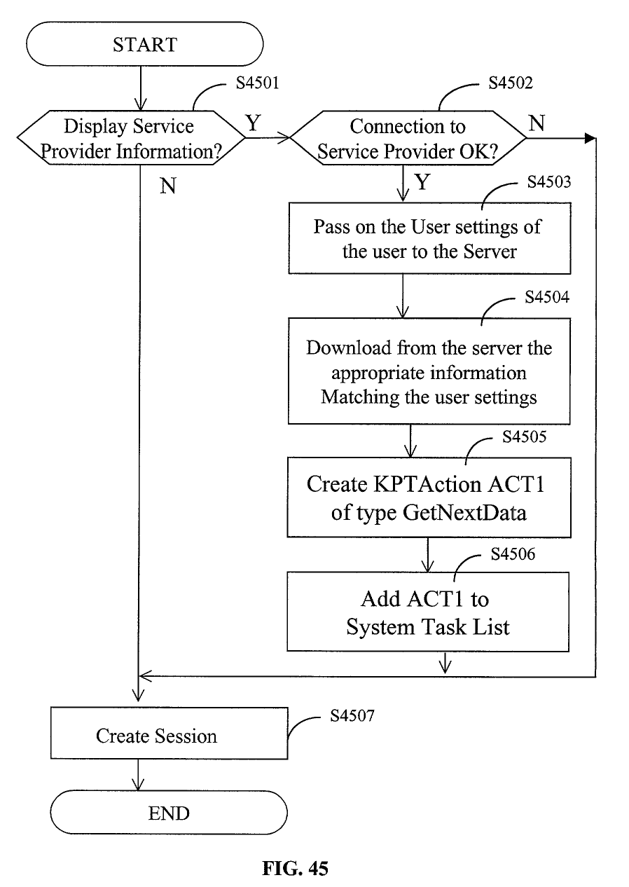

FIG. 45 is a flowchart of the procedural steps of CreateSession ( ) procedure of step S503 of INK3 System of previous figure. In step S4501 a check is made to determine if the Information from the Information or Service Provider needs to be displayed. If so, a check is made to see if the connection to the Information Service Provider was successful in step S4502. If not, it proceeds to step S4507. If so, the user settings or preferences from the client are sent to the server in step S4503. In step S4504, the appropriate information matching the user preferences and settings are downloaded periodically from the server. KPTAction ACT1 of type GetNextData is created in step S4505 and added to System Task list in step S4506. The control proceeds to S4507 where a new session is created and the process returns.

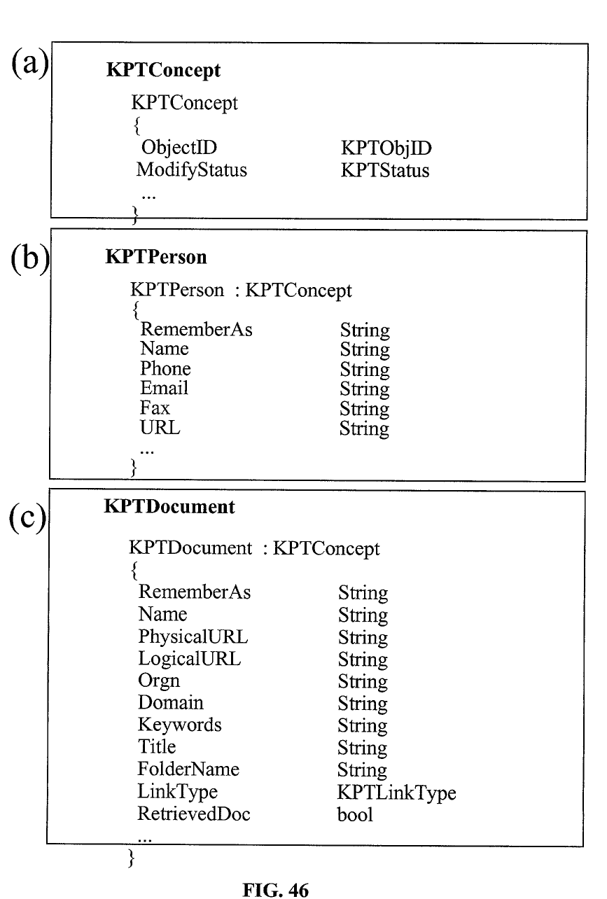

FIG. 46 shows an example of the knowledge structures in the knowledge base. (a), (b), (c) are the knowledge structure definitions for KPTConcept, KPTPerson and KPTDocument respectively.

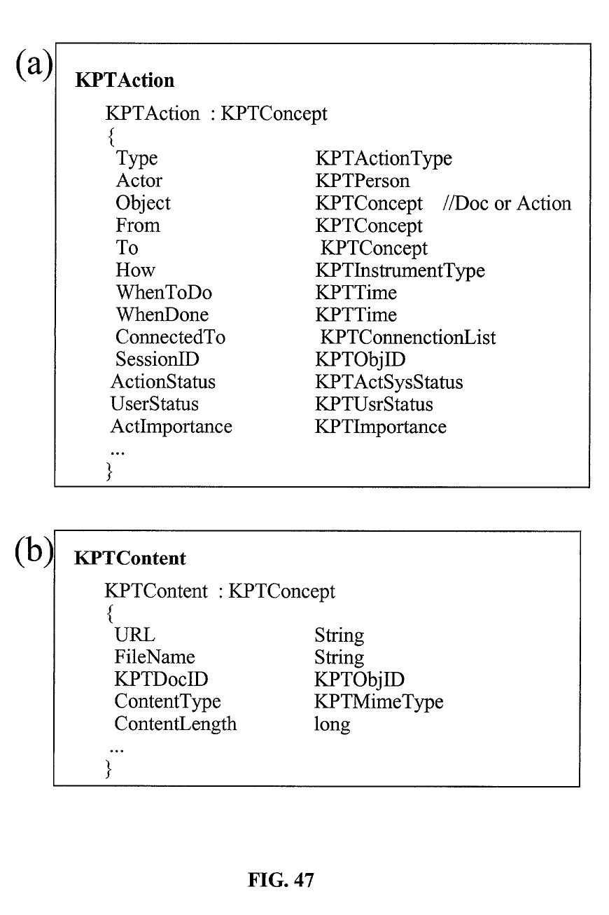

FIG. 47 shows an example of the knowledge structures in the knowledge base. (a), (b) are the knowledge structure definitions for KPTAction and KPTContent respectively.

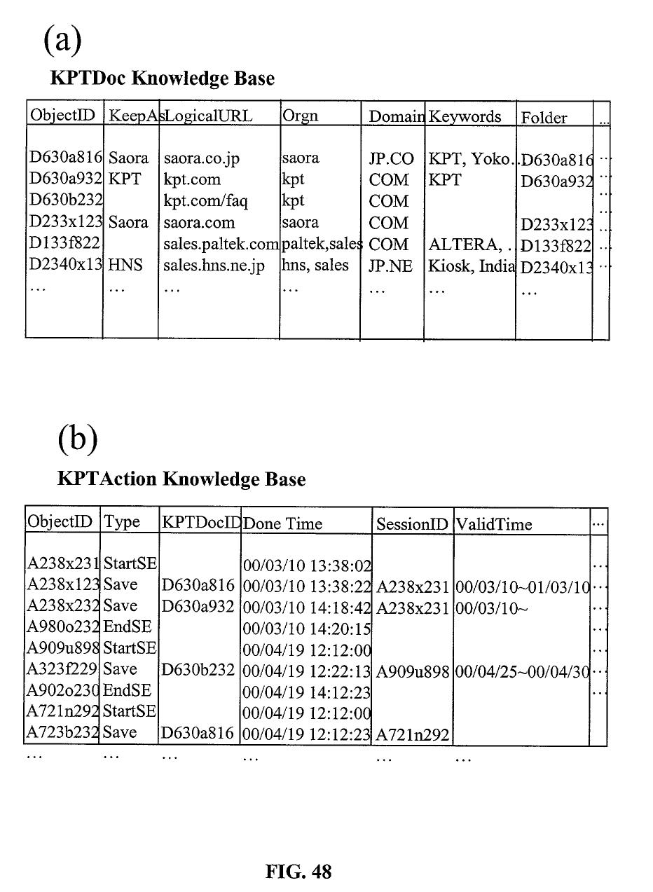

FIG. 48 shows an example content of the knowledge base. (a), (b) are the contents of the knowledge base for KPTDocument and KPTAction respectively.

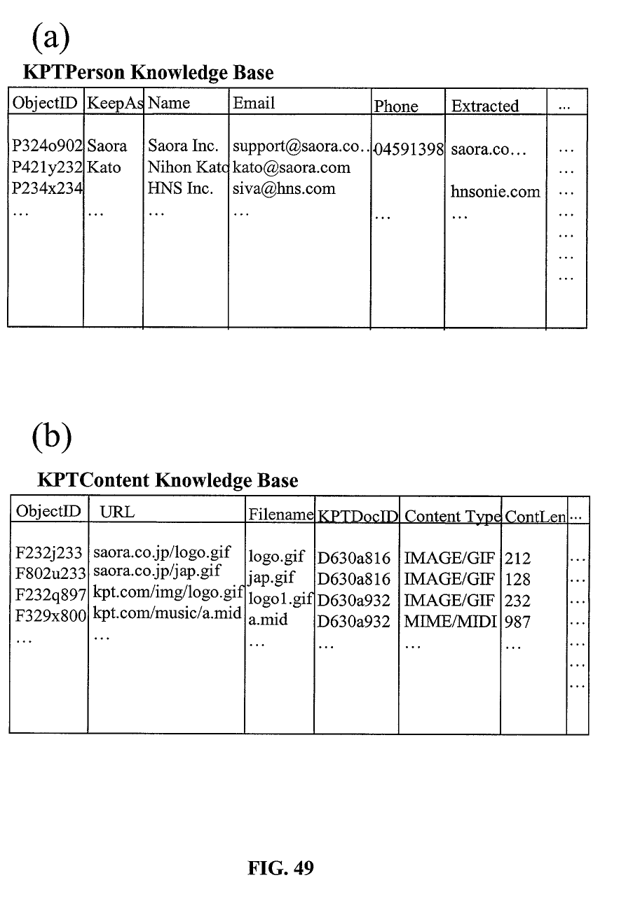

FIG. 49 shows an example content of the knowledge base. (a), (b) are the contents of the knowledge base for KPTPerson and KPTContent respectively.

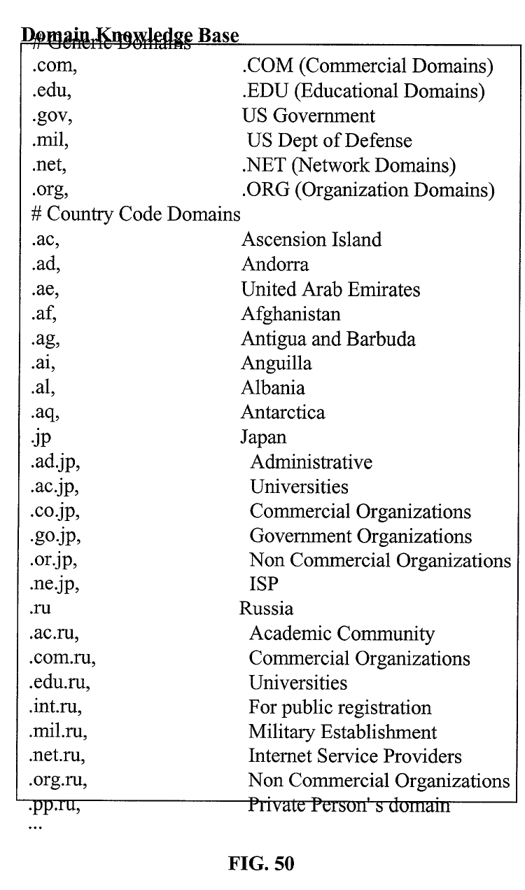

FIG. 50 shows an example content of the Domain knowledge base.

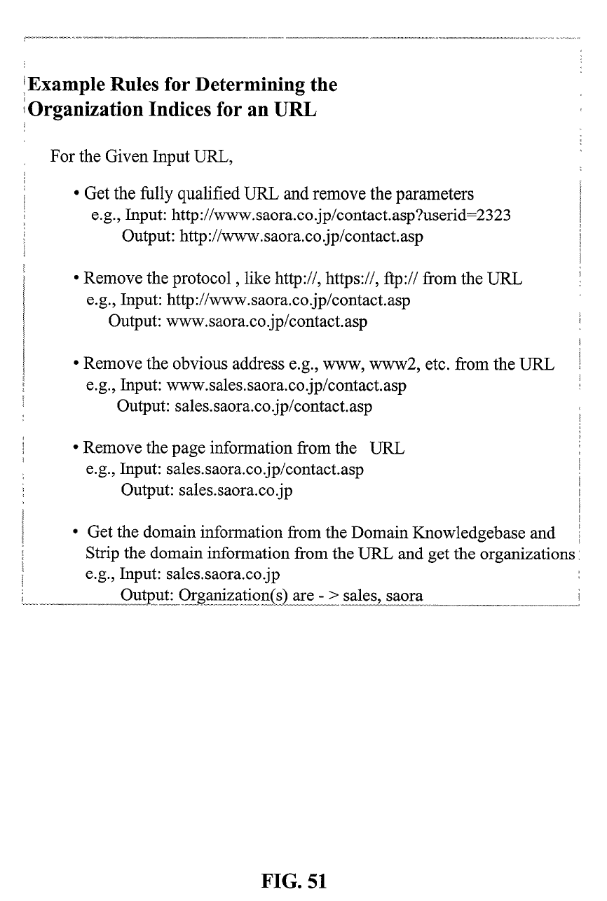

FIG. 51 shows example rules for determining the organization indices for a URL. As can be seen from the figure, the parameter, protocol, obvious address, page information is first removed from the URL. By referring to the Domain Knowledge base, whose example is shown in FIG. 50, the domain part of the URL is removed. The remaining URL is then processed to obtain the Organization indices as shown.

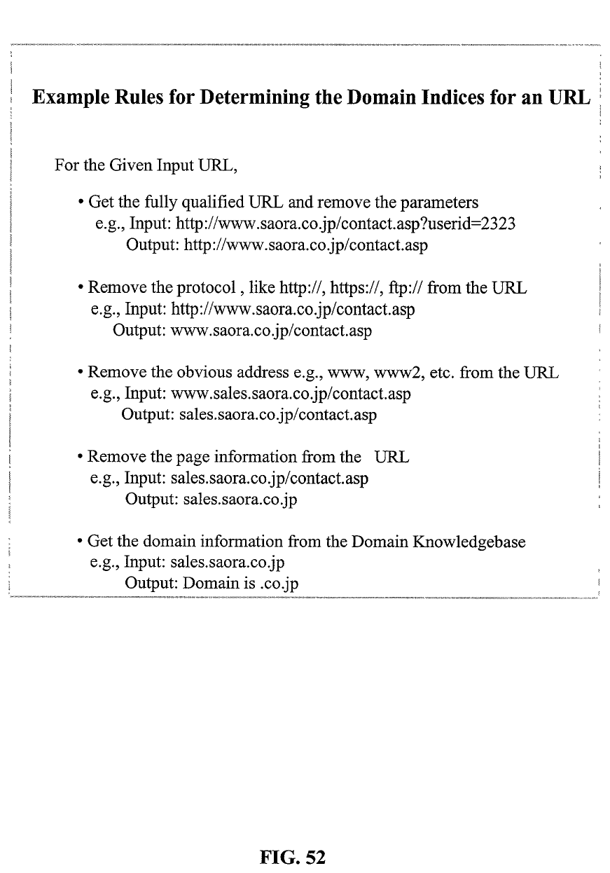

FIG. 52 shows example rules for determining the domain indices for a URL. As can be seen from the figure, the parameter, protocol, obvious address, page information is first removed from the URL. By referring to the Domain Knowledge base, whose example is shown in FIG. 50, the domain part of the URL is obtained.

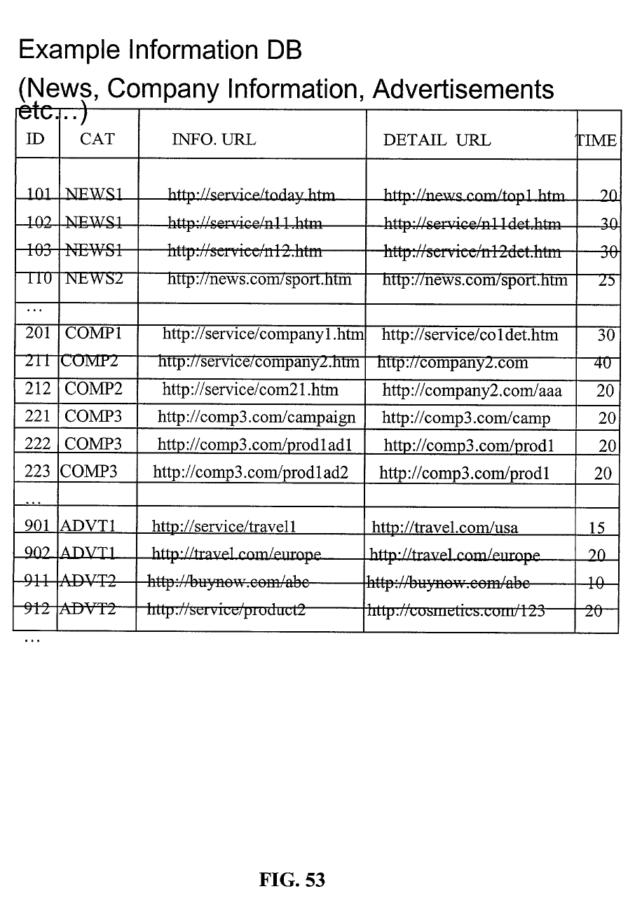

FIG. 53 shows an example Information DB. As can be seen from the figure, the Database contains information of URL(s) categorized by Category name for example—NEWS, COMPANY, ADVERTISEMENTS etc . . . and further grouped by number for e.g., ADVT1, ADVT2 for subcategories within a category. The URL which is shown in the Service Provider Information Window is INFO URL and when the Show Details is pressed the DETAIL URL is picked up and shown. The time for which the information needs to be displayed is picked from the TIME field of this Database

As can be seen from the figure, some of the information comes from the Information Service Provider, for example ID 901 ADVT1, the Service Provider Information Window contents actually from the Information Service Provider http://service/travel1 (assuming the Information Service Provider's URL is http://service) but the detail comes from the actual web site i.e., http://travel.com/usa.

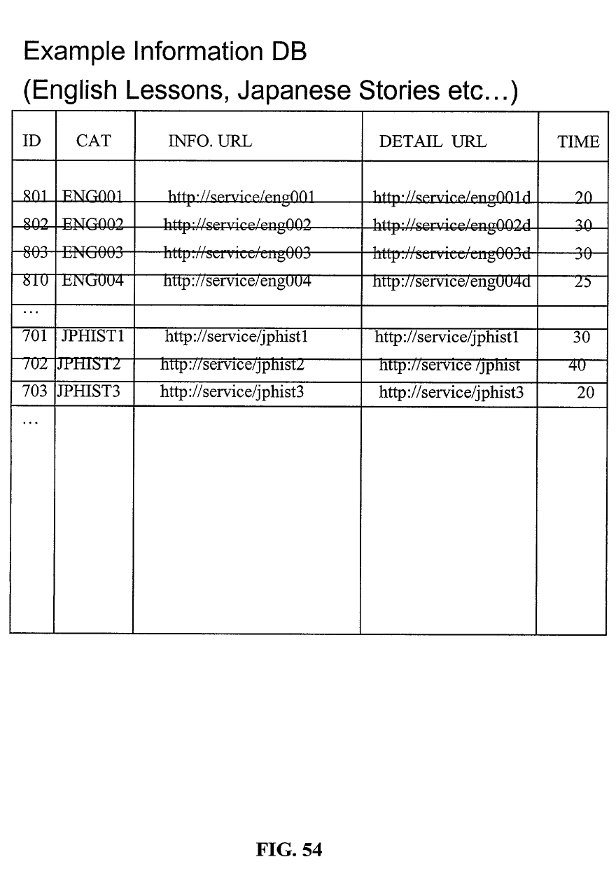

FIG. 54 shows another example of Information DB of this embodiment. The Database contains information of URL(s) categorized bySe r vice Category for example, English Lessons, Japanese Historical stories etc.. Unlike in the previous example all the information shown and the details reside with the Information Service Provider only and no external links are required.

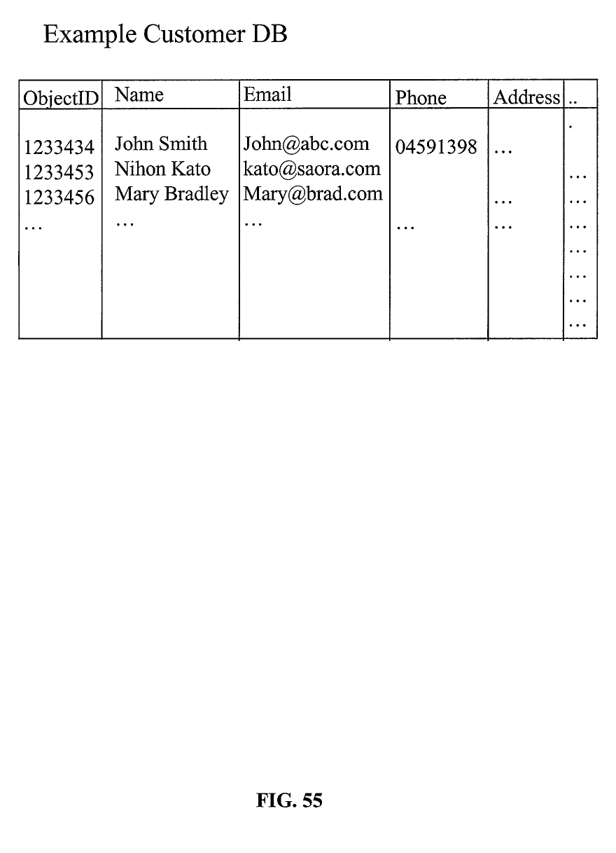

FIG. 55 shows an example of Customer Database of this embodiment.

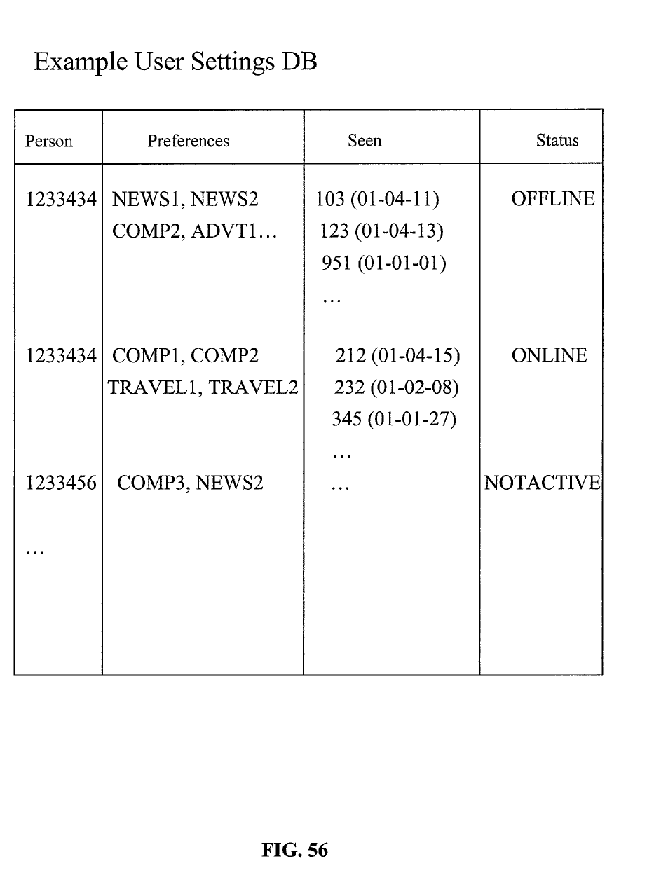

FIG. 56 shows an example of User Settings Database of this embodiment. The User Settings Database contains the user preferences of choices of what information or advertisements the user would like to see. Items already seen by the user are also stored along with time when it was seen by the user. If the original contents of the information have changes since had seen the information, the system would pick up the changed information also along with unseen information. This DB also contains the status of the actual user, i.e., if a particular user is Online or Not

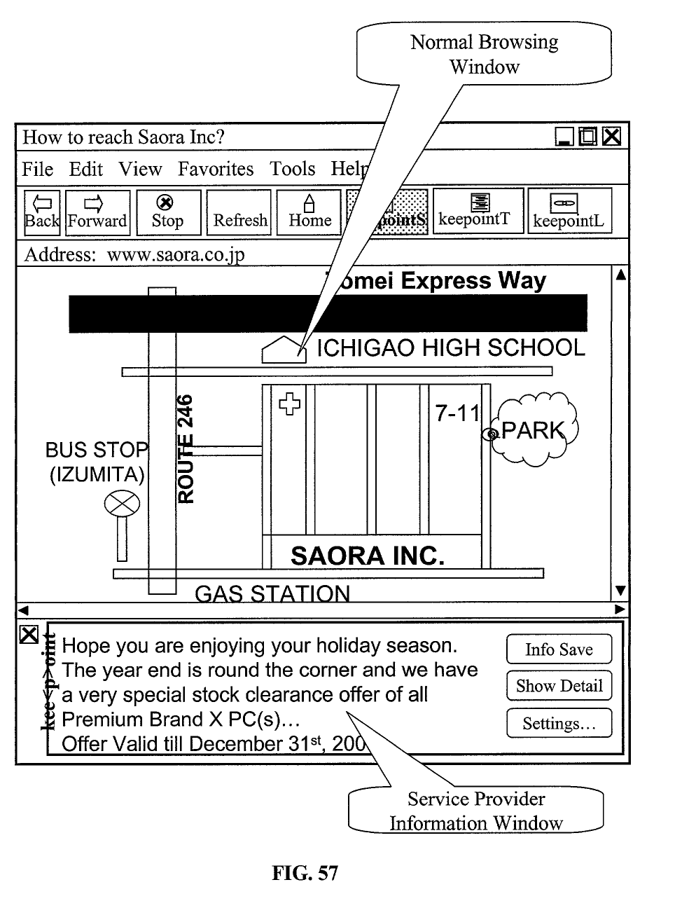

FIG. 57 shows an example User Interface of this embodiment. As can be seen from the figure, the embodiment adds a Service Provider Information Window to the normal browser to display the information published or broadcast from the Information Service Provider Server based on user preferences. The user thus gets contents for example, with high perceived value is that with an emotional or psychological pull (e.g., Horoscope), or that which is needed urgently (e.g., stock information) and/or real time or any other Information which interests the user while browsing the internet.

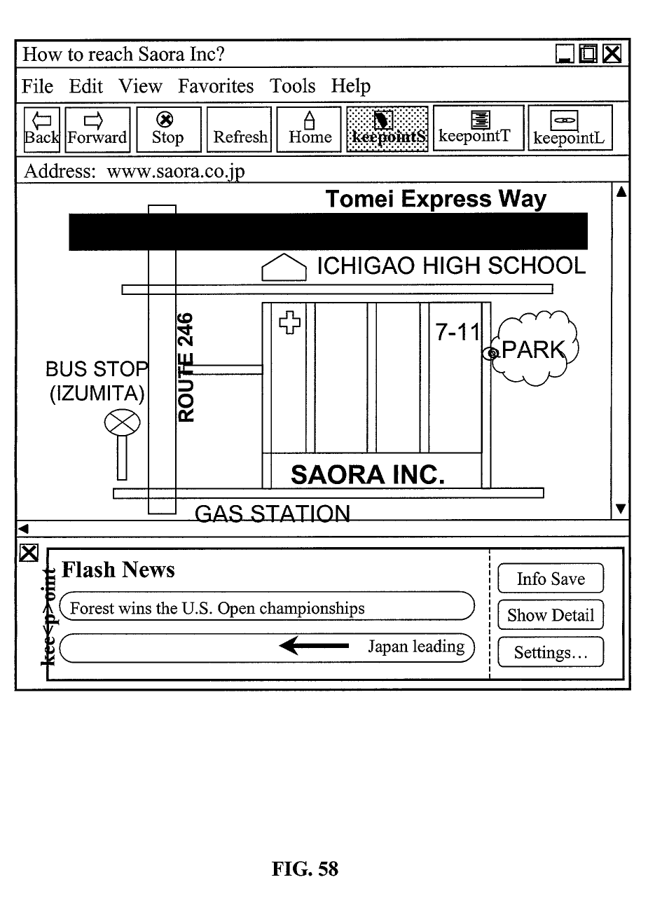

FIG. 58 shows an example User Interface of this embodiment wherein the Flash or Real time news is shown in the Service Provider Information Window. Thus the user while browsing the internet can get up to date information passively, without having to go to fetch or see the information.

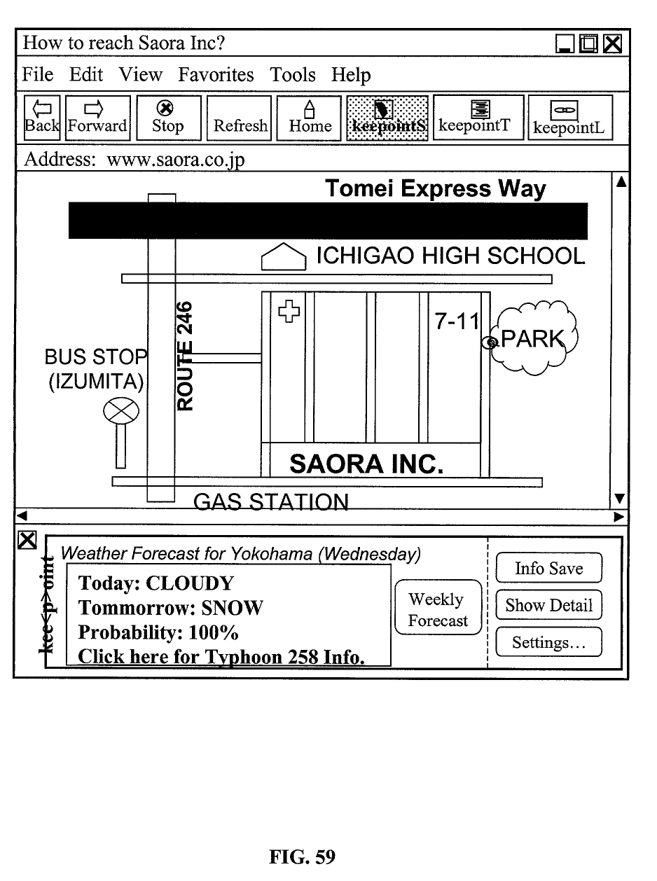

FIG. 59 shows an example User Interface of this embodiment where the weather forecast is shown in the Service Provider Information Window.

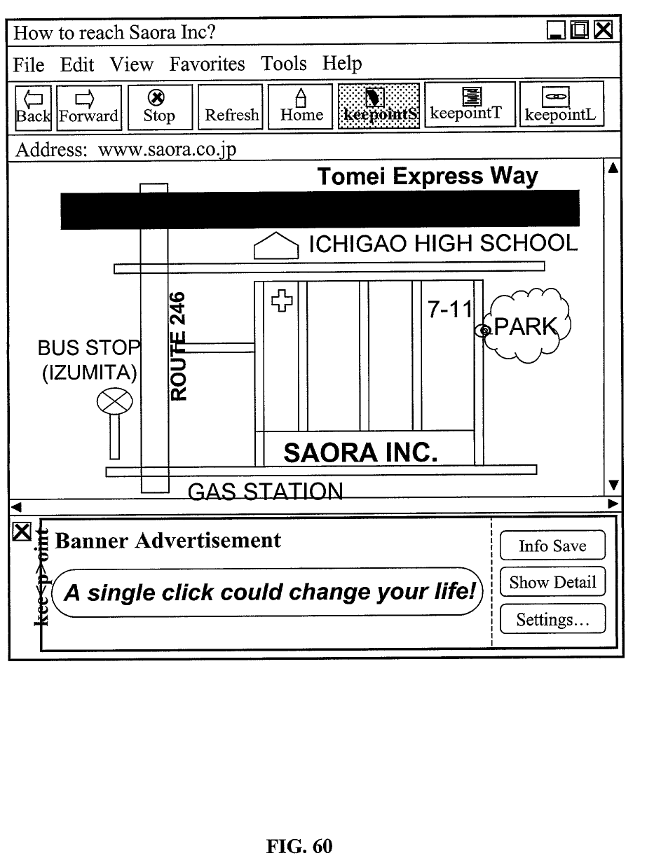

FIG. 60 shows an example User Interface of this embodiment where Banner Advertisements from the organizations or individuals can be shown in the Service Provider Information Window.

FIG. 61 shows an example User Interface of this embodiment when the user clicked on the Show Detail button in the previous figure, in which case the details of the information, advertisement in this case is shown in the normal browsing window.

FIG. 62 shows an example User Interface of this embodiment when the user clicked on the Show Detail button in FIG. 60 and the details of the information, advertisement details in this case is shown as pop-up window.

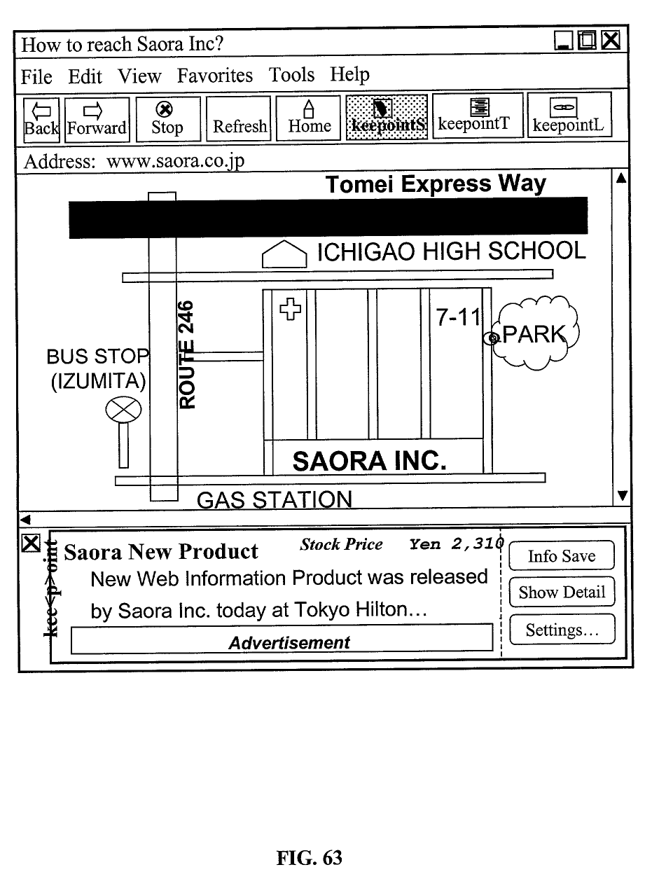

FIG. 63 shows an example User Interface of this embodiment where in the information from the Service Provider is mixture of Real time and static information. As can be seen from the figure, the stock price is a real time information, but the product information is press release and the advertisement is a dynamic publicity information of the company.

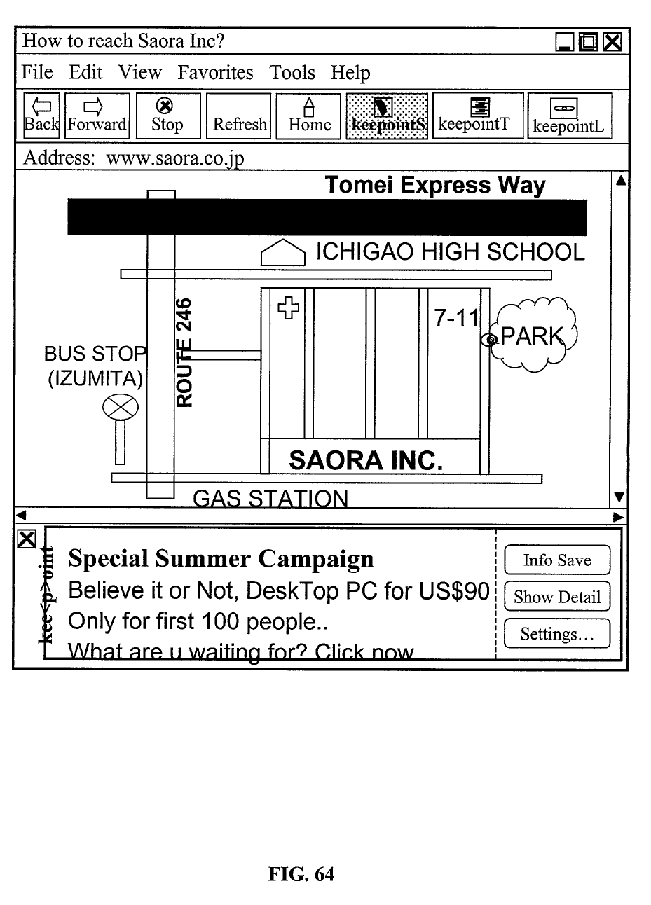

FIG. 64 shows an example User Interface of this embodiment where in the information from the Service Provider is special campaign directed to the specific user, who have asked for or have set the user preference to receive timely information.

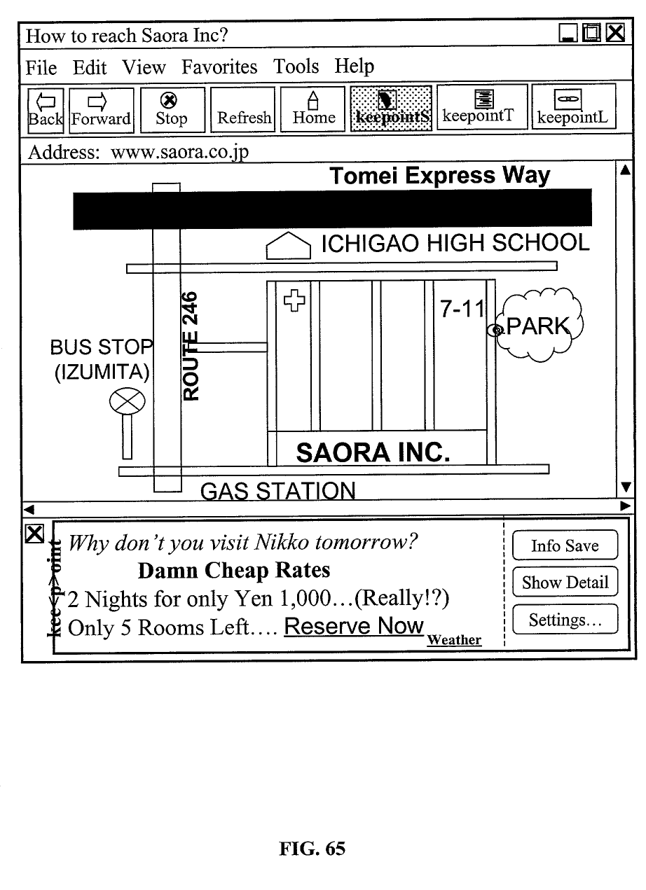

FIG. 65 shows an example User Interface of this embodiment. The information shown in the Information Service Provider Window is timely information, cheap hotel accommodation for tomorrow's stay at a nearby resort. The business community can thus use this media to attract last minute customer by bringing down the price based on availability and the customers can benefit by being able to get good deals passively i.e., while browsing the internet for other purposes, without having to look for or having to launch separate applications for monitoring such information.

FIG. 66 shows an example User Interface for the user preference settings of this embodiment.

FIG. 67 shows an example User Interface for the time setting for individual preferences of FIG. 66.

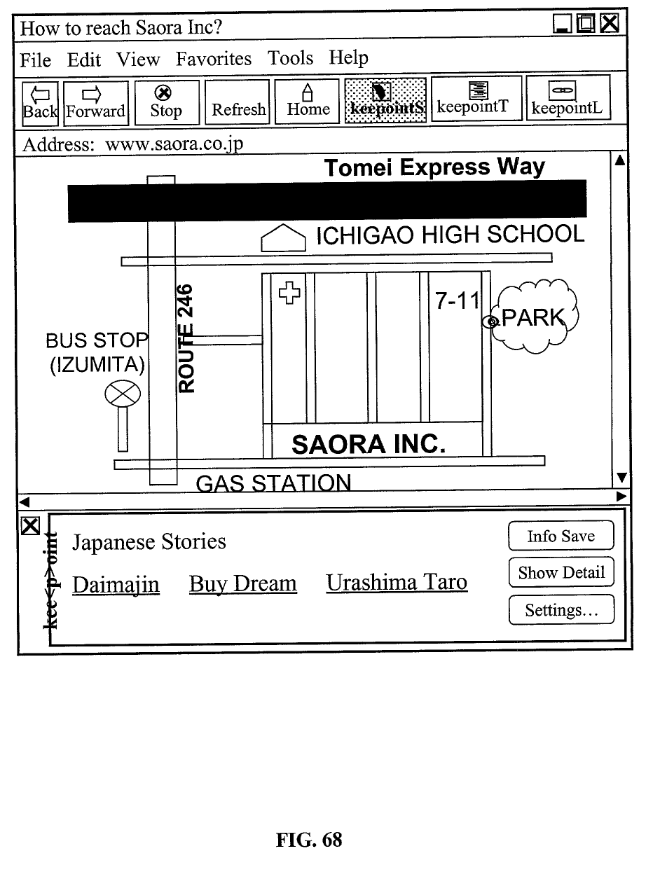

FIG. 68 shows an example User Interface of this embodiment wherein the Information provided by the service provider is Japanese Historical Stories. In the earlier figures, most of the examples were for real time information, but in the current figure the information is not real time.

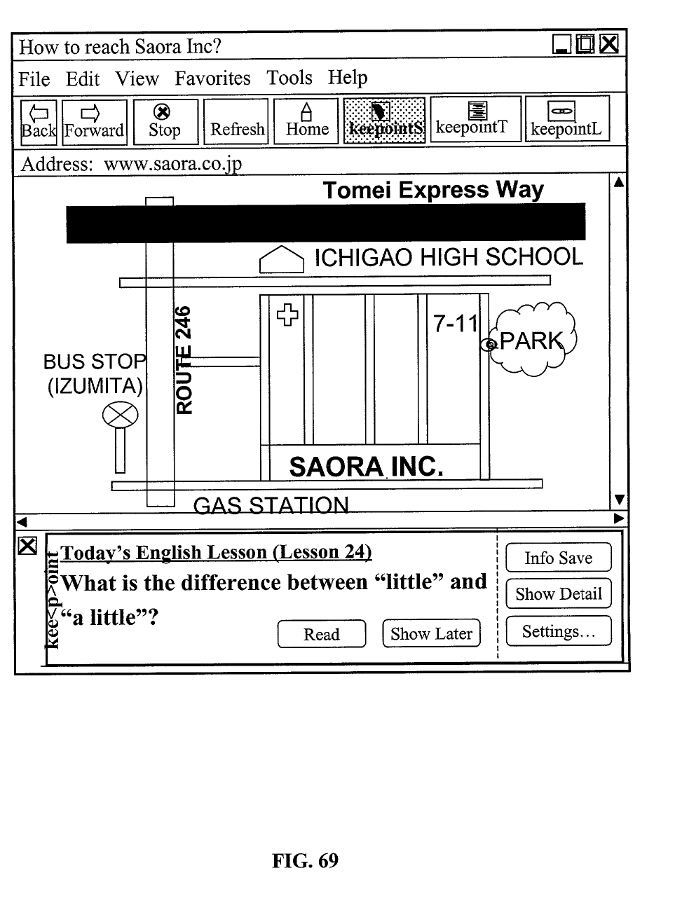

FIG. 69 shows an example User Interface of this embodiment wherein the information provided by the service provider is a service of daily English lesson. As can be seen from the figure, unlike previous examples, the user interface has additional controls like Read or to display later, as the user will have read the lesson actively and not just let it pass by.

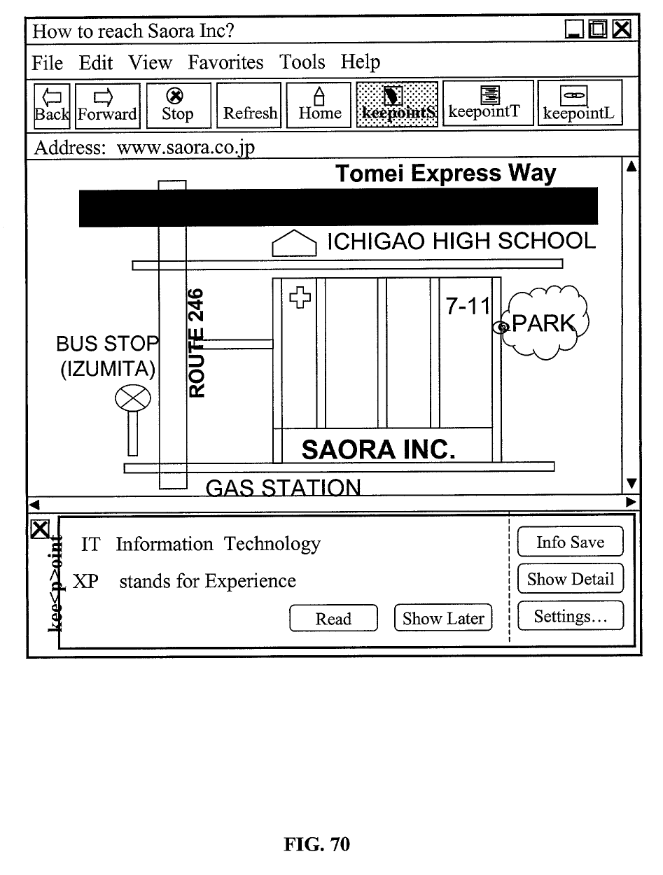

FIG. 70 shows an example User Interface wherein the information provided is a service of English abbreviations or new technical terms or keywords.

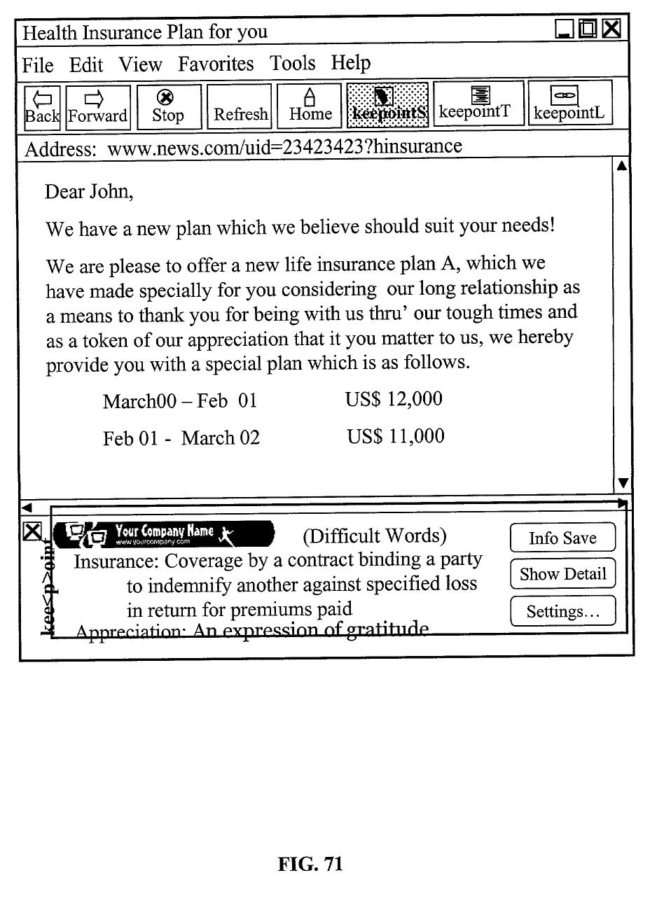

FIG. 71 shows an example User Interface wherein the information provided is a service like a dictionary in which the difficult words are picked up from the normal browsing window and the meaning/usage of the words is shown in the information provider window.

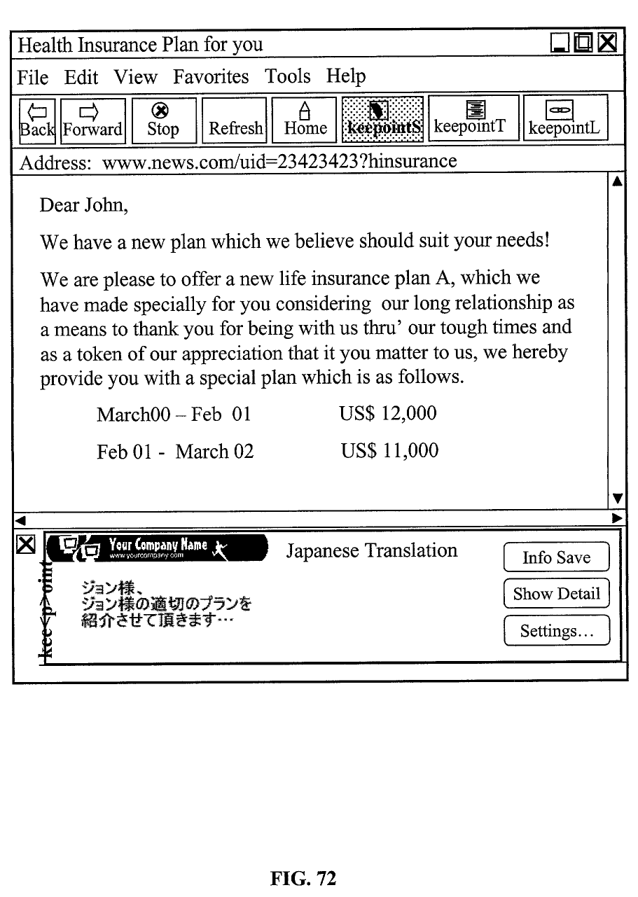

FIG. 72 shows an example User Interface wherein the information provided is a service like Translation of English text currently being browsed in the main window to say for example, Japanese as can be seen in the figure.

FIG. 73 shows an example User Interface of Get All Links UI. In step S1810, the links are sorted by Information Type and the resultant UI displayed in step S1811 is as shown.

FIG. 74 shows an example User Interface of Session UI. In step S1204, for each session the KPTAction is sorted by Time and the result is as shown in this figure.

FIG. 75 shows an example User Interface of Get All Links UI. In step S1805, the links are sorted by Organization and the resultant UI displayed in step S1811 is as shown. As can be seen from the figure, if a content has subdomains i.e., ‘Lesson.Senglish School.com’ then it will appear in multiple places below each of the organization nodes i.e., ‘Lesson’, ‘Senglish School’ etc . . .

FIG. 76 shows an example User Interface of Get All Links UI. In step S1807, the links are sorted by Domains and the resultant UI displayed in step S1811 is as shown.

FIG. 77 shows an example User Interface of Get All Links UI. In step S1809, the links are sorted by Keywords and the resultant UI displayed in step S1811 is as shown. As can be seen from the figure, if a content has multiple keywords i.e., ‘English’, ‘Lesson1’, then it will appear in multiple places below each of the keyword nodes.

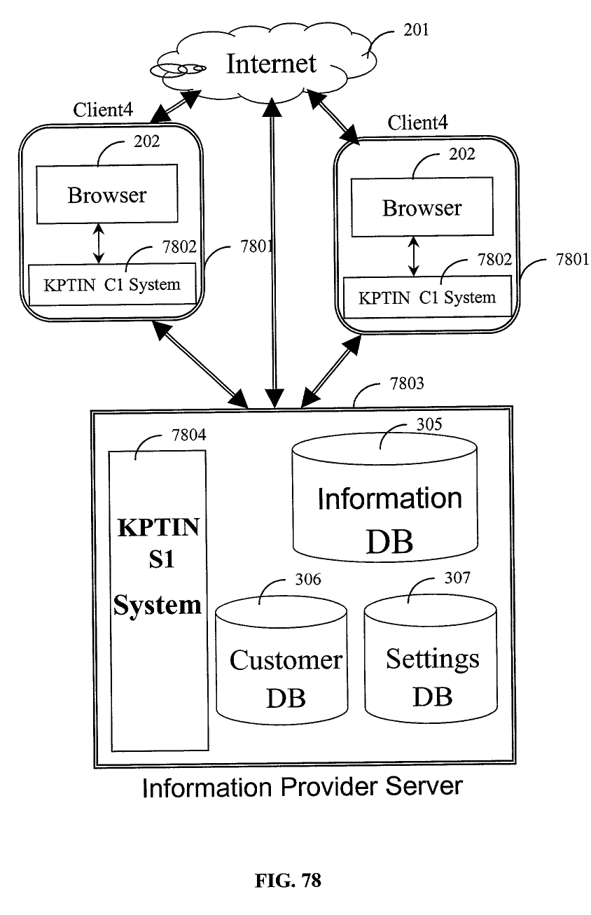

FIG. 78 shows another example system architecture of this embodiment. In this system, the KPTIN C1 System has also the capability to store normal web pages being browsed by the user.

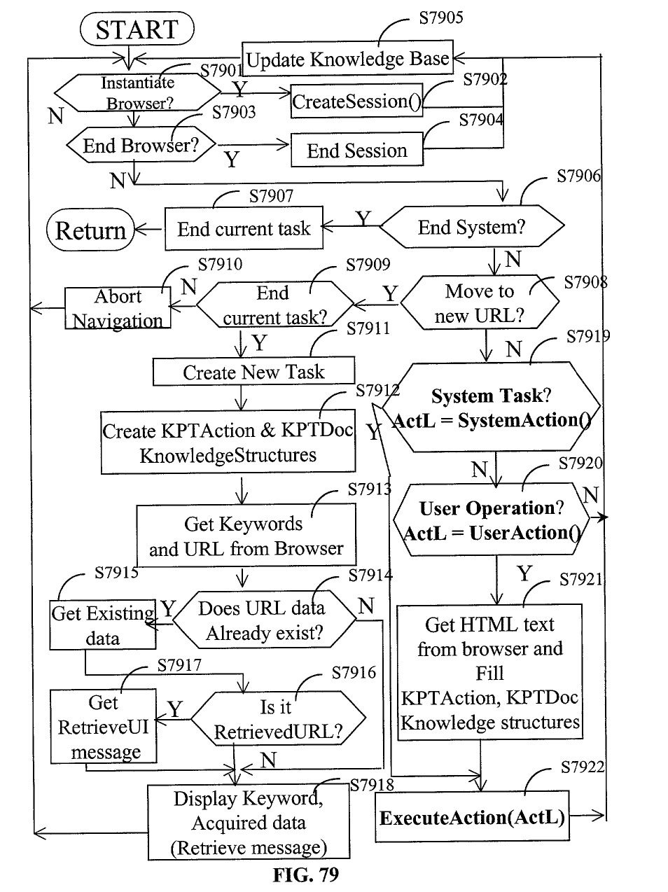

FIG. 79 is a flowchart of the procedural steps of MAIN-PROCESSOR procedure of step S402 of KPTIN System. In step S7901, a check is made to determine if the browser was instantiated or not. If so, a new session is created in step S7902 and the process proceeds to step S7905, wherein the knowledge base is updated. If not, a check is made in step S7903 to determine if the browser was terminated or ended. If so, the session associated with the browser is ended and proceeds to step S7905. If not, a check is made in step S7906 to determine if an action was performed to end the system. If so, all the current tasks are terminated in step S7907 and the process returns.

If not, a check is made in step S7908 to determine if the user is navigating to a new URL. If so, a check is made in step S7909 to confirm with the user that the current task should be terminated. If not, the process proceeds to step S7910, where the navigation is aborted and the process continues to step S7901. If the current task is to be ended in step S7909, step S7911 is executed wherein, the previous task is terminated and then a new task is created. In step S7912, the knowledge structures KPTAction and KPTDocument are created.

In step S7913, the URL and the keywords are obtained from the Browser. A check is made in step S7914 to determine if the URL data already exists in the knowledge base. If so, all the existing data for the current URL is procured from the knowledge base in step S7915 and moves to step S7916, where a check is made to determine if it is a Retrieved URL i.e., the user is trying to view the contents of an already stored page. If so, step S7917 is executed to get the Retrieve UI message and control goes to S7918. If URL data does not already exist in step S7914, step S7918 is executed to display the keywords, other acquired data from browser like the URL, page title etc . . . and other existing data if any from the knowledge base like validity period etc . . . and the process proceeds to step S7901.

In step S7908, if the user is not moving to a new URL, a check is made in step S7919 to determine if any SystemTask ActL needs to be executed. If so, step S7922 ExecuteAction(ActL) is executed and control moves to step S7905 to update the knowledge base. If not, a check is made in step S7920 to determine if any User Operation was performed. If not, step S7905 is executed, otherwise in step S7921, the HTML text is obtained from the browser and the KPTAction and KPTDocument structures created in step S7912 are updated and ExecuteAction(ActL) for the UserAction is executed in step S7922 and the process moves to step S7905 to update the knowledge base.

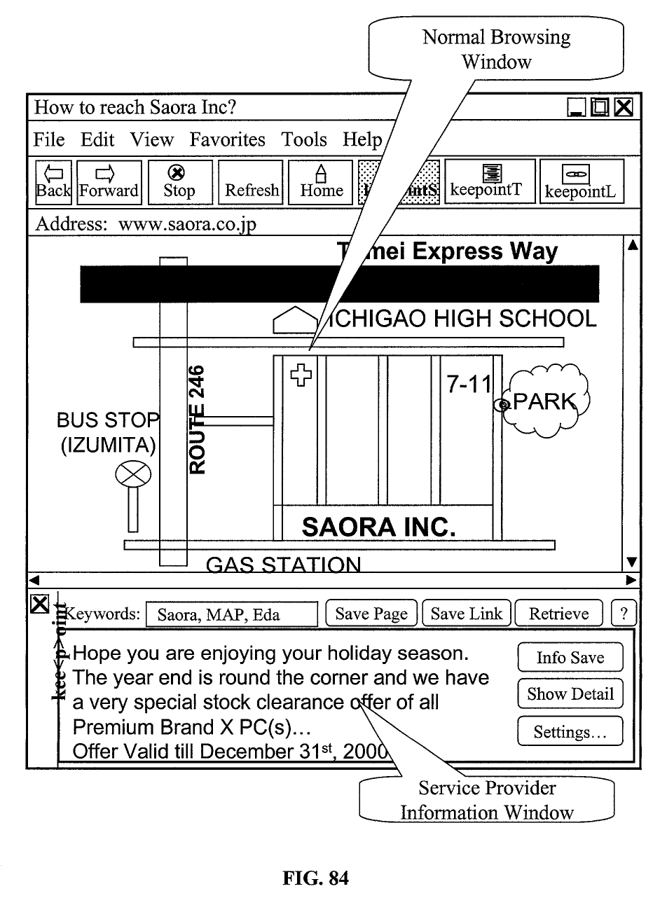

FIG. 84 shows an example User Interface of this embodiment. As can be seen from this Figure, this embodiment allows the user to save information from web pages and retrieve the stored information, without alluding to any files and folders; concepts normally associated with saving information on a computer. There is no need to specify a filename or a destination folder. This saves a lot of time spent in deciding for a filename and specifying the destination folder and after time passes, finally searching the whole hard disk(s) for the files one is looking for. There is not only no need to specify a filename, but the link or pages can be kept, in an One-Click operation i.e., by just clicking on either Save Link or Save Page. Also the same contents can be stored as many times as the user wishes, without ever specifying the filename, and still be able to retrieve them easily. This is especially useful, if the user wishes to keep track of the changes in the contents of the same web page.

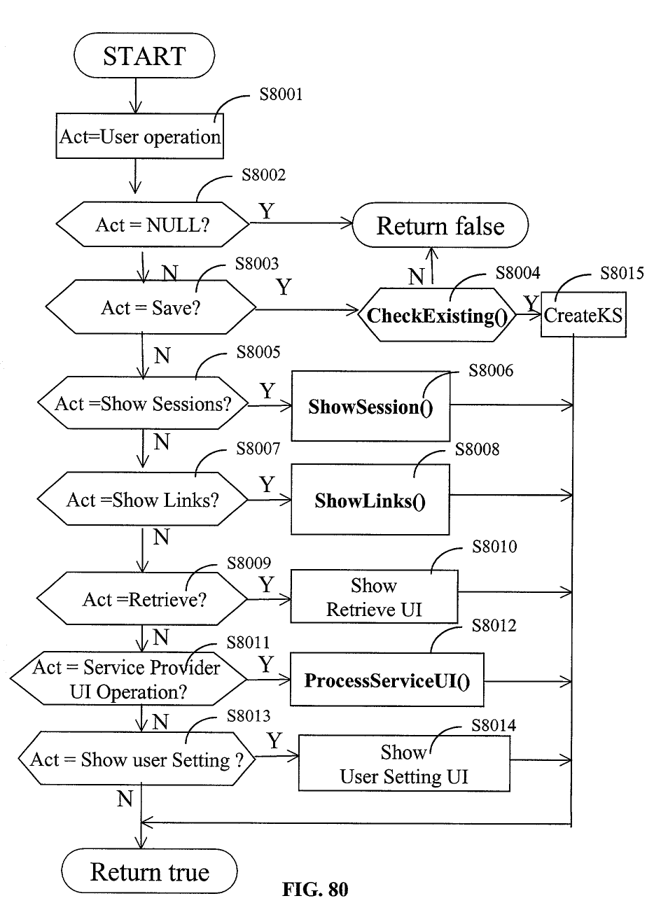

FIG. 80 is a flowchart of the procedural steps of S7920 UserAction. A check is first made in step S8001 to set Act equal to the User operation performed by user and proceeds to step S8002 to determine if Act is equal to NULL. If so, the process returns false. If it is not NULL, the process proceeds to step S8003, a check is made to determine whether Act is Save. If Act is Save, in step S8004, a check is made to determine if the information being saved already exists using CheckExisting ( ), which was explained in FIG. 10 and if so, proceeds to step S8015, otherwise return false. If not, a check is made in step S8005 to determine if Act is Show Sessions. If so, ShowSession ( ) as explained in FIG. 12 is executed in step S8006 and the process returns true. If not, a check is made in step S8007 to determine if the Act is Show Links. If so, ShowLinks ( ) as explained in FIG. 18 is executed in step S8008 and the process returns true. If not, a check is made in step S8009 to determine whether Act is Retrieve. If Act is retrieve, the process proceeds to step S8010 where RetrieveUI is displayed. If not, a check is made in step S8011 to determine whether Act is Service Provider UI Operation. If so, the process proceeds to step S8012 where ProcessServiceUI ( ) is executed which was explained in FIG. 9. If not, a check is made in step S8013 to determine whether Act is Show User Settings. If Act is User Settings, the process proceeds to step S8014 where User SettingUI is displayed. In step S8015, createKS ( ) is executed to create the associated knowledge structures and the process returns true.

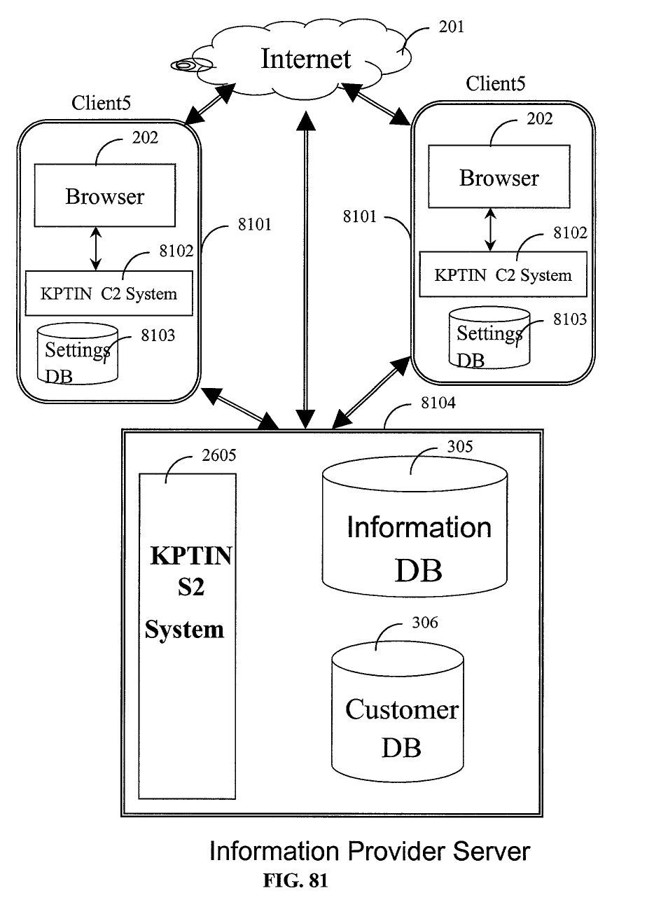

FIG. 81 shows another example system architecture of this embodiment. As can be seen in the figure, each client 8101 also stores the user settings or preferences in Settings DB 8103.

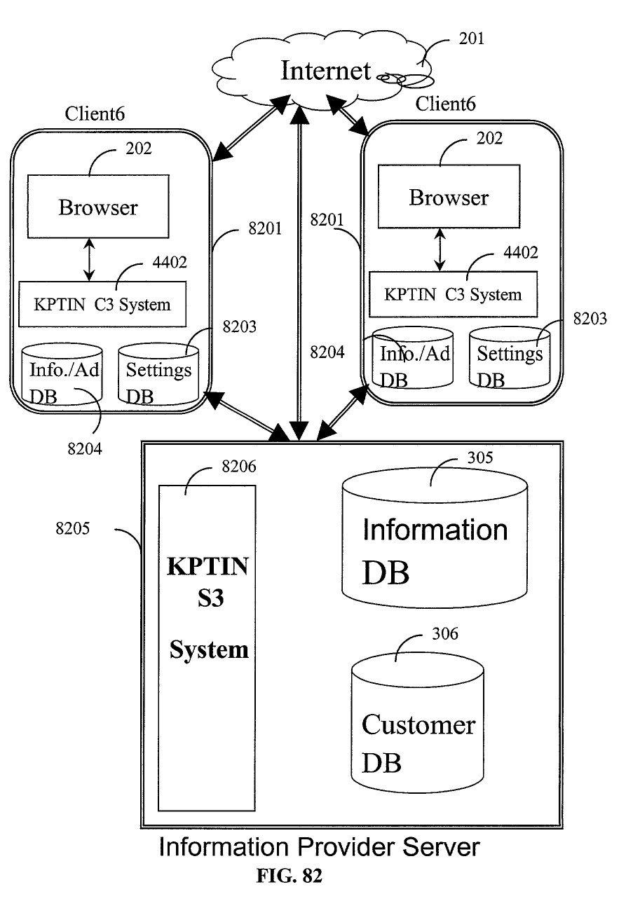

FIG. 82 shows another example system architecture KPTIN3 System of this embodiment. As can be seen in the figure, each client 8201 not only stores the user settings or preferences in Settings DB 8203, but also the Information DB in Info/Ad DB 8204.

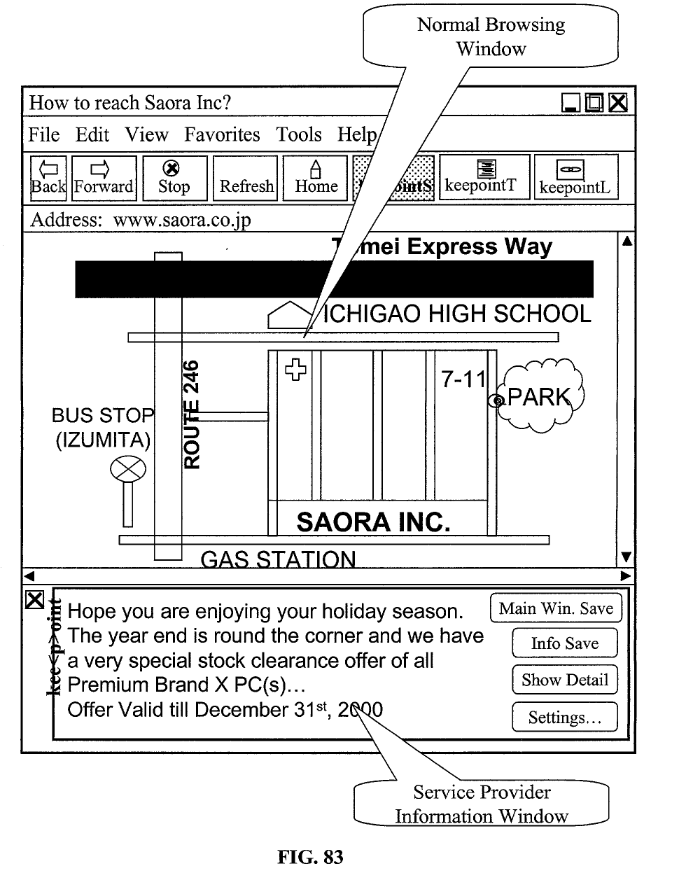

FIG. 83 shows an example User Interface of this embodiment. As can be seen from the figure, the embodiment adds a Service Provider Information Window to the normal browser to display the information published or broadcast from the Information Service Provider Server based on user preferences. The user can also save the information being browsed by using the Main Window Save button.

FIG. 84 shows an example User Interface of this embodiment. As can be seen from the figure, the user can also save the information being browsed by using the Save Page or Save Link buttons. The keywords obtained in step S7913—Saora, MAP, Eda etc. are displayed in the UI as shown in step S7918.

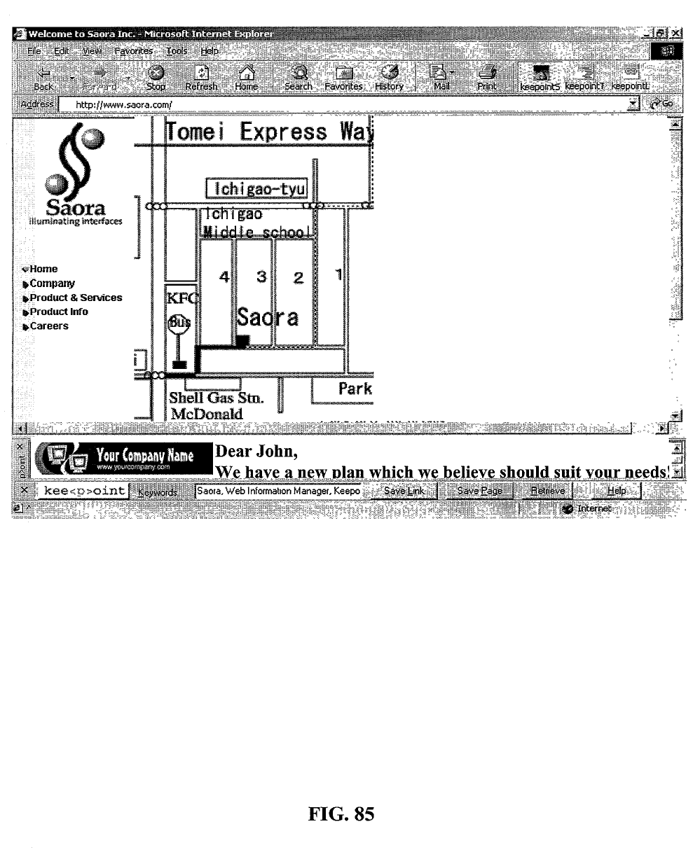

FIG. 85 shows an example User Interface when customized Information is provided to by Information Provider. In this example, the user is John and he has been provided with customized Insurance Plan based on his preference settings.

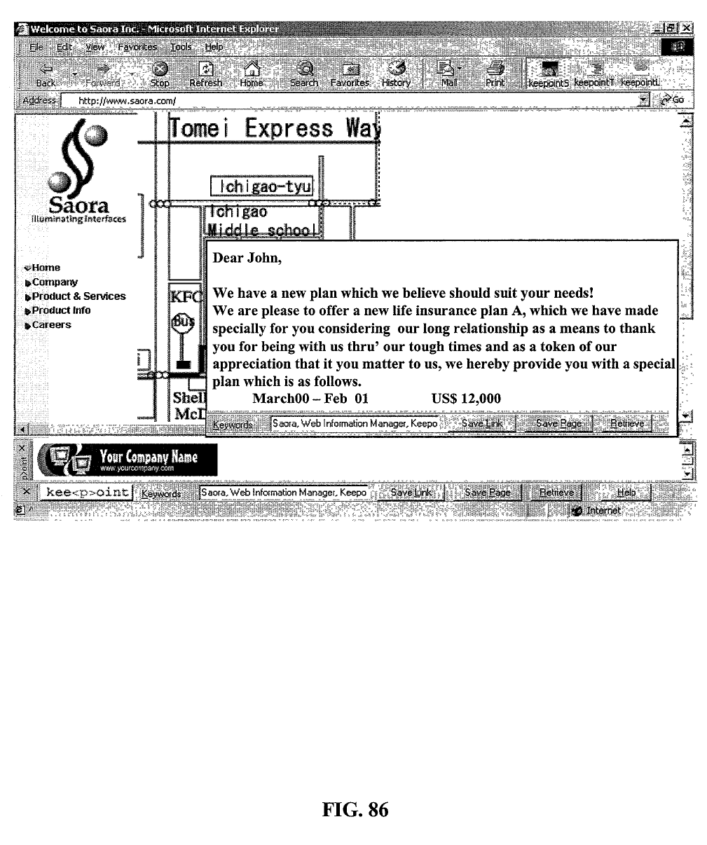

FIG. 86 shows an example User Interface Pop-up of Detail information of the personalized information.

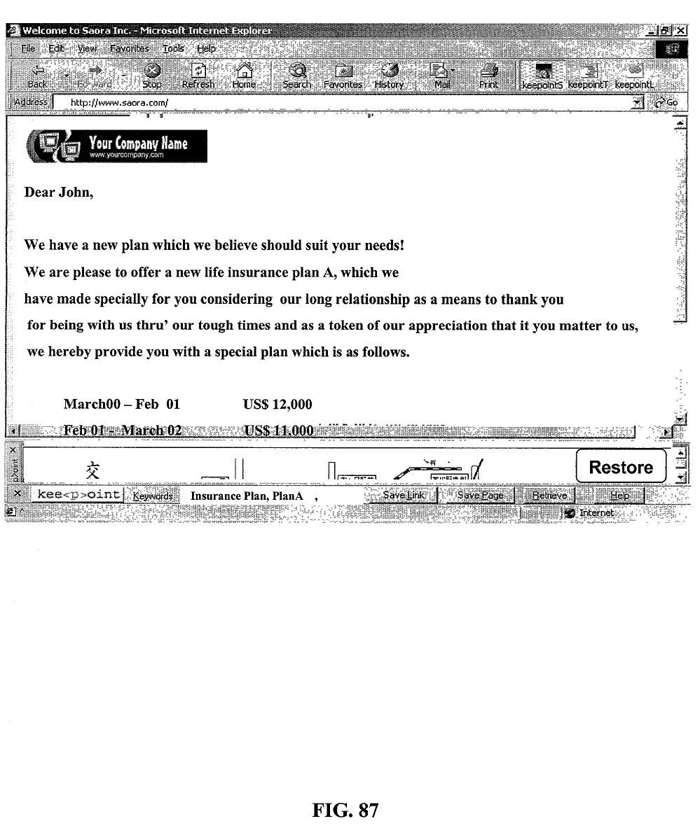

FIG. 87 shows an example User Interface when the main window and service provider information window have been swapped.

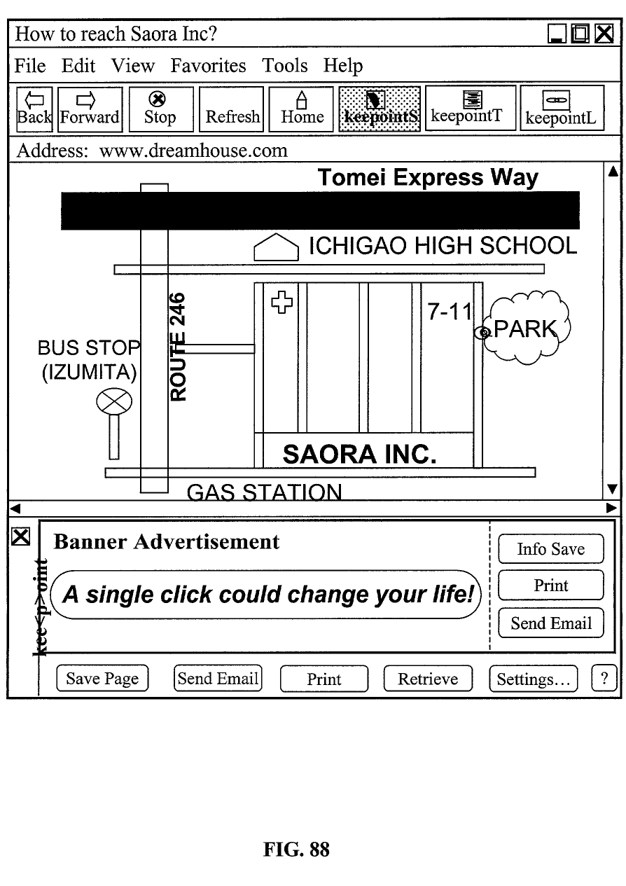

FIG. 88 shows an example User Interface when Banner Advertisement is shown from Service Provider. As can be seen from the figure, the user can, not only save the page, but he or she can also send the page by Email or Print the contents.

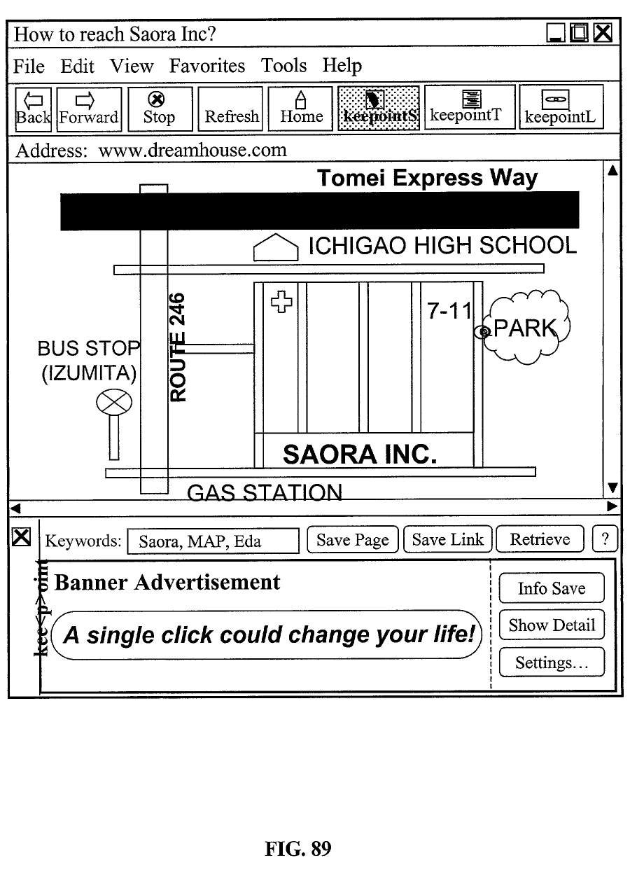

FIG. 89 shows an example User Interface when Banner Advertisement is shown from Service Provider. As can be seen from the figure, the information being browsed can be saved in a one-touch operation i.e., by just clicking on Save Page.

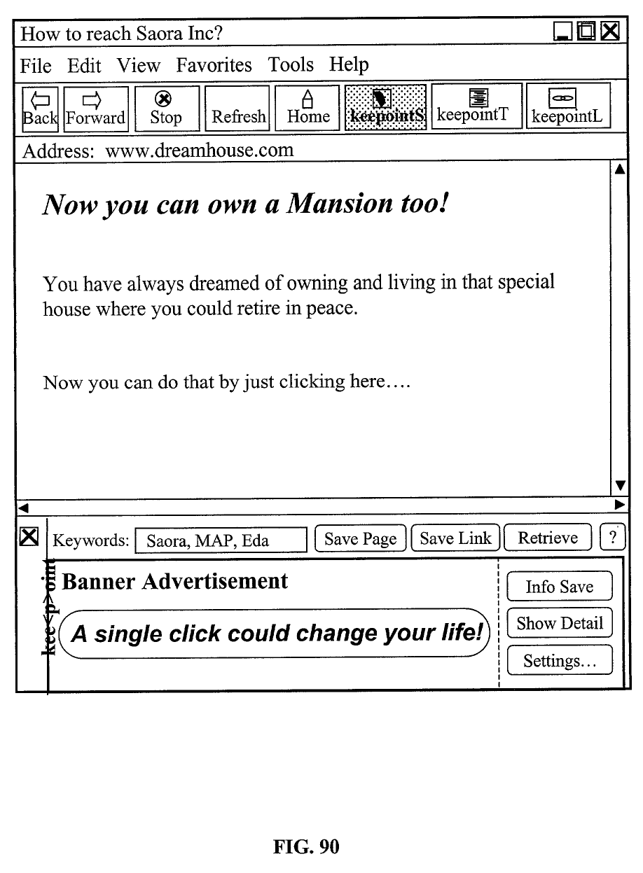

FIG. 90 shows an example User Interface when Show Detail is pressed in previous figure.

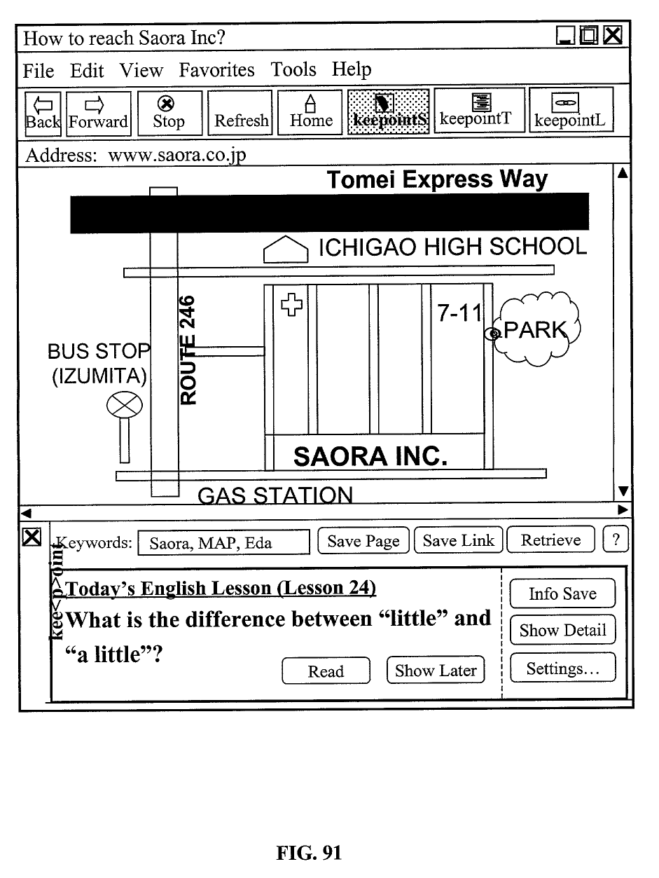

FIG. 91 shows an example Daily English Lesson provided by Information Service Provider.

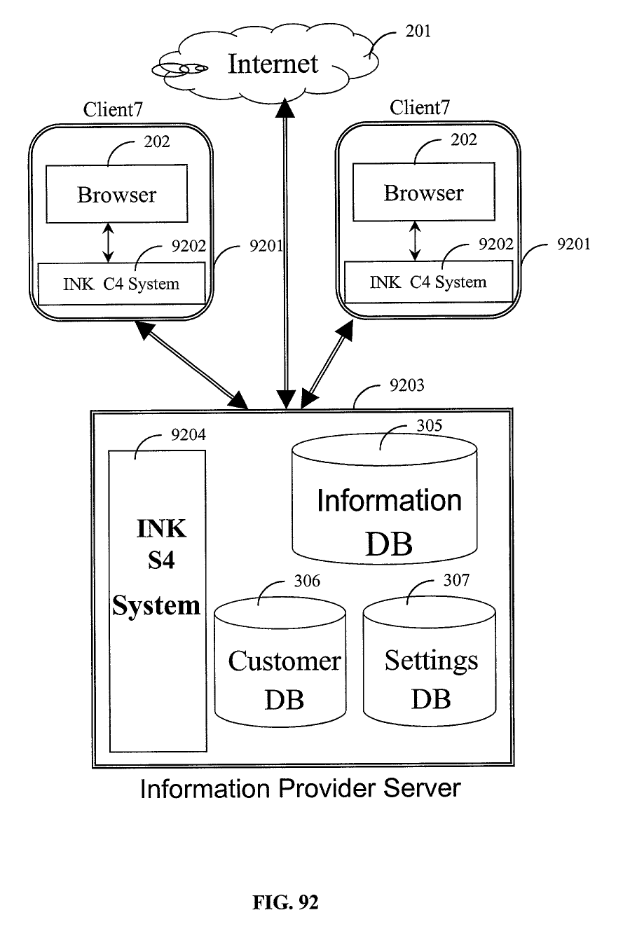

FIG. 92 shows another example system architecture of this embodiment. As can be seen from the figure, the individual clients C9201 do not access the Internet directly but access the Internet through the Server 9203.

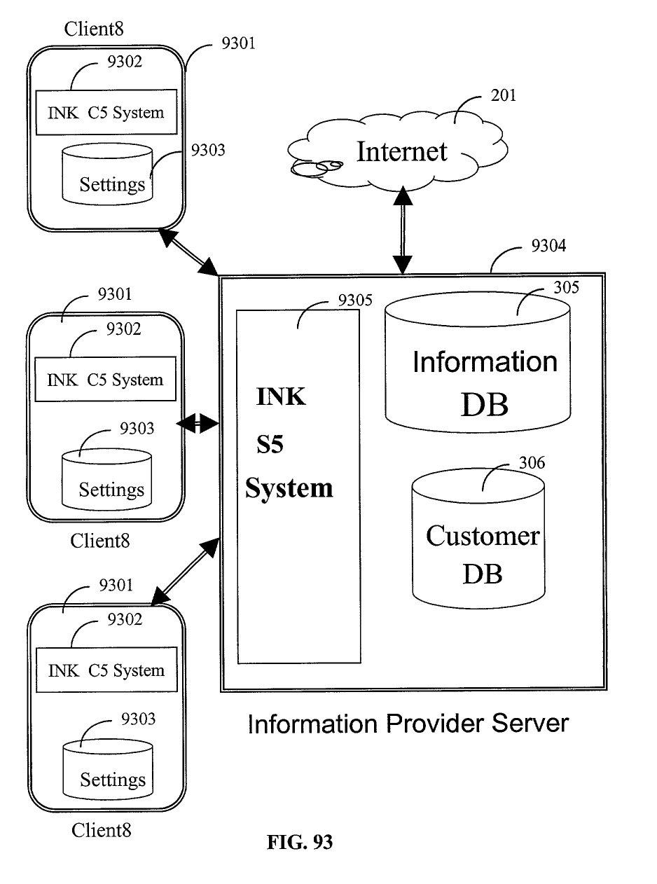

FIG. 93 shows another example system architecture of this embodiment. As can be seen from the figure, the individual clients 9301 have the user settings stored within the client itself in, 9303 Settings Database. Hence, the matching of what information is to be obtained is performed either on the client or on the server. Also, if the client has to connect to multiple servers, the user settings need not be duplicated across the servers, as they reside in the client itself.

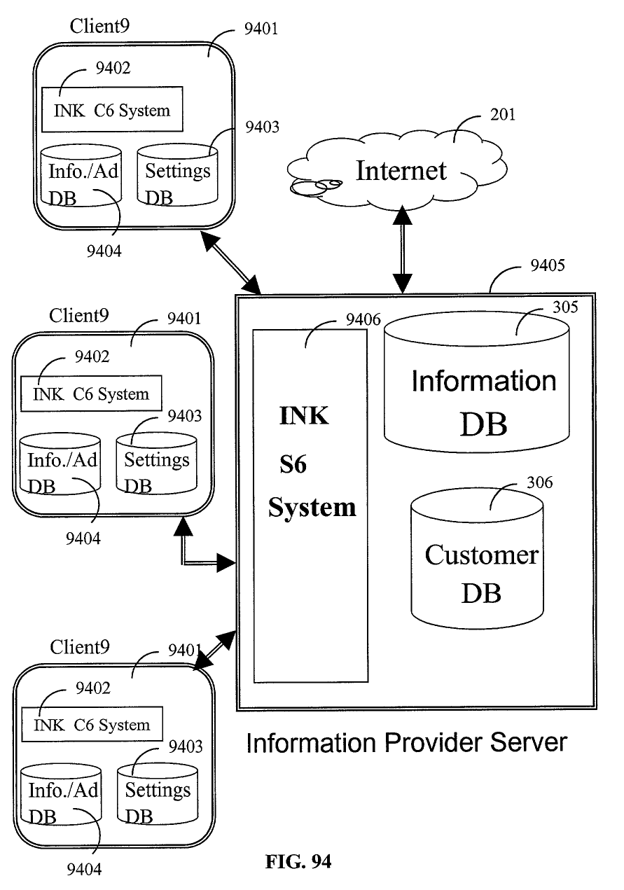

FIG. 94 shows another example system architecture of this embodiment. As can be seen from the figure, the individual clients 9401, not only have the user settings stored within the client itself in, 9403 Settings Database but also the service provider's information, advertisements are stored in the Info./Ad DB in 9404, which is either periodically based on fixed or user defined schedule or on demand. This is especially useful, as the information and the advertisements can be shown to the user, in ‘offline’ mode, i.e., the user need not be connected to the server to view the information from the service provider.

The present invention described above may be applied to a system constituted of a plurality of computers, or a specific computer within a system. The object of the present invention can also be achieved by supplying a storage medium storing program codes of software for implementing the function of the above embodiment to a system or an apparatus, and reading out and executing the program codes stored in the storage medium by a computer (or a CPU or MPU) of the system or apparatus. In this case, the program codes read out from the storage medium implement the function of the present invention, and the storage medium storing these program codes constitutes the invention. Also, besides the function of the above embodiment is implemented by executing the readout program codes by the computer, the present invention includes a case where an OS (Operating System) or the like running on the computer performs a part or the whole of actual processing in accordance with designations by the program codes and thereby implements the function of the above embodiment.

Furthermore, the present invention also includes a case where, after the program codes read out from the storage medium are written in a memory of a function extension board inserted into the computer or of a function extension unit connected to the computer, a CPU or the like of the function extension board or function extension unit performs a part or the whole of actual processing in accordance with designations by the program codes and thereby implements the function of the above embodiment.

Although the present invention has been described in its preferred form with a certain degree of particularity, many apparently widely different embodiments of the invention can be made without departing from the spirit and scope thereof. It is to be understood that the invention is not limited to the specific embodiments thereof except as defined in the appended claims.

What is claimed is:

1. An information processing system including a server and at least one client terminals, said server comprising:
receiving means for receiving information provided by a plurality of providers via an internet; and
transmission means for transmitting information from the plurality of providers to said at least one client terminals,
each of said at least one client terminals comprising:
server information receiving means for receiving information transmitted from said server; and
display means for displaying, while information in the internet is displayed in a first window by a browser, information received by said server information receiving means in a second window.

2. The system according to claim 1, wherein said server further comprising transmission control means for controlling said transmission means to select and transmit predetermined information from among information provided by the plurality of providers.

3. The system according to claim 2, wherein said transmission control means controls said transmission means to select and transmit predetermined information based on a setting for a user of each of said at least one client terminals.

4. The system according to claim 2, wherein said transmission control means controls said transmission means to select and transmit information which has not displayed yet or updated after displayed based on a history of displayed information.

5. The system according to claim 3, wherein said server further comprising setting database for storing the setting for the user of each of said at least one client terminals, and said transmission control means controls said transmission means based on the setting stored in said setting database.

6. The system according to claim 5, wherein said setting database stores a field of information which are wanted by the user.

7. The system according to claim 5, wherein said setting database stores a setting of a period or a timing for displaying information set by the user.

8. The system according to claim 3, wherein each of said at least one client terminals further comprising setting storage means for storing the setting for the user of respective client terminals, and said transmission control means controls said transmission means based on the setting stored in said setting storage means.

9. The system according to claim 8, wherein said setting storage means stores a field of information which are wanted by the user.

10. The system according to claim 8, wherein said setting storage means stores a setting of a period or a timing for displaying information set by the user.

11. The system according to claim 1, wherein each of said at least one client terminals further comprising:
setting storage means for storing the setting for the user of respective client terminals; and
reception control means for controlling said server information receiving means to select and receive predetermined information based on the setting stored in said setting storage means.

12. The system according to claim 11, wherein said setting storage means stores a field of information which are wanted by the user.

13. The system according to claim 11, wherein said setting storage means stores a setting of a period or a timing for displaying information set by the user.

14. The system according to claim 2, wherein said transmission control means controls at least one of a transmission order, a transmission timing, and a length of transmission time for a plurality of information to be transmitted by said transmission means.

15. The system according to claim 14, wherein said transmission control means controls the length of transmission time based on a setting set by a provider.

16. The system according to claim 2, wherein said transmission control means controls said transmission means to display a plurality of information, simultaneously.

17. The system according to claim 1, wherein each of said at least one client terminals further comprising:
storage means for storing information received from the provider by said server information receiving means; and
offline display means for displaying the information stored in said storage means in a offline state.

18. The system according to claim 17, wherein said storage means stores each information received from the provider with assigning a predetermined index.

19. The system according to claim 18, wherein each of said at least one client terminals further comprising sorting means for sorting and displaying the index assigned to the each information received from the provider.

20. The system according to claim 19, wherein said storage means stores each information received from the provider in correspondence with a day and time when the information was received, and said sorting means is able to sort and display the index based upon the day and time.

21. The system according to claim 1, wherein each of said at least one client terminals further comprising window control means for controlling said display means to display the information received by said server information receiving means in the first window in response to an instruction of switching windows.

22. The system according to claim 1, wherein each of said at least one client terminals further comprising popup display control means for controlling said display means to display the information received by said server information receiving means in a popup window in response to an instruction of popup.

23. The system according to claim 1, wherein each of said at least one client terminals further comprising display timing control means for controlling said display means not to display the information received by said server information receiving means at the time the information is received and to display later.

24. The system according to claim 1, wherein said server further comprising:
internet information acquisition means for acquiring internet information presently displayed by the browser in the first window of said client terminal;
generation means for generating information related to a content of the internet information; and
related information transmission means for transmitting related information generated by said generation means so as to display the related information with the internet information.

25. The system according to claim 24, wherein said generation means generates the related information by translating a text or a word contained in the internet information.

26. The system according to claim 1, wherein the information provided by the plurality of providers includes real time information or specific type information.

27. The system according to claim 26, wherein the real time information or specific type information includes at least one of advertisement, news, a lesson, and a glossary.

28. The system according to claim 1, further comprising detailed information acquisition means for acquiring more detailed information of the information presently displayed, in response to a request for detailed information, and
said display means displays the more detailed information.

29. The system according to claim 28, wherein said detailed information acquisition means receives the detailed information directly from a site of the provider of the information presently displayed.

30. The system according to claim 29, wherein the site of the provider is set in said server as a source of the detailed information and said detailed information acquisition means perceives the site of the provider by referring to said server.

31. An information processing method comprising the steps of:
receiving information provided by a plurality of providers by a server via an internet;
transmitting information provided by the plurality of providers to at least one client terminals by said server; and
displaying on said at least one client terminals, while information in the internet is displayed in a first window by a browser, information received from said server in a second window.

32. A client terminal connectable to a server for receiving information provided by a plurality of providers, said client terminal comprising:
server information receiving means for receiving information transmitted from said server; and
display means for displaying, while information in the internet is displayed in a first window by a browser, information received by said server information receiving means in a second window.

33. An information processing method in a client terminal connectable to a server for receiving information provided by a plurality of providers, said method comprising the steps of:
receiving information provided by the plurality of providers via said server; and
displaying, while information in the internet is displayed in a first window by a browser, information received from the plurality of providers via said server in a second window.

34. A computer readable program for processing information executed by a client terminal connectable to a server for receiving information from a plurality of providers, said program comprising the program steps of:
receiving information from the plurality of providers via said server; and
displaying, while information in the internet is displayed in a first window by a browser, information received from the plurality of providers via said server in a second window.

35. A server connectable to at least one client terminals, said server comprising:
receiving means for receiving information provided by a plurality of providers via an internet;
transmission means for transmitting information provided by the plurality of providers to said at least one client terminals; and
transmission control means for controlling said transmission means to select and transmit predetermined information from among information provided by the plurality of providers.

36. An information processing method in a server connectable to at least one client terminals, said method comprising the steps of:
receiving information provided by a plurality of providers via an internet;
selecting predetermined information from among information provided by the plurality of providers in said receiving step; and
transmitting the predetermined information selected in said selecting step to said at least one client terminals.

37. A computer readable program for processing information executed by a server connectable to at least one client terminals, said program comprising the program steps of:
receiving information provided by a plurality of providers via an internet;
selecting predetermined information from among information provided by the plurality of providers in said receiving step; and
transmitting the predetermined information selected in said selecting step to said at least one client terminals.

38. An information processing system including a server and at least one client terminals, said server comprising:
receiving means for receiving a page in an internet requested by a client terminal and information provided by a plurality of providers via the internet; and
transmission means for transmitting the page and information provided by the plurality of providers to said client terminal,
each of said at least one client terminals comprising:
server information receiving means for receiving the page and information provided by the plurality of providers from said server; and
display means for displaying the page in a first window and information provided by the plurality of providers in a second window.

39. An information processing method comprising the steps of:
receiving by a server a page in an internet requested by a client terminal and information provided by a plurality of providers via the internet;
transmitting the page and information provided by the plurality of providers from said server to said client terminal; and
displaying the page in a first window and information provided by the plurality of providers in a second window.

40. A server connectable to at least one client terminals, said server comprising:
receiving means for receiving a page in an internet requested by a client terminal and information provided by a plurality of providers via the internet; and
transmission means for transmitting the page and information provided by the plurality of providers to said client terminal.

41. An information processing method in a server connectable to at least one client terminals, said method comprising the steps of:
receiving a page in an internet requested by a client terminal and information provided by a plurality of providers via the internet; and
transmitting the page and information provided by the plurality of providers to said client terminal.

42. A computer readable program for processing information executed by a server connectable to at least one client terminals, said program comprising the program steps of:
receiving a page in an internet requested by a client terminal and information provided by a plurality of providers via the internet; and
transmitting the page and information provided by the plurality of providers to said client terminal.
